(19) United States
(12) Patent Application Publication
(10) Pub. No.: US 2024/0336005 A1
(43) Pub. Date: Oct. 10, 2024

(54) METHODS AND APPARATUSES FOR FORMATION OF TOPOGRAPHICAL MICROSTRUCTURES AND PATTERNING OF TEXTURED SURFACES USING PHOTOPOLYMERIZATION

(71) Applicant: University of Florida Research Foundation, Incorporated, GAINESVILLE, FL (US)

(72) Inventors: Aftab A. Bhanvadia, Gainesville, FL (US); Toshikazu Nishida, Gainesville, FL (US)

(21) Appl. No.: 18/623,484

(22) Filed: Apr. 1, 2024

Related U.S. Application Data
(60) Provisional application No. 63/457,924, filed on Apr. 7, 2023.

(51) Int. Cl. B29C 64/129; B29C 64/232; B29C 64/236; B29C 64/245; B29C 64/393; B33Y 10/00; B33Y 50/02; B33Y 70/00; B33Y 80/00

(52) U.S. Cl. CPC B29C 64/129; B29C 64/232; B29C 64/236; B29C 64/245; B29C 64/393; B33Y 10/00; B33Y 50/02; B33Y 70/00; B33Y 80/00

(57) ABSTRACT

Disclosed are systems, methods, and apparatuses for fabricating topographical microdevices and textured surfaces with arbitrary geometries using frontal photopolymerization. The method can include disposing a volume of a liquid resin on a transparent substrate, projecting a patterned light on the liquid resin or through the transparent substrate, varying the patterned light in order to focus a projection focal plane of the patterned light on an interface between the transparent substrate and the liquid resin in order to initiate polymerization of the photocurable monomer at said interface, and laterally and temporally modulating an effective exposure energy dose of the patterned light relative to a total depth of the liquid resin, wherein the exposure energy dose is a product of light exposure time and exposure intensity for respective of the different portions of the liquid resin.

### CROSS-REFERENCE TO RELATED APPLICATIONS

This application claims priority to, and the benefit of, U.S. Provisional Patent Application Ser. No. 63/457,924, filed Apr. 7, 2023 and entitled “Methods and Apparatuses for Formation of Topographical Microstructures and Patterning of Textured Surfaces Using Photopolymerization,” the entire disclosure of which is hereby incorporated herein by reference in its entirety for all purposes.

### SUPPORT STATEMENT

This invention was made with government support under 1939009 awarded by the National Science Foundation. The government has certain rights in the invention.

### FIELD

The presently disclosed subject matter relates generally to methods and apparatuses for preparing topographical and textured surfaces and 3D objects, and more specifically to methods and apparatuses for using photopolymerization to form topographical and textured surfaces.

### BACKGROUND

Patterned surfaces and topographical microstructures have a variety of applications, such as metamaterials, metalenses, microfluidics, optical lenses, holography, hardware security, hydrophobic surfaces, lubricious surfaces, antifouling surfaces, and friction control, among others. Formation of patterned surfaces and topographical microstructures is generally carried out using micromilling, photolithography, soft lithography, direct write, laser ablation, or stereolithography. These techniques are often costly and time-consuming, involving multiple complex steps. The subject matter described herein meets this and/or other needs and solves some or all of the problems identified herein.

### BRIEF SUMMARY

Described herein are systems, methods, apparatuses, and computer program products for creating polymeric objects, textured surfaces, microstructured materials, and/or the like, that have arbitrary geometries and topographical textures. According to some embodiments, a micro-patterning method can be used such that a geometry of the polymer object/device and/or textured surface can be controlled in all three-dimensions (e.g., along the x, y, and z-axes), and can comprise multiple different materials. In some embodiments, minimum feature sizes of microstructured materials, microtextured surfaces, and/or polymeric objects on the order of ones-to tens of a micrometer can be achieved in the lateral direction (e.g., along the x-axis and/or the y-axis), and topographical heights (e.g., along the z-axis) of the features can range from ones-to thousands of a micrometer. In some embodiments, fabricated polymer surfaces can function as positive masters for replication into other materials. In some embodiments, a device formed at least in part based on a method described herein can include multi-focal length microlens arrays with high fill factor, radio frequency (RF) waveguides, and/or the like.

In one aspect, the presently disclosed subject matter is directed to a method for the fabrication of a polymeric device or a polymeric surface with arbitrary geometries and topographical textures, the method comprising: disposing a volume of a liquid resin comprising a photocurable monomer to a first surface of a transparent substrate; projecting a patterned light onto a second surface of the transparent substrate, the second surface being opposite the first surface, wherein the transparent substrate is dimensioned and configured such that the patterned light travels through the transparent substrate from the second side to the first side; varying the patterned light in order to focus a projection focal plane of the patterned light on an interface between the first surface of the transparent substrate and the liquid resin disposed thereon in order to initiate polymerization of the photocurable monomer at said interface; and laterally and temporally modulating an effective exposure energy dose of the patterned light relative to a total depth of the liquid resin, wherein the exposure energy dose is a product of light exposure time and exposure intensity for respective of the different portions of the liquid resin.

In some embodiments, the liquid resin comprises a photoinitiator, a photoabsorber, an inhibitor, a dye, and/or nanoparticles.

In some embodiments, the method can further comprise: controlling vertical polymerization by varying resin formulation.

In some embodiments, the characteristic absorption length is inversely correlated with the absorption constant of the resin.

In some embodiments, the method can further comprise: controlling a minimum exposure dose energy to control polymerization of the resin.

In some embodiments, the liquid resin comprises a plurality of photocurable monomers. In some embodiments, the liquid resin comprises one or more of: one or more photocurable monomers, one or more photoinitiators, one or more absorbers, one or more dyes, one or more functional fillers, or one or more inhibitors.

In some embodiments, the transparent substrate comprises one of: a glass, a microscope slide, a cyclic olefin copolymer film, a polyethylene terephthalate film, or a combination thereof.

In some embodiments, the transparent substrate is one of: flat, curved, flexible, or stiff.

In some embodiments, the method can further comprise: functionalizing the first surface of the transparent substrate using one or more silane adhesion promotors.

In some embodiments, the method can further comprise: functionalizing the second surface of the transparent substrate by coating the second surface of the transparent substrate with one or more of: an anti-reflective coating, a light filter coating, a light polarization coating, a stencil, a mask, a wavelength filtering coating, or a patterning coating.

In some embodiments, the spatial light modulator comprises one or more of: a digital light projector (DLP) configured to project said patterned light, a liquid crystal display device, or a liquid crystal on silicon device.

In some embodiments, the method can further comprise: tilting or laterally translating the transparent substrate in order to laterally and temporally modulating the effective exposure energy dose of the patterned light relative to the total depth of the liquid resin.

In some embodiments, the method can further comprise: tilting, vertically translating, or laterally translating the transparent substrate to modulate the effective exposure energy dose of the patterned light relative to the total depth of the liquid resin or vary a position or an angle of the projection focal plane with respect to one of the first or second surface of the transparent substrate.

In some embodiments, the method can further comprise: causing the volume of the liquid resin to be mixed, stirred, vibrated, oscillated, or agitated mechanically.

According to another embodiment, a method can be carried out for the fabrication of a polymeric device or a polymeric surface with arbitrary geometries and topographical textures, the method comprising: disposing a volume of a liquid resin comprising a photocurable monomer to a first surface of a transparent substrate; projecting a patterned light onto a second surface of the transparent substrate, the second surface being opposite the first surface, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to another embodiment, a method can be carried out for the fabrication of a polymeric device or a polymeric surface with arbitrary geometries and topographical textures, the method comprising: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin, wherein the exposure energy dose is a product of light exposure time and exposure intensity of the liquid resin.

According to another embodiment, a method can be carried out for the fabrication of a polymeric device or a polymeric surface with arbitrary geometries and topographical textures, the method comprising: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to another embodiment, a method can be carried out for the fabrication of a polymeric device or a polymeric surface with arbitrary geometries and topographical textures, the method comprising: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; varying the patterned light in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to another embodiment, a method can be carried out for the fabrication of a polymeric device or a polymeric surface with arbitrary geometries and topographical textures, the method comprising: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; focusing a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to another embodiment, a method can be carried out for the fabrication of a polymeric device or a polymeric surface with arbitrary geometries and topographical textures, the method comprising: disposing a volume of a liquid resin comprising a photocurable monomer to a first surface of a transparent substrate; using a spatial light modulator to pattern the light emitted towards a second surface of the transparent substrate, the second surface being opposite the first surface, and projecting patterned light onto the second surface of the transparent substrate, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to another embodiment, a method can be carried out for the fabrication of a polymeric device or a polymeric surface with arbitrary geometries and topographical textures, the method comprising: disposing a volume of a liquid resin comprising a photocurable monomer to a first surface of a transparent substrate; projecting a patterned light onto a second surface of the transparent substrate, the second surface being opposite the first surface, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to another embodiment, a method can be carried out for the fabrication of a polymeric device or a polymeric surface with arbitrary geometries and topographical textures, the method comprising: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to another embodiment, an apparatus can be provided for fabricating a polymeric device or a polymeric surface with arbitrary geometries and topographical textures, the apparatus comprising: a transparent substrate configured to support a liquid resin on or a distance above a first side of the transparent substrate, the liquid resin comprising a photocurable monomer; a light source disposed a distance from a second side of the transparent substrate, the light source configured to emit a light towards the second side of the transparent substrate; a spatial light modulator configured to pattern the light emitted by the light source and project patterned light towards the second side of the transparent substrate; and a 3-axis linear stage configured to move the spatial light modulator and/or the light source in three dimensions relative to the transparent substrate.

In some embodiments, the transparent substrate is configured such that the patterned light projected towards the second side of the transparent substrate travels through the transparent substrate to the first side and initiates frontal photopolymerization of the photocurable monomer, causing at least a portion of the photocurable monomer to be converted into a solid polymer.

In some embodiments, a geometry or a topography of the polymeric device or the polymeric surface is controlled through programmatic movement of the spatial light modulator and/or the light source by the 3-axis linear stage.

In some embodiments, the spatial light modulator is configured to project the patterned light such that initiation of the frontal photopolymerization of the photocurable monomer occurs at an interface of the first side of the transparent substrate and the liquid resin.

According to other embodiments, an apparatus can be provided that comprises a processor and a memory storing program codes, wherein the memory and the program codes are configured, with the processor, to cause the apparatus at least to fabricate a polymeric device or a polymeric surface with arbitrary geometries and topographical textures by: disposing a volume of a liquid resin comprising a photocurable monomer to a first surface of a transparent substrate; projecting a patterned light onto a second surface of the transparent substrate, the second surface being opposite the first surface, wherein the transparent substrate is dimensioned and configured such that the patterned light travels through the transparent substrate from the second side to the first side; varying the patterned light in order to focus a projection focal plane of the patterned light on an interface between the first surface of the transparent substrate and the liquid resin disposed thereon in order to initiate polymerization of the photocurable monomer at said interface; and laterally and temporally modulating an effective exposure energy dose of the patterned light relative to a total depth of the liquid resin, wherein the exposure energy dose is a product of light exposure time and exposure intensity for respective of the different portions of the liquid resin.

In some embodiments, the liquid resin comprises a photoinitiator, a photoabsorber, an inhibitor, a dye, and/or nanoparticles.

In some embodiments, the memory and the program codes can be further configured, with the processor, to further cause the apparatus to carry out at least: controlling vertical polymerization by varying resin formulation.

In some embodiments, the characteristic absorption length is inversely correlated with the absorption constant of the resin.

In some embodiments, the memory and the program codes can be further configured, with the processor, to further cause the apparatus to carry out at least: controlling a minimum exposure dose energy to control polymerization of the resin.

In some embodiments, the liquid resin comprises a plurality of photocurable monomers. In some embodiments, the liquid resin comprises one or more of: one or more photocurable monomers, one or more photoinitiators, one or more absorbers, one or more dyes, one or more functional fillers, or one or more inhibitors.

In some embodiments, the transparent substrate comprises one of: a glass, a microscope slide, a cyclic olefin copolymer film, a polyethylene terephthalate film, or a combination thereof.

In some embodiments, the transparent substrate is one of: flat, curved, flexible, or stiff.

In some embodiments, the memory and the program codes can be further configured, with the processor, to further cause the apparatus to carry out at least: functionalizing the first surface of the transparent substrate using one or more silane adhesion promotors.

In some embodiments, the spatial light modulator is a digital light projector (DLP) configured to project said patterned light.

In some embodiments, the memory and the program codes can be further configured, with the processor, to further cause the apparatus to carry out at least: tilting or laterally translating the transparent substrate in order to laterally and temporally modulating the effective exposure energy dose of the patterned light relative to the total depth of the liquid resin.

In some embodiments, the memory and the program codes can be further configured, with the processor, to further cause the apparatus to carry out at least: causing the volume of the liquid resin to be mixed, stirred, vibrated, oscillated, or agitated mechanically.

According to other embodiments, an apparatus can be provided that comprises a processor and a memory storing program codes, wherein the memory and the program codes are configured, with the processor, to cause the apparatus at least to fabricate a polymeric device or a polymeric surface with arbitrary geometries and topographical textures by: disposing a volume of a liquid resin comprising a photocurable monomer to a first surface of a transparent substrate; projecting a patterned light onto a second surface of the transparent substrate, the second surface being opposite the first surface, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to other embodiments, an apparatus can be provided that comprises a processor and a memory storing program codes, wherein the memory and the program codes are configured, with the processor, to cause the apparatus at least to fabricate a polymeric device or a polymeric surface with arbitrary geometries and topographical textures by: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin, wherein the exposure energy dose is a product of light exposure time and exposure intensity of the liquid resin.

According to other embodiments, an apparatus can be provided that comprises a processor and a memory storing program codes, wherein the memory and the program codes are configured, with the processor, to cause the apparatus at least to fabricate a polymeric device or a polymeric surface with arbitrary geometries and topographical textures by: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to other embodiments, an apparatus can be provided that comprises a processor and a memory storing program codes, wherein the memory and the program codes are configured, with the processor, to cause the apparatus at least to fabricate a polymeric device or a polymeric surface with arbitrary geometries and topographical textures by: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; varying the patterned light in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to other embodiments, an apparatus can be provided that comprises a processor and a memory storing program codes, wherein the memory and the program codes are configured, with the processor, to cause the apparatus at least to fabricate a polymeric device or a polymeric surface with arbitrary geometries and topographical textures by: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; focusing a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to other embodiments, an apparatus can be provided that comprises a processor and a memory storing program codes, wherein the memory and the program codes are configured, with the processor, to cause the apparatus at least to fabricate a polymeric device or a polymeric surface with arbitrary geometries and topographical textures by: disposing a volume of a liquid resin comprising a photocurable monomer to a first surface of a transparent substrate; using a spatial light modulator to pattern the light emitted towards a second surface of the transparent substrate, the second surface being opposite the first surface, and projecting patterned light onto the second surface of the transparent substrate, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to other embodiments, an apparatus can be provided that comprises a processor and a memory storing program codes, wherein the memory and the program codes are configured, with the processor, to cause the apparatus at least to fabricate a polymeric device or a polymeric surface with arbitrary geometries and topographical textures by: disposing a volume of a liquid resin comprising a photocurable monomer to a first surface of a transparent substrate; projecting a patterned light onto a second surface of the transparent substrate, the second surface being opposite the first surface, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

According to other embodiments, an apparatus can be provided that comprises a processor and a memory storing program codes, wherein the memory and the program codes are configured, with the processor, to cause the apparatus at least to fabricate a polymeric device or a polymeric surface with arbitrary geometries and topographical textures by: disposing a volume of a liquid resin comprising a photocurable monomer to a first surface of a transparent substrate; causing a light source to emit a light towards a second surface of the transparent substrate, the second surface being opposite the first surface; using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side; varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface; varying a concentration of one or more materials in the liquid resin in order to control a polymerization thickness, measured as a distance away from the first surface of the transparent substrate and into the liquid resin that photopolymerization occurs; and laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin.

These and other aspects are described fully herein.

### BRIEF DESCRIPTION OF THE DRAWINGS

FIGS. 1A-1B shows the use of frontal photopolymerization for the fabrication of patterned surfaces. FIG. 1A shows an apparatus setup for frontal photopolymerization with a DLP project projecting patterned light through a transparent substrate into a vat of liquid resin to form topographical microstructures. FIG. 1B shows the UV intensity and maximum cured depth (C_{d}) of the polymer for topographical structure A in FIG. 1A.

FIG. 2 shows a graph of the thickness of the cured polymer (C_{d}) as a function of the incident exposure energy dose. Dₚ is the characteristic absorption length. E is the exposure energy dose used for printing. E_{c} is the minimum exposure energy dose required to initiate polymerization.

FIGS. 3A-3E show examples of microstructures polymerized by projecting patterned ultraviolet (UV) light. FIGS. 3A-3D show patterned grayscale images that are inputted into the DLP and output projected UV light patterns with intensity proportional to the greyscale value. FIG. 3E shows the 3D microstructures polymerized on the transparent substrate.

FIG. 4 shows a fabrication system to fabricate micropatterns with UV light projected from the bottom.

FIG. 5 shows two aluminum clamping plates and a transparent glass substrate comprising a modular vat.

FIG. 6 shows the vat mounted onto a platform.

FIG. 7 shows a DLP projection system mounted onto a 3-axis linear stage.

FIG. 8 shows patterned UV light being projected into the resin-filled vat.

FIG. 9 shows a variation of the fabrication system with a tiltable vat.

FIG. 10 shows a variation of the fabrication system with UV light coming from the top wherein the resin can be continuously flowed and/or stirred.

FIG. 11 shows a variation of the fabrication system with UV light coming from the top with a layer of inert immiscible liquid that can be stirred under the resin.

FIG. 12 shows a variation of the fabrication system with UV light coming from the top with a layer of inert immiscible liquid that can be stirred under the resin.

FIGS. 13A-13B show patterned UV light to achieve various surface geometries.

FIG. 13A shows a grayscale pattern file inputted to a DLP. FIG. 13B shows the projected UV patterned light that is in focus at the interface of the substrate and the resin.

FIGS. 14A-14G show cross-sections with expected geometry of polymerized resin.

FIG. 14A shows the patterned UV light of FIG. 13A-13B with features A-F. The polymer's lateral dimension (x-axis, y-axis) and height (z-axis) are controlled by varying the local UV intensity, which is determined from the grayscale of the pattern. FIG. 14B shows a cross section of a cured polymer for feature A. FIG. 14C shows a cross section of a cured polymer for feature B. FIG. 14D shows a cross section of a cured polymer for feature C. FIG. 14E shows a cross section of a cured polymer for feature D. FIG. 14F shows a cross section of a cured polymer for feature E. FIG. 14G shows a cross section of a cured polymer for feature F.

FIG. 15 shows a pattern used for UV exposure of resin for the fabrication of a polymer device with varying topographical features.

FIG. 16 shows the fabricated polymer with various textures and surface profiles.

FIG. 17 shows a microstructure with pyramidal geometry with sharp stepped edges. The structure has a variable lateral geometry and heights, given by h where h₃>h₂>h₁.

FIG. 18 shows a single exposure grayscale pattern inputted into a DLP to achieve a microstructure with stepped pyramidal geometry in FIG. 17.

FIGS. 19A-19C show multiple discrete exposure patterns to achieve a microstructure with stepped pyramidal geometry in FIG. 17. FIG. 19A shows the black and white pattern for exposure time t_{A} to achieve h₁ of the pyramid structure. FIG. 19B shows the black and white pattern for exposure time/B to achieve h₂ of the pyramid structure. FIG. 19C shows the black and white pattern for exposure time fc to achieve h₃ of the pyramid structure.

FIG. 20 shows a microstructure with pyramidal geometry with curved stepped edges. The structure has a variable lateral geometry and heights, given by h where h₃>h₂>h₁.

FIGS. 21A-21C show multiple discrete exposure patterns containing grayscale to achieve a microstructure with stepped pyramidal geometry with curved edges in FIG. 20. FIG. 21A shows the pattern for exposure time t_{A} to achieve h₁ of the pyramid structure. FIG. 21B shows the grayscale pattern for exposure time t_{B} to achieve h₂ of the pyramid structure. FIG. 21C shows the grayscale pattern for exposure time t_{C} to achieve h₃ of the pyramid structure.

FIG. 22 shows an example of a polymer microstructure with a curved parabolic profile.

FIG. 23 shows an image of a GIF file of a dynamically changing pattern to fabricate a polymer with a curved profile in FIG. 22.

FIG. 24 shows temporal screenshots of the dynamically changing pattern in FIG. 23 used to fabricate the structure in FIG. 22.

FIGS. 25A-25B shows examples of multi-material heterogenous microstructure patterns formed by changing the resin material between discrete exposures, with FIG. 25A being a front view and FIG. 25B being a top-down view.

FIGS. 26A-26D show exposure patterns and sequence for fabricating multi-material heterogenous features shown in FIGS. 25A-25B. FIG. 26A shows Exposure 1 with Material C. FIG. 26B shows Exposure 2 with Material B. FIG. 26C shows Exposure 3 with Material A. FIG. 26D shows a top view of the composite exposure and materials.

FIGS. 27A-27D show the tradeoff between the field of view (FOV) and the minimum patternable feature size. FIG. 27A shows image expansion with a larger FOV with a larger patternable feature size, but poorer resolution, relative to a corresponding pattern illustrated in FIG. 27B. FIG. 27C shows image reduction with a smaller FOV and higher resolution, relative to a corresponding pattern illustrated in FIG. 27D.

FIG. 28 shows projection stitching to achieve a larger polymerization region with high resolution by sequentially exposing smaller FOV areas.

FIGS. 29A-29B show an example of a fabricated micropattern wherein the resin was polymerized in multiple regions of the substrate. After each exposure, the DLP was automatically moved to a new location and the same pattern was exposed again. FIG. 29A shows a picture of a glass slide with patterned polymer structures coated with aluminum. FIG. 29B shows the polymer surface of the structures in FIG. 29A characterized using an optical profilometer.

FIG. 30 shows an example of a topographical textured micropattern formed on a substrate according to a method described herein.

FIG. 31 is an image of a multi-focal microlens array formed according to a method described herein.

FIG. 32 shows an example of a CAD model of a 3D structure with complex geometry fabricated using an overlapping exposure stacking method.

FIG. 33 shows a vertical view of the CAD model of the structure in FIG. 32 which is divided into 3 segments, wherein Segment 1 is a region comprising z=0-100 μm, Segment 2 is region comprising z=100-200 μm, and Segment 3 is a region comprising z=200-300 μm.

FIGS. 34A-34C shows grayscale patterns for UV exposure to fabricate the structure of FIG. 32. The pattern of each segment contains 10 additional slices which are linearly spaced along the z-axis and their slices correspond to the grayscale values which are also linearly spaced. FIG. 34A shows the grayscale Pattern 1 for Segment 1. FIG. 34B shows the grayscale Pattern 2 for Segment 2. FIG. 34C shows the grayscale Pattern 3 for Segment 3.

FIGS. 35A-35D show frontal photopolymerization to fabricate smooth and curved polymers, which can be used to create optical lenses. FIG. 35A shows an apparatus setup with a DLP projector projecting patterned UV to cure a polymer with a curved surface. FIG. 35B shows a cross-sectional profile of a cured polymer with the relationship between maximum cured depth (C_{d}) and UV light intensity. FIG. 35C illustrates the patterned UV light emitted from the DLP projector. FIG. 35D is a graph that illustrates the relationship between Ca and UV light intensity.

FIG. 36 shows a schematic of how curved profiles are formed by influencing the degree of polymerization laterally along the depth of the resin by leveraging the secondary effects of polymerization kinetics.

FIG. 37 shows microstructure geometries with curved profiles that were fabricated with single exposure of a non-grayscale, “white only” pattern of a circle with a designed base diameter of 500 μm. Each microlens was formed by sequential exposures of the same pattern at different locations using projection stitching. Exposure intensity was varied from about 3 mW/cm² to about 40 mW/cm² and exposure time was varied from about 3 seconds to about 120 seconds for each microlens. The microstructures were characterized using an optical profilometer.

FIG. 38 shows an angled optical photograph in a microscope of microstructures with curved profiles that were fabricated with single exposure of a non-grayscale, “white only” pattern of a circle with a designed base diameter of about 250 μm and coated with aluminum.

FIG. 39 and FIG. 40 show conical microstructures fabricated through the control of lateral and vertical polymerization.

FIGS. 41-43 show microscope images of an array of microlenses with different diameter, height and curvature geometries. The object being imaged through the lenses has an array of black dots. In FIG. 41 the microscope is focused to show the top view of all the lenses. In FIG. 42 the microscope is focused such that the object imaged through the lenses can be seen. FIG. 43 shows an enlarged image of FIG. 42.

FIGS. 44-47 show optical microscope images of an array of multi-focal microlenses arranged in a mosaic pattern fabricated on a glass substrate. In the array, each unit cell has 4 lenses. Each lenslet in the unit cell has a different geometry (diameter, height, curvature), thus a different focal length. FIG. 44 shows an angled view. FIG. 45 shows the microscope image focused on the top surface of the lenses. FIG. 46 and FIG. 47 show lenses in front of a textual reference object wherein the microscope is focused such that the textual object can be viewed in focus through the lenses.

FIG. 48 shows the grayscale pattern used to fabricate the multi-focal lenses shown in FIGS. 44-47. The pattern contains an array of unit cells. Each unit cell has 4 circles with different grayscale values to modulate exposure intensity.

FIGS. 49A-49D show sequential non-overlapped exposure patterns to fabricate the multi-focal lenses shown in FIGS. 44-47 without grayscale. FIG. 49A shows the pattern used with an exposure time of t_{A}. FIG. 49B shows the pattern used with an exposure time of t_{B}. FIG. 49C shows the pattern used with an exposure time of t_{C}. FIG. 49D shows the pattern used with an exposure time of t_{D}.

FIG. 50 shows a pattern containing an array of circles in a hexagonal arrangement used to fabricate a dense array of microstructures.

FIG. 51 shows an array of microlenses with a single focal length in a hexagonal arrangement to increase the packing density. Multiple exposure and inter-exposure routines are used to achieve high uniformity through all of the lenses.

FIGS. 52A-52B show a multi-focal array of microlenses. The unit cell of the array is highlighted in red. Each lenslet in the unit cell has a different shape and focal length.

FIGS. 53A-53E show patterns used to attain a densely packed array of microlenses. The composite pattern is subdivided into 4 different patterns and exposures, allowing increased spacing between the features concurrently exposed to UV light. FIG. 53A shows the desired composite pattern. FIG. 53B shows pattern A with exposure time t_{A} and exposure intensity I_{A}. FIG. 53C shows pattern B with exposure time t_{A} and exposure intensity IB. FIG. 53D shows pattern C with exposure time t_{A} and exposure intensity I_{C}. FIG. 53E shows pattern D with exposure time t_{A} and exposure intensity I_{D}.

FIG. 54 shows an alternate arrangement for multi-focal lenses. The colored circles represent polymer microstructures with different shapes and effective focal lengths.

FIG. 55 shows an example of optical lens arrays with graded index of refraction, achieved by multi-material fabrication.

FIG. 56 shows replication of a textured microstructure by casting desired material in between the mold and substrate.

FIGS. 57-58 show replication of a microlens array. FIG. 57 shows the microlens array on a glass substrate (positive master) and a PDMS mold (negative mold). FIG. 58 shows the replicated microlens array made of PDMS which is flexible and stretchable.

FIGS. 59A-59D illustrate an example of a functional device as a substrate used for forming a topographical texture on a top surface thereof. FIG. 59A illustrates a top-view of a transparent film with one or more non-transparent conductive traces formed thereon. FIG. 59B illustrates a cross-sectional view of the transparent film illustrated in FIG. 59A. FIG. 59C illustrates a resin volume on a transparent substrate with a topographical texture formed thereon via UV light exposure from a DLP. FIG. 59D illustrates a resin volume on a transparent substrate with a topographical texture formed thereon between polymer structures via UV light exposure from a DLP.

FIG. 60A-609C illustrate an example approach for using a substrate spin coated with a thin layer of an at least partially transparent sacrificial material to form thereon polymerized topographical textures (FIG. 60A), etching or dissolving a portion of the at least partially transparent sacrificial material from the surface of the substrate (FIG. 60B), and allowing the textured polymer device to peel or release from the substrate (FIG. 60C).

FIG. 61 illustrates an example array of textured microstructures with overhanging features.

FIGS. 62A-62D illustrate an approach for multi-material frontal photopolymerization to fabricate overhanging textured microstructure surfaces. In FIG. 62A, a volume of a first liquid resin is disposed on a substrate and photopolymerization is used to polymerize portions of a first monomer to form one or more first microstructures of a first polymer on the substrate. In FIG. 62B, a volume of a second liquid resin is disposed on the substrate and photopolymerization is used to polymerize portions of a second monomer to form one or more second microstructures of a second polymer on the substrate. In FIG. 62C, a dissolving liquid is disposed on the substrate and caused to dissolve the one or more first microstructures of the first polymer on the substrate. In FIG. 62D, the one or more second microstructures of the second polymer remain on the substate, forming a surface having overhanging textured microstructures of the second polymer formed thereon.

FIGS. 63A-63E illustrate an example approach for single or multi-material photopolymerization of stacked structures on a substrate by initial exposure of a liquid resin to a patterned light having a first focal plane and subsequent exposure of the liquid resin or another liquid resin to a patterned light having a second focal plane to form stacked photopolymerized structures on the substrate through discrete sequential exposure. In FIG. 63A, a first focal plane of a first emission of patterned UV light is formed at an interface between resin and a transparent substrate. In FIG. 63B, an example of a first light pattern is illustrated. In FIG. 63C, a second focal plane of a second emission of patterned UV light is formed at the interface between resin and the transparent substrate. In FIG. 63D, an example of a second light pattern is illustrated. In FIG. 63E, a sequential combination of the first emission of patterned UV light patterned according to the first light pattern and the second emission of patterned UV light patterned according to the second light pattern forms a complex structure on the transparent substrate through photopolymerization of the resin.

FIGS. 64A-64G illustrate an example approach for replication of a textured polymer surface. FIG. 64A illustrates how a textured surface is fabricated through UV light emission through a transparent substrate and into a resin supported thereon. FIG. 64B illustrates that once the unpolymerized resin is removed from the substrate, a positive master of the textured surface is formed. FIG. 64C illustrates that PDMS can be cast on top of the positive master of the textured polymer substrate. FIG. 64D illustrates that, once the cast PDMS hardens/solidifies, the PDMS forms a negative mold that inversely corresponds to the positive master. FIG. 64E illustrates that liquid resin can be cast into an inner volume of the negative mold and exposed with non-patterned UV light. FIG. 64F illustrates that, once the liquid resin is cast into the inner volume of the negative mold, it hardens. FIG. 64G illustrates that, once the cast liquid resin hardens, it forms an exact or substantially exact replication of the textured polymer surface as represented by the positive master using, but now replicated in the new resin material.

FIG. 65 illustrates a computing device configured to carry out 3D printing methods and microdevice fabrication methods described in the present disclosure, according to an embodiment discussed herein.

FIG. 66 illustrates a computing device configured to carry out 3D printing methods and microdevice fabrication methods described in the present disclosure, according to an embodiment discussed herein.

FIG. 67 illustrates a method for 3D printing, according to an embodiment discussed herein.

FIG. 68 illustrates a method for 3D printing, according to an embodiment discussed herein.

FIG. 69 illustrates a method for 3D printing, according to an embodiment discussed herein.

FIG. 70 illustrates a method for 3D printing, according to an embodiment discussed herein.

FIG. 71 illustrates a method for 3D printing, according to an embodiment discussed herein.

FIG. 72 illustrates a method for 3D printing, according to an embodiment discussed herein.

FIG. 73 illustrates a method for 3D printing, according to an embodiment discussed herein.

FIG. 74 illustrates a method for 3D printing, according to an embodiment discussed herein.

FIG. 75 illustrates a method for 3D printing, according to an embodiment discussed herein.

FIG. 76 illustrates a method for 3D printing, according to an embodiment discussed herein.

FIG. 77 illustrates a method for 3D printing, according to an embodiment discussed herein.

FIG. 78 illustrates a method for 3D printing, according to an embodiment discussed herein.

### DETAILED DESCRIPTION

Three-dimensional (3D) printing has developed over the years and proved valuable in many fields, ranging from biomedical engineering to aerospace applications. However, preparing micro- and nano-scale textured surfaces and topographical microstructures, for example, has presented several challenges. Indeed, issues such as material waste, micro/nano-structure dimensional imprecision, undesirable cost and manufacturing complexity, material failure, and other issues can occur while attempting to print micro- and nano-scale textured surfaces and topographical microstructures. Further, preparing such surfaces with varying physical properties at different locations/depths across/within the microstructures and/or nanostructures of the surface or microstructure has presented additional difficulties. There are currently no facile and efficient methods for preparing such textured surfaces and/or topographical microstructures that is sufficiently simple and not overly wasteful. The subject matter described herein meets this and/or other needs and solves at least some of the problems identified herein.

Textured surfaces, e.g., nanotextured surfaces, are surfaces that have features with dimensions on the nanometer scale (typically between about 1 nanometer and about 100 nanometers). These surfaces can be created using a variety of techniques, including:

Top-down lithography, which involves using a focused beam of electrons or ions to etch away material from a surface, creating patterns and features on the nanoscale. This technique is commonly used in the semiconductor industry to create nanoscale circuits and devices.

Bottom-up self-assembly involves molecules or nanoparticles being arranged on a surface in a way that leads to the formation of nanoscale patterns or structures. This can be achieved through a variety of methods, such as chemical reactions, electrostatic forces, and van der Waals interactions.

Physical vapor deposition involves depositing material onto a surface using a vacuum-based process, such as sputtering or evaporation. By controlling the deposition parameters, such as the temperature and pressure, it is possible to create nanoscale features on the surface.

Chemical etching involves using chemical solutions to selectively remove material from a surface, creating nanoscale patterns and features. The technique can be used with a wide range of materials, including metals, semiconductors, and polymers.

Other techniques for forming patterned/textured surfaces and topographical microstructures can be carried out using micromilling, photolithography, soft lithography, direct write, or stereolithography. These techniques are often costly and time-consuming, involving multiple complex steps.

Topographical microstructures are often formed using similar or the same techniques.

Overall, there are many different techniques that can be used to create patterned/textured surfaces and/or topographical microstructures, and the choice of method will depend on the specific application and the materials being used. Such applications can include, e.g., metamaterials, metalenses, microfluidics, optical lenses, holography, hardware security, hydrophobic surfaces, lubricious surfaces, antifouling surfaces, and friction control, among others.

In the present disclosure, various approaches for improved photopolymerization are described. Photopolymerization is a process in which a liquid monomer is transformed into a solid polymer by the application of light. This transformation occurs through the activation of photo-initiators, which absorb light energy and produce free radicals that initiate a chemical reaction between the monomer molecules.

In the context of forming patterned surfaces, textured surfaces, and topographical microstructures, photopolymerization is often used in a technique known as photolithography. In this process, a patterned mask is placed over a substrate coated with a photosensitive polymer, and light is directed onto the substrate. The areas of the polymer that are exposed to the light undergo photopolymerization and become solid, while the areas that are blocked by the mask remain liquid.

This technique can be used to create textured surfaces and topographical microstructures by varying the intensity and duration of the light exposure, as well as the composition of the polymer. By controlling these parameters, it is possible to create surfaces with a wide range of textures, from fine patterns to larger, more complex structures.

One application of this technique is in the production of micro- and nano-scale devices and structures, such as sensors, lenses, and electronic components. Using photolithography to create textured surfaces can reduce the loss of raw material from subtractive techniques, such as laser/thermal/chemical etching, or the like.

In stereolithography and photolithography, optical radiation is often used to photopolymerize suitable raw material to produce a desired object. The raw material comes to the process in the form of a resin. A vat is used to hold an amount of resin, and a build platform is moved in the vertical direction so that the object to be produced grows layer by layer onto a build surface of the build platform. The optical radiation used for photopolymerizing may come from above the vat, in which case the build platform moves downwards through the remaining resin as the manufacturing proceeds.

The present disclosure more fully describes various embodiments with reference to the accompanying drawings. It should be understood that some, but not all, embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments of the present disclosure will now be described more fully hereinafter with reference to the accompanying drawings, in which some, but not all embodiments of the disclosed systems, methods, and apparatuses are shown. Indeed, the disclosed systems, methods, and apparatuses may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

As used herein, the terms “instructions,” “file,” “designs,” “data,” “content,” “information,” and similar terms may be used interchangeably, according to some example embodiments of the present disclosure, to refer to data capable of being transmitted, received, operated on, displayed, and/or stored. Thus, use of any such terms should not be taken to limit the spirit and scope of the disclosure. Further, where a computing device is described herein to receive data from another computing device, it will be appreciated that the data may be received directly from the other computing device or may be received indirectly via one or more computing devices, such as, for example, one or more servers, relays, routers, network access points, base stations, and/or the like.

As used herein, the term “computer-readable medium” refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, and infrared waves. Signals include man-made transient variations in amplitude, frequency, phase, polarization, or other physical properties transmitted through the transmission media. Examples of non-transitory computer-readable media include a floppy disk, a flexible disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments. By way of example only, a design file for a printed article may be stored on a computer-readable medium and may be read by a computing device, such as described hereinbelow, for controlling part or all of a 3D printing process and associated apparatuses and components, according to various embodiments described herein.

As used herein, the term “circuitry” refers to all of the following: (a) hardware-only circuit implementations (such as implementations in only analog and/or digital circuitry); (b) to combinations of circuits and computer program product(s) comprising software (and/or firmware instructions stored on one or more computer readable memories), such as (as applicable): (i) to a combination of processor(s) or (ii) to portions of processor(s)/software (including digital signal processor(s)), software, and memory (ies) that work together to cause an apparatus, such as a mobile phone or server, to perform various functions described herein); and (c) to circuits, such as, for example, a microprocessor(s) or a portion of a microprocessor(s), that require software or firmware for operation, even if the software or firmware is not physically present. This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, other network device, and/or other computing device.

As used herein, the term “computing device” refers to a specialized, centralized device, network, or system, comprising at least a processor and a memory device including computer program code, and configured to provide guidance or direction related to the charge transactions carried out in one or more charging networks.

As used herein, the terms “about,” “substantially,” and “approximately” generally mean plus or minus 50% of the value stated, e.g., about 200 μm would include 100 μm to 300 μm, about 1,000 μm would include 500 μm to 1,500 μm. Any provided value, whether or not it is modified by terms such as “about,” “substantially,” or “approximately,” all refer to and hereby disclose associated values or ranges of values thereabout, as described above.

As used herein, “and/or” refers to and encompasses any and all possible combinations of one or more of the associated listed items, as well as the lack of combinations when interpreted in the alternative (“or”).

As used herein, conditional language used herein, such as, among others, “can,” “could,” “might,” “may,” “e.g.,” and the like, unless specifically stated otherwise or otherwise understood within the context as used, is generally intended to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

As used herein, “stereolithographic” or “stereolithography” refers to a form of 3D printing technology (also known as additive manufacturing) used for creating models, prototypes, patterns, and production parts in a layer-by-layer fashion using photochemical processes by which light causes chemical monomers and oligomers to cross-link together to form polymers. These polymers then comprise the body of a three-dimensional solid. As described herein, hollow regions or blocking compositions that are not photopolymerizable can be introduced into the three-dimensional solids prepared using stereolithographic means.

As used herein, the terms “resin” and “monomer” may be used interchangeably. In some embodiments, a “resin” may comprise one or more of: a monomer, a photoinitiator, a photoabsorber, an inhibitor, a dye, micro/nano particles, any other component desired for polymerization or the resulting 3D object, or combinations thereof. As used herein, a “liquid resin” or a “liquid monomer” will generally be used to refer to the fluid in the containment vessel that is used to form the solid polymer and may include the components listed above for a resin and any other additional component desired for the resulting 3D object. The liquid monomer can include metal, polymer, ceramic, and/or a mixture thereof, such as organic molecules, monomer, or polymer with dispersed metal or ceramic nanoparticles. The liquid monomer may be any suitable composition to form the desired solid polymer from liquid material.

As used herein, the term “polymerization” or “curing” may refer to the process of converting liquid monomer into a “solid polymer.” The method may not be limited to creating “polymers” (e.g., “plastics”). The disclosed devices and methods may be used to create any 3D object out of any suitable materials, for example, polymers, metals, ceramics, etc., and combinations thereof. The materials may be modified to prepare the desired object from the desired material. Thus, while the reaction process (e.g., the process of converting a liquid component to a solid component) is generally referred to as polymerization and with reference to a liquid monomer, the disclosed devices and methods may be used to create any 3D object out of any suitable materials, for example, polymers, metals, ceramics, etc., and combinations thereof, and may use liquid forms of these materials and then convert such forms to solid to form the 3D object.

Reference may be made throughout the present disclosure to “UV light” as the light that initiates polymerization. Light may allow for spatially controlling where polymerization occurs. However, light of any wavelength (e.g., a narrow spectrum or a broad spectrum) may be used. That is, the disclosure may be applied to light of any wavelength.

As used herein, “photopolymerization” or “photopolymerize” refer to a polymerization reaction induced by light exposure.

As used herein, a “resin” may be composed of monomer, initiator, dye, photo-absorber, inhibitor, and/or loaded micro/nano particles. The “resin” is generally used to refer to the fluid in a containment vessel that is used to form the solid polymer and may include the before-mentioned components. The “initiator” is responsible for reacting with UV light to create a free-radical and start the crosslinking reaction of the monomers. The UV light spatially controls where the resin will solidify. The photo-absorbers/dyes reduce the UV light penetration depth. The initiator is generally a “photo-initiator” because UV light is needed to initiate the reaction. However, other initiators (e.g., thermal initiators) can be added to the resin composition. The polymerization reaction is generally exothermic, so the presence of a thermal initiator can also affect the polymerization process. Furthermore, other additives, e.g., nano-particles, dyes, and fillers can be added to bring additional functionality to the fabricated part (e.g., color or mechanical strength). For example, the resin can include fumed silica particles.

As used herein, “polymerization” refers to the process of converting a resin into a “solid polymer.”

As used herein, “polymer” refers to the product of a polymerization reaction in which one or more monomers are linked together.

Reference may be made throughout the present disclosure to “UV light” as the light that initiates polymerization. However, the polymerization light may be of any wavelength in the electromagnetic spectrum (e.g., from a narrow spectrum or a broad spectrum). That is, the disclosure may be applied to light of any wavelength. In certain embodiments, the polymerization light has a wavelength of about 385 nm. In certain other embodiments, the polymerization light has a wavelength of about 405 nm or 365 nm.

Additive manufacturing (AM) or 3D printing is a process of fabricating 3D objects by sequentially adding materials to the object being built until it reaches its final geometrical form. Each subsequent addition of material to the object is selectively placed in order to make the desired geometrical form of the final 3D object. Because of the ability to fabricate complex 3D objects using additive manufacturing, additive manufacturing is also generally referred to as 3D printing. As used herein, the product resulting from application of the disclosed methods and use of the disclosed devices is generally referred to as the 3D object.

Stereolithography and microstereolithography are one type of additive manufacturing. Microstereolithography is generally used to refer to the fabrication of objects on a micrometer scale. However, the method and its basic principles may be scalable to a macro scale (that is, stereolithography). Thus, the methods described herein are applicable to both microstereolithography and stereolithography.

Stereolithography allows for the fabrication of 3D objects by sequentially depositing materials, e.g., through radical chain polymerization, to a solid polymer until the object reaches its final geometrical form. Each subsequent addition of material may occur along the height of the object (e.g., along the z-axis). Traditionally, the process may allow for “layer-by-layer” growth, where each layer has a finite thickness.

### Overview

Provided herein are systems, methods, and apparatuses for fabricating/forming polymeric microdevices and patterned/textured surfaces with arbitrary geometries and textures utilizing frontal photopolymerization. Using the micro-patterning method of at least some of the disclosed embodiments, a geometry of the polymer devices/microdevices and patterned/textured surfaces can be controlled in all three-dimensions (e.g., x, y, and z-axes) and can comprise one or multiple materials.

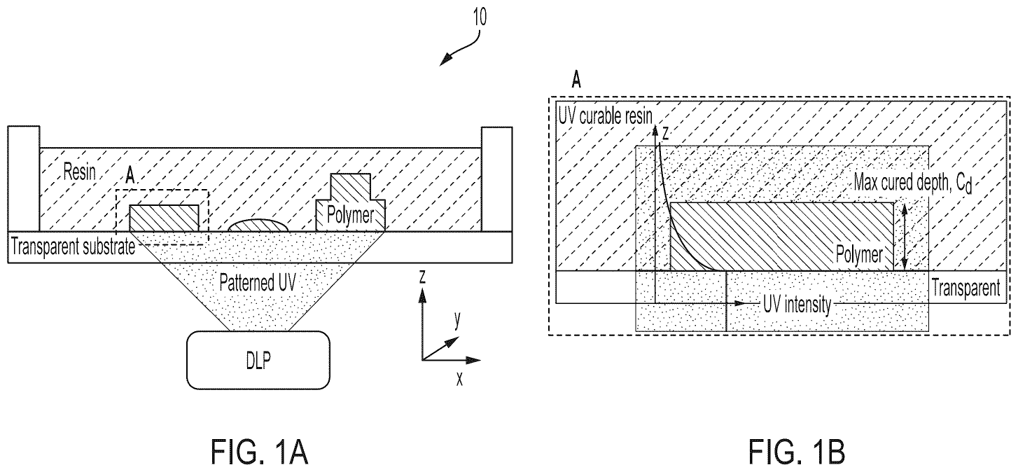

A general overview of an apparatus 10 utilizing frontal photopolymerization technique is given in FIGS. 1A-1B. As shown in FIG. 1A, a liquid resin is adjacent to a transparent substrate (e.g., glass, microscope slides, cyclic olefin copolymer film, polyethylene terephthalate film) of the apparatus 10. A spatial light modulator (e.g., DLP projector) of the apparatus 10 projects patterned light (e.g., UV light) through the transparent substrate of the apparatus 10 and into the resin. The projection focal plane is at the interface of the substrate and the resin. As shown in FIG. 1B, the intensity of the UV light decreases exponentially along the vertical axis (z-axis) within the resin. The attenuation of light is given by Beer's Law and is a function of absorption caused by the resin. Additives in the resin (e.g., photoinitiators and photo-absorbers/dyes) contribute the absorption factor. The solidification of the resin through polymerization begins at the interface of the substrate and continues to grow spatially and temporally along the z-axis. The polymer fabricated adheres to the substrate during the process.

The maximum cured height/thickness, C_{d}, of the polymer is modeled by Equation 1.

$${C}_{d} = {D}_{p} ln \frac{E}{Ec} \qquad Equation 1$$

$${D}_{p} = \frac{1}{α}$$

wherein C_{d} a is a maximum cured depth, Dₚ is a characteristic absorption length, a is a resin absorption factor, E_{c} is a minimum exposure energy dose required to initiate polymerization, and E is an exposure energy dose used for printing. In some embodiments, the characteristic absorption length Dₚ can be inversely correlated with an absorption constant of the resin.

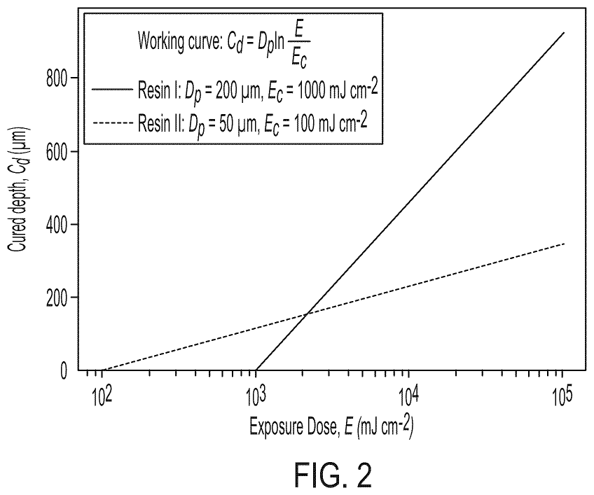

The cured height is primarily affected by the absorption constant of the resin (e.g., inverse of Dₚ) and the minimum exposure dose energy required to initiate polymerization (E_{c}). The exposure dose energy (E) is the product of the UV light intensity and irradiation time. Using Equation 1, the graph in FIG. 2 shows an example of the polymer cured depth as a function of incident UV exposure dose for two different theoretical resins. Dₚ is inverse of the absorption constant of the resin and the slope of the line in FIG. 2. When absorption factor of the resin increases (lower Dₚ), the resulting cured thickness is lower, and it is less sensitive to the incident exposure energy. E_{c} is the minimum exposure energy required to initiate polymerization. A lower E_{c} means the resin is more reactive to onset of polymerization, while a higher Fe means it is less reactive. For a constant exposure dose, higher Dₚ or a lower E_{c} enables a larger cured thickness, and vice versa.

Photopolymerization with Patterned Light

During photopolymerization, a liquid resin is converted into a solid polymer when it is irradiated with light (e.g., UV light). Photopolymerization is commonly used for stereolithography based additive manufacturing (e.g., 3D printing). In some embodiments, frontal photopolymerization is used instead of stereolithography to create solid parts with patterned surfaces.

Aspects of the disclosure relate to light (e.g., UV light) patterned using a spatial light modulator (SLM) such as a Texas Instrument DLP projector. Alternatively, the light can be patterned using other techniques such as an LCD or a static lithography photomask (e.g., a stencil). A SLM can be dimensioned and configured to control an amplitude of the emitted light, a phase of the emitted light, a polarization of the emitted light, and/or the like. Light patterning can include patterning of multi-wavelength light. The emitted light can be patterned dynamically or statically to vary the incident light and patterning thereof that reaches the resin. The DLP projector outputs images that are inputted to the DLP projector and may be configured to have a set maximum output power from the UV LED internally. Input images may be grayscale images, wherein the projected UV light pattern maps to the input grayscale image. In the disclosure, black refers to no UV light, white refers to maximum UV intensity, and gray refers to UV intensity proportional to gray value. The UV light and its intensity can be spatially (x, y-axis) modulated using grayscale image.

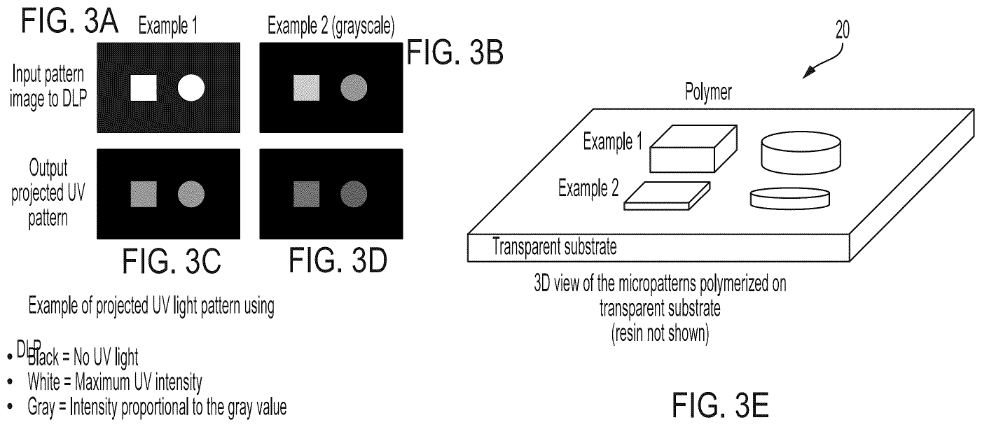

FIGS. 3A-3E illustrate an example of how patterning of the UV light can be used to fabricate polymer structures 20. FIGS. 3A-3D illustrate patterns that can be inputted into the DLP in order to emit or project therefrom a correspondingly patterned UV light. The input images in FIGS. 3A-3D are grayscale images ranging from black to white. The grayscale values can range from 0 to 255, where 0 is black and 255 is white and any value in between is gray. The projected output from the DLP is a UV light with an intensity that is proportional the grayscale value. FIG. 3E shows a cured polymer (as 3D microstructures) on the transparent substrate (e.g., glass). The uncured resin is not shown for simplicity. The UV light is projected from the bottom of the substrate. The resulting polymer thickness is affected but the intensity of the UV light which is controlled by the grayscale patterns.

### Fabrication System

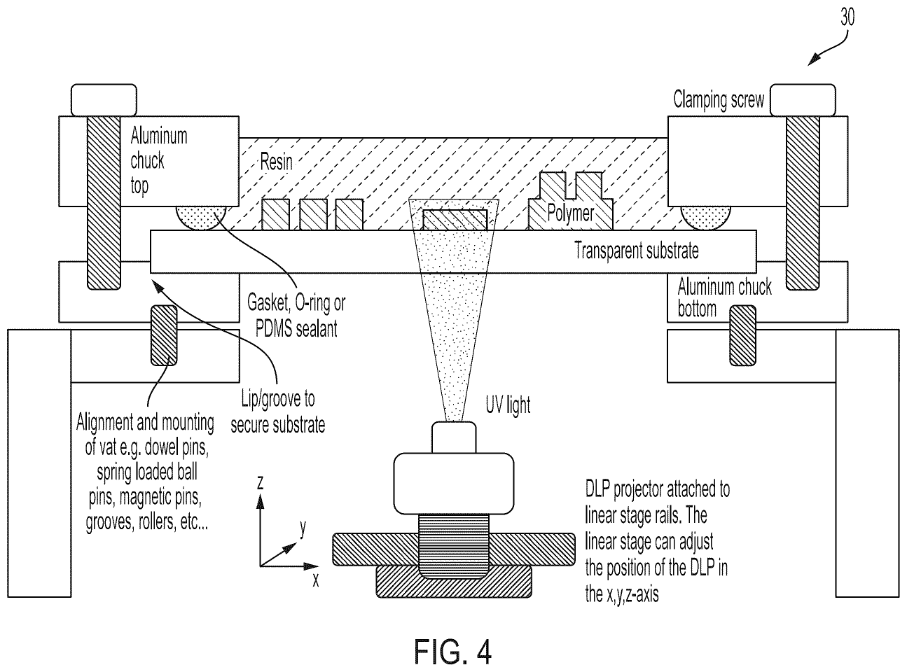

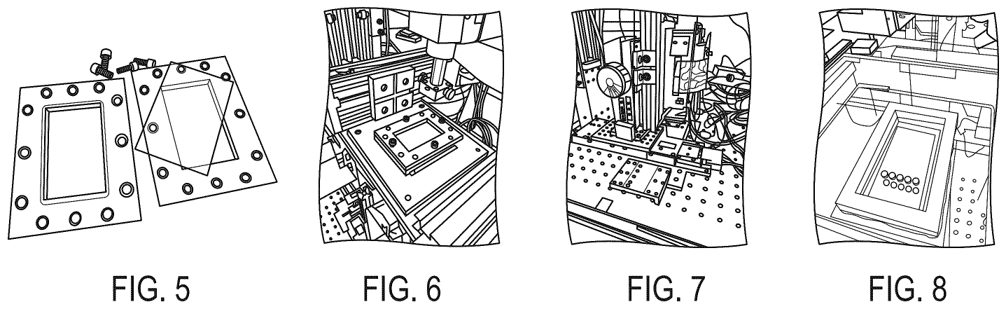

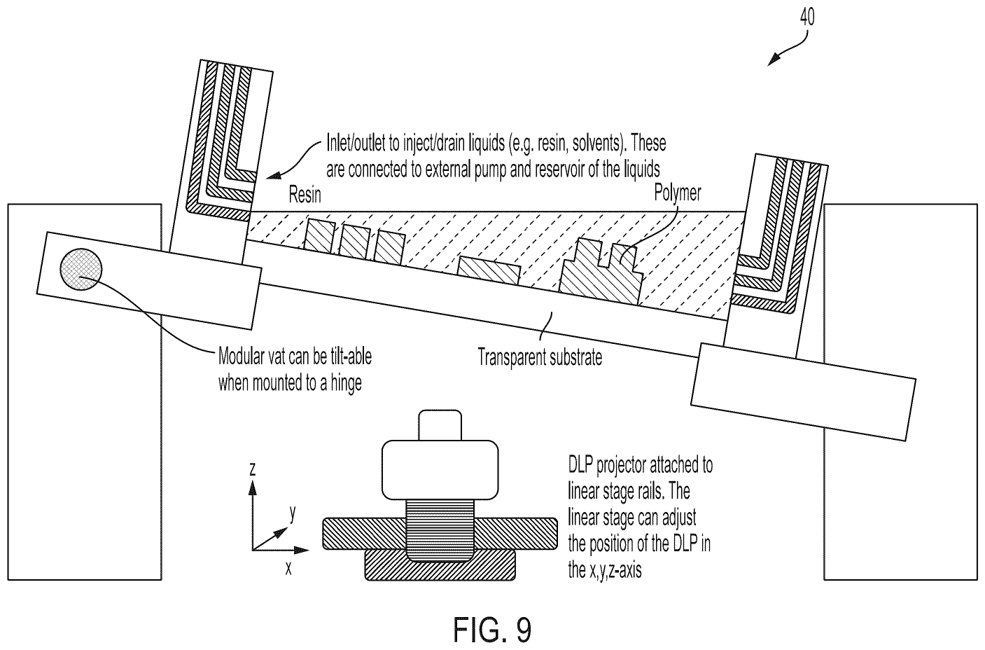

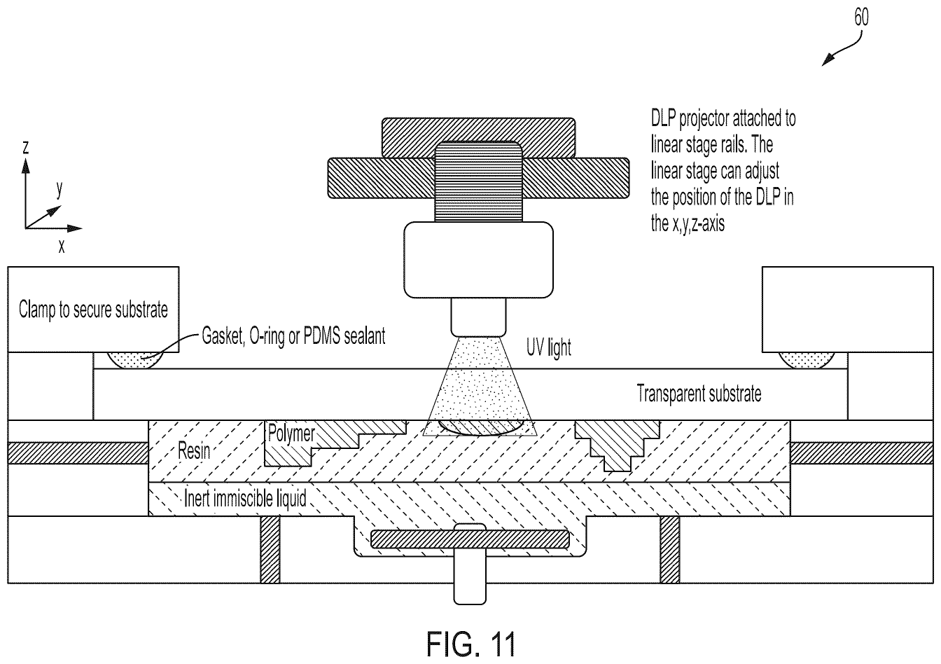

FIG. 4 shows a general schematic of a fabrication system 30 to fabricate micropatterns disclosed herein. FIGS. 5-8 show pictures of actual hardware used.

In some embodiments, the fabrication system 30 comprises a modular vat wherein a transparent substrate (e.g., glass) is clamped between a top and a bottom aluminum chuck. In some embodiments, the chuck comprises a lip/groove to secure the substrate in place. A region above the substrate is filled with a liquid resin. In some embodiments, the chuck comprises grooves for an O-ring, a gasket or silicone-based sealing, which prevents the liquid resin from leaking out. In some embodiments, the transparent substrate is interchanged after removing the liquid resin.

In some embodiments, a modular vat is mounted or secured onto a fixed platform of the fabrication system 30 using grooves, alignment pins, spring loaded balls, and/or magnetic pins to prevent the vat from moving. The vat can be manually removed and placed back onto the platform without losing position/alignment.

In some embodiments, the transparent substrate of the fabrication system 30 can comprise soda lime glass, quartz glass, cyclic olefin copolymer (COC) film, or polyethylene terephthalate (PET) film. In some embodiments, the transparent substrate of the fabrication system 30 is treated to improve adhesion of the polymer to the transparent substrate (e.g., treatment with UV ozone plasma or silanization with 3-(Trimethoxysilyl) propyl methacrylate).

### Vat Above Light Source

In some embodiments, a DLP projection system is located below the transparent substrate of the fabrication system 30. In some embodiments, the DLP projection system is mounted to a 3-axis linear stage, wherein the stage can be programmatically moved in the x, y, and z directions. Movement of the DLP projection system in the x and y direction allows for polymerization of resin in different locations of the substrate. Movement of the DLP projection system along the z-axis allows a focal plane of the DLP to be adjusted. The focal plane may be changed depending on the thickness of the substrate used.

In some embodiments a DLP projection system and/or linear stage of the fabrication system 30 are connected to a control software. The control software can be used for automation of the fabrication, process planning, and implementation of the general steps described herein, within the fabrication system 30.

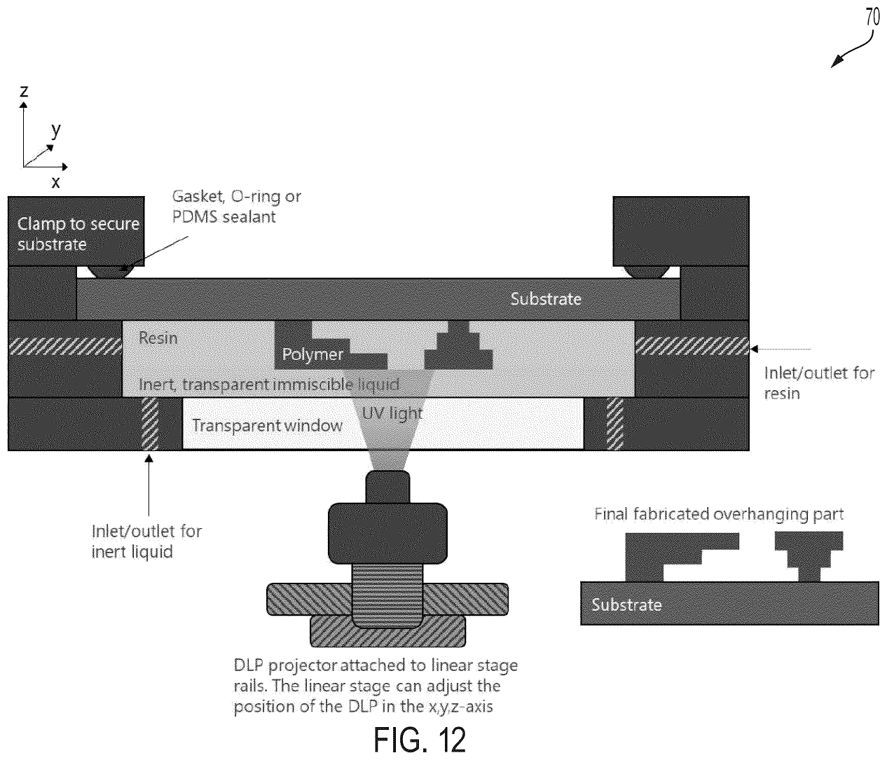

In some embodiments, such as shown in FIG. 9, a fabrication system 40 comprises a modular vat. In some embodiments, the modular vat can be mechanically tilted. Tilting may be performed to facilitate mixing, stirring, and/or vibrating the resin in vat. Additionally tilting may facilitate draining of liquids in the vat.

### Vat Below Light Source

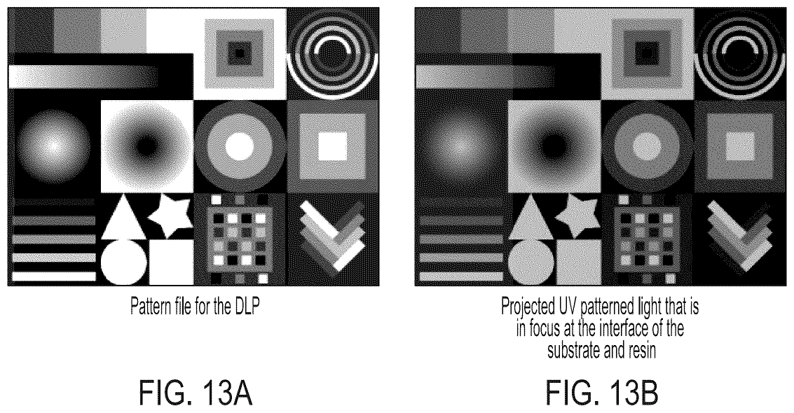

In other embodiments, such as shown in FIG. 10, a fabrication system 50 comprises a modular vat, wherein the vat is below a transparent substrate and light is projected from above. In some embodiments, the transparent substrate is mounted in place with a top clamping plate and sealing. In some embodiments the transparent substrate is rigid. In other embodiments the transparent substrate is flexible, such as a stretchable film. In some embodiments, a fully sealed vat chamber is formed, wherein the substrate and top clamping plate fully covers the entire area of the bottom vat.

In some embodiments, the modular vat comprises inlet and/or outlet holes to inject and/or drain liquids (e.g., resin and/or solvents). In some embodiments inlets and/or outlets are connected to an external liquid reservoir, pump and/or vacuum to facilitate the injection and/or draining of liquids in the vat. In some embodiments, inlets and/or outlets are used to replace resin with the same or a different type of resin. In some embodiments, inlets and/or outlets are used to stir or mix resin. In some embodiments, inlets and/or outlets are used to keep resin in a state of continuous flow. In some embodiments, inlets and/or outlets are used to rinse the substrate and/or polymer with solvents. In some embodiments, rinsing is performed between switching from one type of resin to a different type of resin. In some embodiments, a vacuum is used to decrease the pressure in a vat chamber to evaporate cleaning solvents.

In some embodiments, the modular vat comprises one or more rotating device (e.g., fan or a magnetic stirring rods), which may be inside a recessed region. The rotating device allows for the resin to be stirred, mixed, or in a state of continuous flow during UV exposure.

In some embodiments, the vertically height of the vat chamber is greater than the height of the fabricated polymers. Thus, the polymerization of the polymer only remains constrained on one end, the substrate.

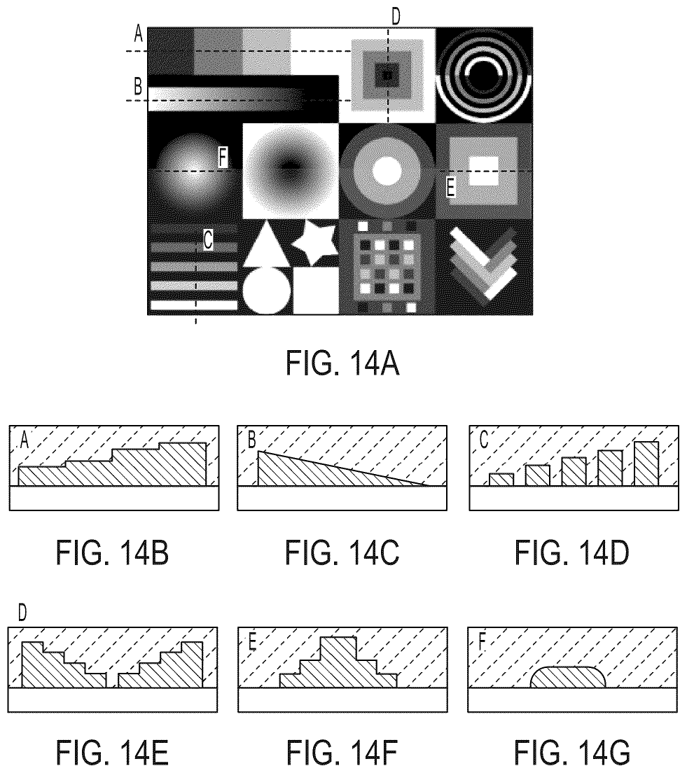

In some embodiments, such as shown in FIG. 11, a fabrication system 60 can include a modular vat that comprises a layer of inert immiscible liquid, wherein the inert immiscible liquid has a density different from that of the resin and constrains the bottom of the resin. In some embodiments, the inert immiscible liquid dynamically controls the vertical height of the resin in the chamber, wherein the height of the resin is changed temporally by inletting or draining the resin and/or the inert immiscible liquid. In some embodiments, the inert immiscible liquid provides a source of reactants that can diffuse into the resin (e.g., inhibitors such as oxygen to inhibit the polymerization reaction). In some embodiments, the inert immiscible liquid is in a state of continuous flow, facilitated by inlet and outlet ports and/or a rotating device.

In some embodiments, the inert immiscible liquid can be used to limit a maximum cured thickness of the polymer. For example, without wishing to be bound by any particular theory, a user can use an exposure dose of E1, which theoretically would result in a cured thickness of the polymer to be H1. However, if the inert immiscible liquid (e.g., resin) thickness is H2, where H2 is less than H1, then the maximum cured thickness of the polymer will be H2. In some embodiments, the resin thickness can be controlled at least in part by the thickness of the inert liquid below it, as shown in FIG. 11.

In some embodiments, the inert immiscible liquid can function as a carrier of reactants that cannot be include in the resin itself (e.g., oxygen or other filler particles), a transport carrier (e.g., heat or precipitant from polymerization reaction), a “liquid boundary”, and/or a dynamic polymer height controller.

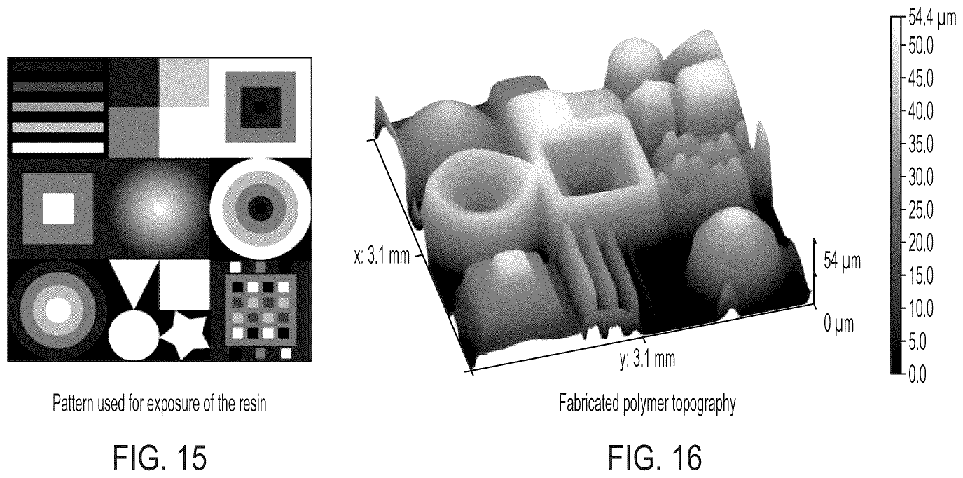

In some embodiments, such as shown in FIG. 12, a fabrication system 70 can be used for topographical patterning of emitted light. In some embodiments, a method can include fabricating reentrant structures in one step, where other approaches typically otherwise would require multiple steps.

In some embodiments, the fabrication system 70 can include a device configured for fabrication of overhanging structure. In some embodiments, overhanging or freeform topography can be important for various applications, such as antennas and reentrant microstructures. In some embodiments, the fabrication system 70 can be configured for fabricating overhanging textured microstructures using multi-material front-photopolymerization. In other embodiments, the fabrication system 70 can be configured for fabricating overhanding textured microstructures using single-material front-photopolymerization, e.g., using a single resin material.

The fabrication system 70 can be similar to, but a variant of, the fabrication system 60 illustrated in FIG. 11. As such, the fabrication system 70 can also include a modular vat that comprises a layer of inert immiscible liquid, wherein the inert immiscible liquid has a density different from that of the resin and constrains the bottom of the resin. In some embodiments, the inert immiscible liquid dynamically controls the vertical height of the resin in the chamber, wherein the height of the resin is changed temporally by inletting or draining the resin and/or the inert immiscible liquid. In some embodiments, the inert immiscible liquid provides a source of reactants that can diffuse into the resin (e.g., inhibitors such as oxygen to inhibit the polymerization reaction). In some embodiments, the inert immiscible liquid is in a state of continuous flow, facilitated by inlet and outlet ports and/or a rotating device.

In some embodiments, the inert immiscible liquid can be used to limit a maximum cured thickness of the polymer. For example, without wishing to be bound by any particular theory, a user can use an exposure dose of E1, which theoretically would result in a cured thickness of the polymer to be H1. However, if the inert immiscible liquid (e.g., resin) thickness is H2, where H2 is less than H1, then the maximum cured thickness of the polymer will be H2. In some embodiments, the resin thickness can be controlled at least in part by the thickness of the inert liquid below it, as shown in FIG. 12.

In some embodiments, the inert immiscible liquid can function as a carrier of reactants that cannot be include in the resin itself (e.g., oxygen or other filler particles), a transport carrier (e.g., heat or precipitant from polymerization reaction), a “liquid boundary”, and/or a dynamic polymer height controller.

In some embodiments, a resin can be constrained between two interfaces. For example, a first interface can be an inert, transparent, immiscible liquid while the second interface is the substrate (e.g., transparent substrate). In some embodiments, projected patterned UV light can be passed through the substrate or a transparent window in the substrate and/or through the transparent inert liquid, and then reach the interface of the resin. The polymerization of resin may begin at the interface of the resin and the transparent inert liquid. The polymer height of the polymer can grow towards the substrate. The height of the polymer may be determined by the exposure dose, resin formulation, and/or other factors, such as those already discussed elsewhere in this disclosure. A portion of the polymerized feature can grow to a maximum allowable thickness determined by the resin height. This portion of the polymer may adhere to the substrate that is touching the resin. Overhanging microstructure may be realized when one portion of the polymerized feature has a cured thickness less than the height of the resin (e.g., not touch the substrate), while another portion of the polymerized feature has a cured thickness equal to the height of the resin thickness (e.g., touching the substrate).

In some embodiments, the height of the resin can be dynamically controlled during the fabrication process by controlling the height of the inert liquid and the resin. Both of these heights can be varied by utilizing the inlet/outlet ports in the device to insert/dispose/flow/pump/drain either of the fluids (resin or inert liquid). The height of the fluids can be changed between each discrete exposure steps if desired. For example, before the first exposure, the resin can have a height of H1 and the inert liquid can have a height of H2. Once a portion of the microstructure of the resin is cured to create the desired microstructure, then before the second exposure, the resin height can change to H3 and the inert liquid can have a height H4. If resin height H1 is greater than resin height H3, then it is obvious that during the second exposure, the first polymerized microstructure may be partially submerged inside the inert liquid because during second exposure, height of the inert liquid H4 is greater than H2. However, this is not a problem because the first polymerized microstructure is already polymerized and it is not affected during the second exposure which may occur in a different region of the resin.

Herein, the term “inert liquid” is used, generally, to refer to a liquid that does not polymerize (e.g., does not polymerize in response to UV light exposure). Example heights of the inert liquid can range from about 1 μm to about 10 mm, inclusive of all values and ranges therebetween. Example resin heights can range from about 1 μm to about 10 mm, inclusive of all values and ranges therebetween.

In some embodiments, the inert liquid is intended to function as a both a constraining interface where the polymerization of the resin beings. The inert liquid may alternatively or additional function as a release agent since the polymerized feature(s) do(es) not permanently adhere thereto. Therefore, the cured microstructures can be separated/peeled from the inert liquid, e.g., without exerting a force that may destroy or strain the printed part/polymer piece. The inert liquid can also function as a carrier of reactants that may get incorporated within the resin and into the final polymerized microstructures.

In the device show in FIG. 12, for example, the inert liquid is desired to be inert, transparent and immiscible with the resin. Here the “inertness” is defined within the context of the photopolymerization, where it is the resin that has a higher reactivity and polymerization rate to the incident UV light relative to the inert liquid. It is desired that the inert liquid to be transparent or semi-transparent to allow the incident UV light to pass through and reach the resin. In the orientation of the device shown in FIG. 12 where the UV light is coming from the bottom, the inert liquid will have a higher density than the resin. In some embodiments, if the fabrication system 70 is oriented such that UV light is coming from the top, then the inert liquid may be desired to have a lower density than the resin. Density difference between the inert liquid is not required, but instead a viscosity difference and immiscibility or partial miscibility between the resin and the inert liquid can be leveraged. For example, in the device orientation shown in FIG. 12, the inert liquid can be highly viscous paste. Examples of the inert liquid can include, e.g., water, Fluorinert, Fomblin, Krytox, silicone, oil, and/or the like. The inert liquid can itself be a neat monomer that may be photopolymerizable but will have a lower reactivity/polymerization rate compared to the resin because the resin contains monomer plus a photoinitiator. For example, the resin can be composed of HDDA monomer and a TPO photoinitiator, while the inert liquid can be a high molecular weight (e.g., 4,000 g/mol) and high viscosity PEGDA neat monomer.

Within the context FIG. 12 in which the fabrication system 70 can be utilized to fabricate overhanging microstructure, the inert liquid does not need to be a liquid. Instead, in some embodiments, the inert material can be a solid, a gel, a semi-solid, and/or the like. For example, a solid medium adjacent to the transparent window can be a sacrificial film or a sacrificial layer on the substrate to facilitate ease of peeling/release of the polymer/polymerized topographical textures therefrom.

In some embodiments, when the inert liquid is a solid or a semi-solid, it may not be as easy (or not possible) to dynamically adjust the height of the resin or the inert liquid using the inlet/outlet flow ports.

As illustrated in FIG. 12, the fabrication system 70, instead of being configured to build parts additively (i.e., layer-by-layer), is configured to build desired parts by volumetric (i.e., 3D) polymerization. This may mean that the entire topography (e.g., lateral and vertical 3D shape) is capable of being polymerized in a single exposure. Therefore, a desired topography may not need to be approximated by multiple discrete layers (i.e., iterative 2D or 1D printing of 3D part) of exposure as it is typical in conventional stereolithography 3D printing process.

As used herein, the term “polymer” is used to refer to any cured polymer material, such as a polymer part, a polymer structure, a polymer surface coating, a polymer topography, a polymer texture, a polymer microstructure(s), and/or the like. However, the same or similar systems, devices, components, approaches, methods, and media as described herein are contemplated for use to fabricate non-polymeric devices also. One example of this includes adding functional fillers or nanoparticles into the resin. For example, the fillers can be or comprise fumed silica particles, fumed silica nanoparticles, metallic nanoparticles, and/or the like. The resulting fabricated parts are a composite of the polymer and ceramics and/or metals. However, with post processing, e.g., burn out and sintering of a green body part or the like, the organic polymer components can be removed and the results parts can be fully non-polymeric (e.g., ceramic, glass, metal, and/or the like).

### Continuous or Semi-Continuous System

In some embodiments, a continuous or semi-continuous method for fabricating a polymeric device or a polymeric surface can include moving a flexible substrate along a path between a dispensing roll and a receiving roll, disposing one or more volumes of a photocurable monomer onto one or more portions of the flexible substrates, projecting a patterned light into the one or more volumes of the photocurable monomer at one or more points along said path between the dispensing roll and the receiving roll, and modulating an effective exposure energy dose of the patterned light within the one or more volumes of the photocurable monomer to cause the one or more volumes of the photocurable monomer to form one or more photocured structures, wherein the exposure energy dose is a product of at least light exposure time and exposure intensity for respective of the one or more volumes of the photocurable monomer. Said otherwise, a method can be or include a ‘roll-to-roll’ type process in which the substrate is moved between two rolls, the resin/monomer is disposed thereon, and photopolymerization is carried out during movement of the substrate between the two rolls to form structures/texture on the substrate. As such, a process/method that might often or sometimes be a batch-wise process can alternatively or additionally be a continuous or semi-continuous fabrication process.

### Resin Formulation

The liquid resin can comprise monomer(s), oligomer(s), photoinitiator(s), photoexcitation initiator(s), hardening agent(s), curing agent(s), coloring agent(s), absorber(s), dye(s), inhibitor(s), rheological modifier(s), solvent(s), free radicalization agent(s), chain growth termination agent(s), filler(s), photoresist(s), negative resist(s), mechanical strengthening agent(s), conductive material(s), other functional additive(s), combinations thereof, and/or the like.

In some embodiments, the liquid resin comprises a photocurable monomer, wherein the monomer is a molecule that reacts by crosslinking with other monomer molecules upon exposure to light to form a solid polymer. In some embodiments, the photocurable monomer comprises an acrylate ester or a thiol-ene. In some embodiments, the photocurable monomer comprises epoxides, urethanes, polyethers, polyesters, acrylated epoxys, styrenes, vinylpyrrolidones, acrylates, SU-8, and/or the like. In some embodiments, the liquid resin comprises 1,6-Hexanediol diacrylate (HDDA). In some embodiments, the liquid resin comprises polyethylene glycol diacrylate (PEGDA). In some embodiments, the liquid resin comprises trimethylolpropane triacrylate.

In some embodiments, the liquid resin comprises a photoinitiator, wherein the photoinitiator is a molecule that creates a reactive species (e.g., a free radical) upon exposure to radiation (e.g., UV or visible light). In some embodiments, the photoinitiator is diphenyl (2,4,6-trimethylbenzoyl) phosphine oxide (TPO). In some embodiments, the photoinitiator is thioxanthen-9-one. In some embodiments, the photoinitiator is 2-hydroxy-2-methylpropiophenone. In some embodiments, the photoinitiator is 4,4′-bis(dimethylamino)benzophenone. In some embodiments, the liquid resin comprises photoexcitation initiators, such as iodium salts, sulfonium salts, ammonium slats, phosphonium slats, organometallics, ferrocenium salts, pyridinium salts, or the like.

In some embodiments, the liquid resin comprises an absorber or dye, wherein the dye passively absorbs or attenuates light. In some embodiments, the dye comprises Sudan I. In some embodiments, the dye comprises 2,5-bis(5-tert-butyl-benzoxazol-2-yl)thiophene. In some embodiments, the dye comprises 2-hydroxy-4-(octyloxy)benzophenone. In some embodiments, the dye comprises 2 (2-hydroxy-3,5-di-(1,1-dimethylbenzyl)]-2H-benzotriazole.

In some embodiments, the liquid resin comprises an inhibitor, wherein the inhibitor slows or retards the polymerization reaction. In some embodiments, the inhibitor is oxygen. In some embodiments, the inhibitor is p-methoxyphenol (MeHQ). In some embodiments, the inhibitor is 2,2,6,6-tetramethylpiperidinoxyl. In some embodiments, the inhibitor is bis [2-(o-chlorophenyl)-4,5diphenyl imidazole].

In some embodiments, the liquid resin comprises one or more functional additives, wherein the additive contributes a useful property to the polymeric device. In some embodiments the additive comprises fumed silica particles. In some embodiments the additive comprises naonparticles (e.g., barium titanate, iron oxide, titanium dioxide). In some embodiments the additive comprises poly(3,4-ethylenedioxythiophene) polystyrene sulfonate (PEDOT:PSS).

### Methods of Fabrication

Aspects of the disclosure relate to methods of fabricating topographical textured micropatterns and surfaces using frontal photopolymerization. Several techniques are used to spatially control the geometry of polymerization in the x, y, and z directions.

In some embodiments, the resin formulation is varied to control the vertical polymerization thickness (e.g., in the z-axis), wherein the characteristic absorption length (Dₚ) and minimum exposure energy dose required to initiate polymerization (E_{c}) are modified based on the resin formulation.

In some embodiments, lateral polymerization is controlled along the x-axis and y-axis using patterned light. In some embodiments, the exposure energy dose is modulated laterally and temporally to control lateral polymerization along the x-axis and y-axis along the depth of the resin in the z-axis. The exposure energy dose is the product of exposure time and exposure intensity. In some embodiments, grayscale patterns are used to spatially modulate exposure intensity laterally (e.g., along the x-axis and y-axis). In some embodiments, the exposure energy dose is modulated laterally by controlling the sequence and duration of pattern exposures.

In some embodiments, the degree of polymerization is influenced laterally (e.g., along the x-axis and y-axis) along the depth of the resin (e.g., z-axis) by leveraging the higher order effects of polymerization kinetics. In some embodiments, polymerization kinetics are controlled by a photoinitiator, wherein the photoinitiator concentration and efficiency onset the polymerization reaction. In some embodiments, polymerization kinetics are controlled by inhibitors in the resin (e.g., dissolved oxygen), wherein the concentration and spatial diffusion of the inhibitors can be modified.

In some embodiments, textured micropatterns and surfaces are fabricated by performing patterned light exposure. For example, prior to fabrication, a pattern for UV exposure is designed and prepared. Patterns can be designed and prepared using various methods. In some embodiments, a pattern design is translated into a grayscale image file that is inputted to a DLP projector. The projected UV light is spatially patterned (e.g., along the x-axis and y-axis) and has varying intensity that corresponds to the input grayscale image. In some embodiments, Python™ is used to programmatically design and determine the spatially location of each feature in the pattern. The patterns can be defined in “Scalable Vector Graphic (.SVG)” file format and then converted into an image file such as .PNG, BMP, .GIF, or .JPEG to be inputted to the DLP projector. In other embodiments, a pattern is designed in a 2D CAD software (e.g., Inkscape, GIMP, Photoshop or Illustrator) and then exported in a file format for input into the DLP projector (e.g., .PNG, .BMP, .GIF, or .JPEG). In some embodiments, a pattern is designed in photomask design software such as KLayout, then translated into a grayscale image format for input into the DLP projector. In some embodiments, a pattern is designed in 3D CAD software such as AutoCADX or SolidWorks, and a 3D CAD design is converted from a .STL file into multiple discrete exposures. The .STL file is sliced at various z-axis planes to generate the resulting pattern for exposure at different z-axis planes.

After the pattern is prepared, the fabrication system is then setup by attaching a transparent substrate. In some embodiments, the transparent substrate is glass, cyclic olefin copolymer film or polyethylene terephthalate film. In some embodiments the transparent substrate is flat. In other embodiments, the transparent substrate is curved. In some embodiments the transparent substrate is flexible. In some embodiments the surface of the transparent substrate is functionalized to improve adhesion of the polymers to the substrates (e.g., silane adhesion promoters).

After the fabrication system is setup, the focal plane of the spatial light modulator is adjusted such that the projected image is in focus at the substrate-resin interface. In some embodiments, the focus is manually checked with resin comprising a fluorescent dye, allowing the projected pattern to be seen at the interface of the substrate. The projected pattern is visually checked, and the position of the spatial light modulator or optical lenses are adjusted until the projected pattern is in focus. In some embodiments, the focus is checked using external cameras which automate the focusing process and allow the DLP or optical lens positions to be adjusted.

Then, the modular vat is filled with the liquid resin to be exposed. In some embodiments, the liquid resin is added with a pipette. In other embodiments, the liquid resin is poured into the modular vat (e.g., with a beaker). In other embodiments, the liquid resin is injected into the vat using a pump.

Next, frontal photopolymerization is performed by exposing the liquid resin to a pattern or multiple patterns of light. In some embodiments, the light exposure comprises a single shot of a pattern. In other embodiments, the light exposure comprises multiple discrete exposures of multiple patterns. In other embodiments, the light exposure comprises a movie exposure.

In some embodiments, an inter-exposure routine is carried out between multiple exposures. In some embodiments, the inter-exposure routine comprises waiting or pausing between exposures. In some embodiments, the inter-exposure routine comprises stirring, mixing, or vibrating the resin. In some embodiments, the inter-exposure routine comprises replacing the resin with the same type of resin or a different type of resin. Pausing between exposures, mixing the resin and/or draining and replacing resin with fresh resin of the same type can be used to influence high order effects of polymerization kinetics (e.g., diffusion of an inhibitor of polymerization), which facilitates the fabrication of curved surfaces.

In some embodiments, the inter-exposure routine comprises cleaning or rinsing the resin with a solvent. In some embodiments, the solvent for cleaning comprises water, isopropanol, methanol, acetone. In some embodiments, the inter-exposure routine comprises replacing the resin with a resin with the same components, but different formulation to allow for modulation of the curing thickness of the subsequent light exposure. In some embodiments, the inter-exposure routine comprises replacing the resin with another resin with different components for the multi-material heterogenous fabrication. In some embodiments, the spatial light modulator is moved to a new location to expose multiple areas using projection stitching.

### Light Exposure

The thickness (e.g., z-axis) and lateral shape (e.g., x-axis and y-axis) of the cured polymer will depend on the resin formulation, UV exposure time, UV exposure intensity and the projected pattern. A height of a cured polymer will depend on an exposure dose energy (time multiplied by intensity), e.g., as shown in Equation 1 and FIG. 2. A resin formulation is characterized to determine the inherent resin parameters (e.g., Dₚ and E_{c}, in Equation 1) to determine the exposure time and exposure intensity required for the desired cured thickness of the polymer. The maximum light intensity from the spatial light modulator, the range of exposure times, resin characteristics, and the desired range of thickness of the polymer are accounted for during pattern preparation.

Provided herein are several different exposure modes to fabricate polymeric devices and topographical surfaces. In embodiments of the present disclosure, a polymeric device or topographical surface can be fabricated using a single exposure, multiple exposures, and/or a dynamically changing exposure pattern. In some embodiments, the same polymeric device can be fabricated using different exposure modes.

### Single Exposure Mode

In some embodiments, a polymeric device or topographical surface is fabricated with a single shot exposure of patterned light. For single exposure methods, a grayscale pattern is designed, wherein the pattern must take into consideration the resin formulation, light intensity, and exposure time modeled (see, e.g., Equation 1) to control the fabricated microstructure heights.

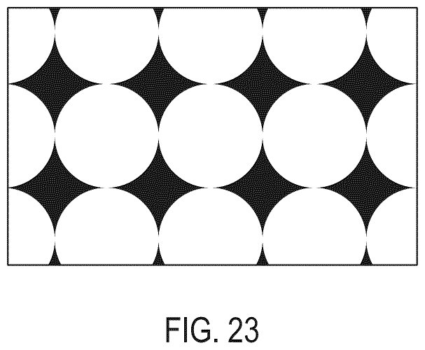

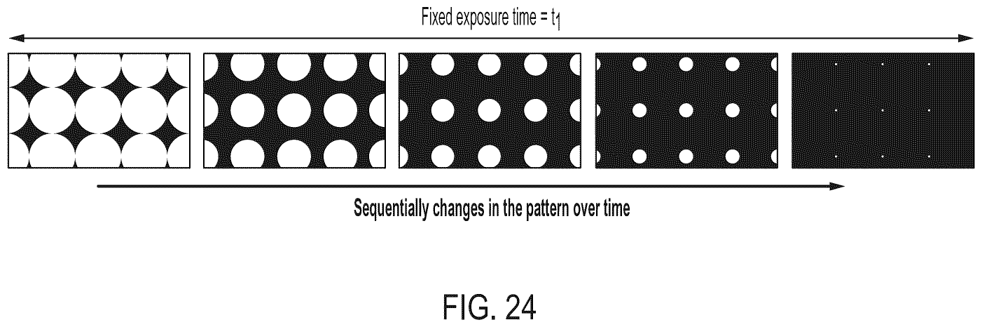

In one embodiment, a microstructure with the topographical geometry in FIG. 17 is fabricated with a single shot UV exposure, wherein the resin is irradiated with patterned UV light for a fixed exposure time by inputting the grayscale pattern shown in FIG. 18. The value G is the grayscale value that ranges from 0 to 255. G₀=0 (black), G₁=255 (white), and G₃>G₂. Spatial intensity of UV light is proportional to the grayscale value. A DLP projector is configured to have maximum output intensity of 20 mW/cm² when the grayscale value G₁=255 (white). Therefore, an intensity of UV light with a grayscale value of G₃=200 will be about 15.7 mW/cm² and a grayscale value of G₂=128 will have intensity of about 10 mW/cm².

The resin has a Dₚ=50 μm and E_{c}=100 mJ/cm² as shown in FIG. 2 and is exposed for a period of t=13 seconds. Based on the Equation 1, the cured thickness (Ca) can be determined, as shown in Equation 2, wherein E, the exposure energy dose, is the product of exposure intensity and exposure time.

$${C}_{d} = 50 ln \frac{E}{100} \qquad Equation 2$$

The height of each region of the pyramidal microstructure is determined by the exposure energy dose, which is the exposure time of 13 seconds multiplied by the exposure intensity.

$$When E = 10 ; {h}_{1} = 50 ln \frac{13 * 10}{100} = 13.1 um .$$

$$When E = 15.7 ; {h}_{2} = 50 ln \frac{13 * 15.7}{100} = 35.7 um .$$

$$When E = 15.7 ; {h}_{3} = 50 ln \frac{13 * 20}{100} = 47.8 um .$$

### Multiple Exposure Mode

In some embodiments, a polymeric device or topographical surface is fabricated with multiple discrete patterned exposures, wherein resin is sequentially irradiated with various sub-divided patterns. Each exposure results in a cured polymer at the desired spatial location. The use of a pattern, wherein the pattern spatially overlaps with previous patterns, results in an overlapping polymer stacked above the previously formed polymer.

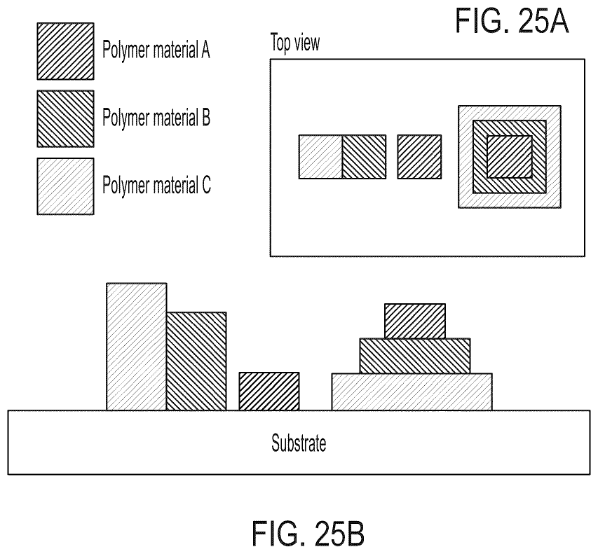

In one embodiment, a microstructure with the topographical geometry in FIG. 17 is fabricated with multiple discrete patterned exposures, without the need for a grayscale pattern. The multiple discrete exposure patterns used to fabricate the device of FIG. 17 are shown in FIGS. 19A-19C. The patterns are a subdivision of the pattern shown in FIG. 18 but are black and white and do not contain grayscale. The exposure of each pattern of FIGS. 19A-19C can be in any sequence (e.g., ABC, CBA, BCA, or BAC). The exposure time will control the height of the features and to attain geometry in FIG. 17, the exposure time must meet the criteria t_{c}>t_{B}>t_{A}. The exact exposure time required for each pattern can be dependent on the desired height of each segment of the microstructure. The h₁, h₂, h₃ values in FIG. 17 modeled in Equation 1 can be used to estimate the desired exposure time for a given resin formulation.

Without wishing to be bound by any particular theory, the use of multiple exposures may have the benefit of not requiring the determination of grayscale values during the pattern design and preparation process, as a simple black and white pattern can be used. Instead, the pattern design and preparation process require the determination and creation of sub-patterns designs such that the composite exposures will result in the desired geometry. In multiple exposure mode it is not necessary that all patterns overlap.

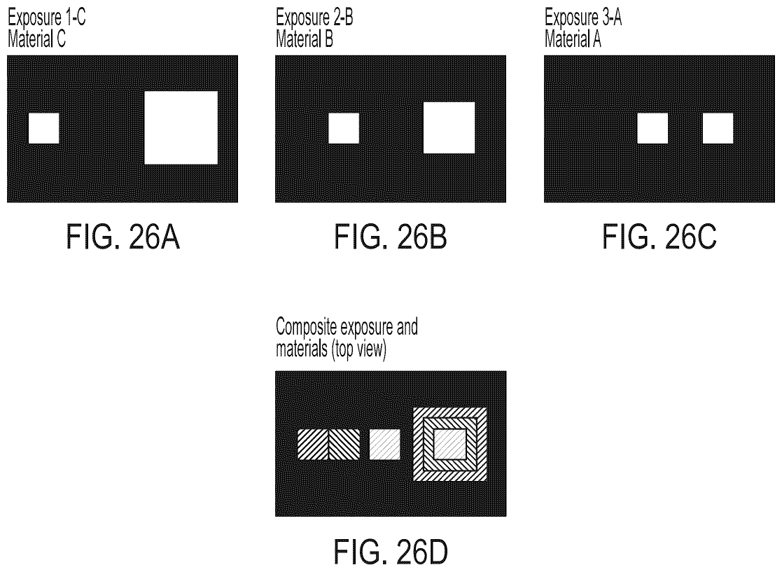

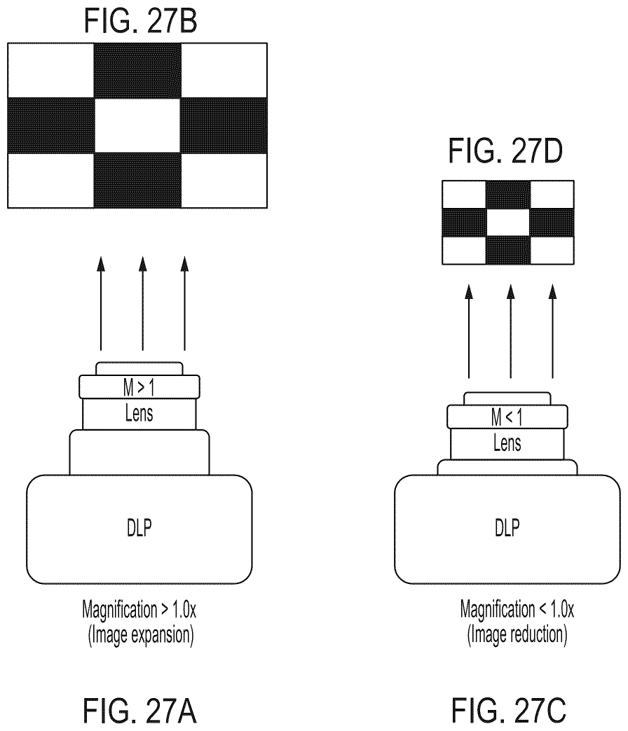

In some embodiments, polymeric microstructures with curved edges are fabricated using multiple discrete exposures with grayscale. In one embodiment, FIG. 20 shows a microstructure geometry where the different step heights of the polymer have curved edges. Unlike the geometry of FIG. 17 with sharp edges, it is not feasible to sub-divide the exposures into a simple black and white pattern because the curved steps would need to be estimated by tens to hundreds of exposures. Instead, the geometry of FIG. 20 is fabricated with patterns that contain grayscale, as shown in FIGS. 21A-21C. In FIGS. 21B-21C, patterns B and C contain squares with gradient grayscale values on the edges to estimate the curved steps. The exposure sequence can occur from A to B to C, where the exposure time must be t_{c}>t_{B}>t_{A}.

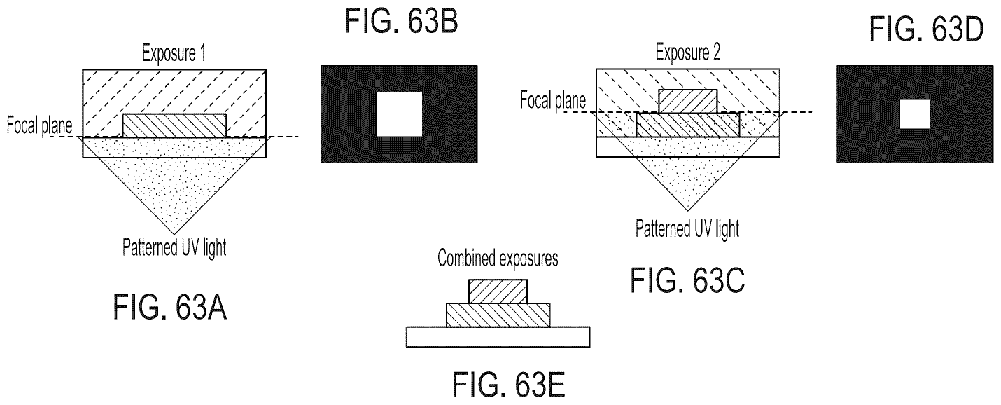

In some embodiments, the focal plane may be adjusted during an inter-exposure routine between multiple exposures (e.g., by adjusting the z-axis of the spatial light modulator). FIGS. 63A-63E illustrate an example approach for single or multi-material photopolymerization of stacked structures on a substrate by initial exposure of a liquid resin to a patterned light having a first focal plane and subsequent exposure of the liquid resin or another liquid resin to a patterned light having a second focal plane to form stacked photopolymerized structures on the substrate through discrete sequential exposure. In FIG. 63A, a first focal plane of a first emission of patterned UV light is formed at an interface between resin and a transparent substrate. In FIG. 63B, an example of a first light pattern is illustrated. In FIG. 63C, a second focal plane of a second emission of patterned UV light is formed at the interface between resin and the transparent substrate. In FIG. 63D, an example of a second light pattern is illustrated. In FIG. 63E, a sequential combination of the first emission of patterned UV light patterned according to the first light pattern and the second emission of patterned UV light patterned according to the second light pattern forms a complex structure on the transparent substrate through photopolymerization of the resin. In some embodiments, the example approach can be used for single or multi-material photopolymerization of stacked structures on a substrate. The example approach can comprise an initial exposure of a liquid resin to a patterned light having a first focal plane and a subsequent exposure of the liquid resin or another liquid resin to a patterned light having a second focal plane to form stacked photopolymerized structures on the substrate through discrete sequential exposure.

During stacked exposures, the first polymer segment formed during the first exposure can result in a lower UV transmission through itself during the second exposure. This decrease in UV transmission will depend on multiple factors such as thickness of the formed polymer and the material properties. For example, if the first resin contains functional nanoparticles (e.g., BaTiO₃, barium ferrite), these particles can cause scattering of light, decreasing UV transmission through the formed polymer when trying to expose the second functional resin. In such cases, adjusting the focal plane position may improve polymerization during subsequent exposures. Alternatively, the light intensity or the grayscale pattern can be adjusted to improve the light transmission through the first material for the second exposure.

### Dynamically Changing Exposure Pattern

In some embodiments, a pattern inputted into the spatial light modulator is designed wherein the pattern is dynamically changing over time. The input file is an animation or a movie file wherein the output projected UV light pattern is also continuously changing over the duration of the fixed exposure time.

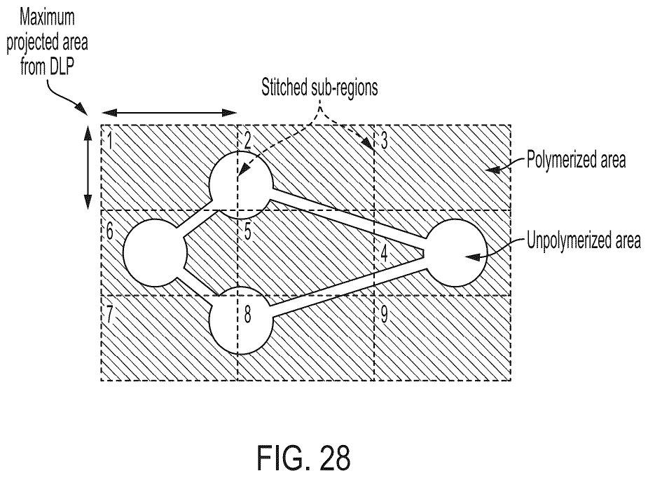

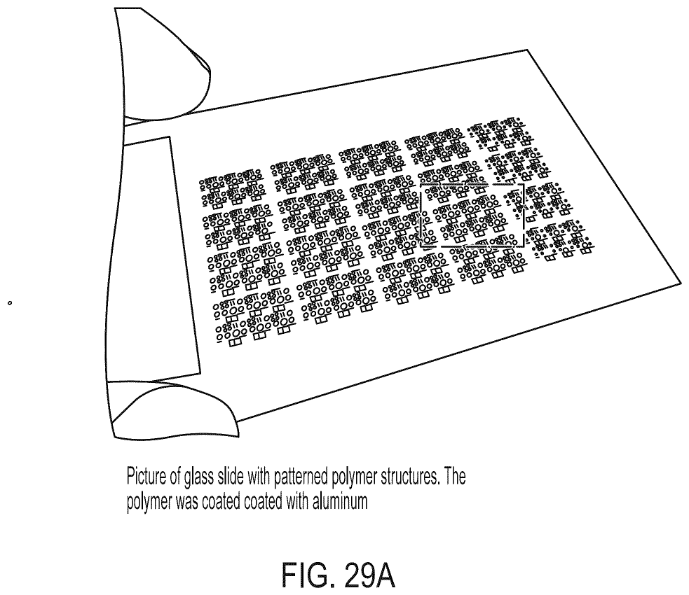

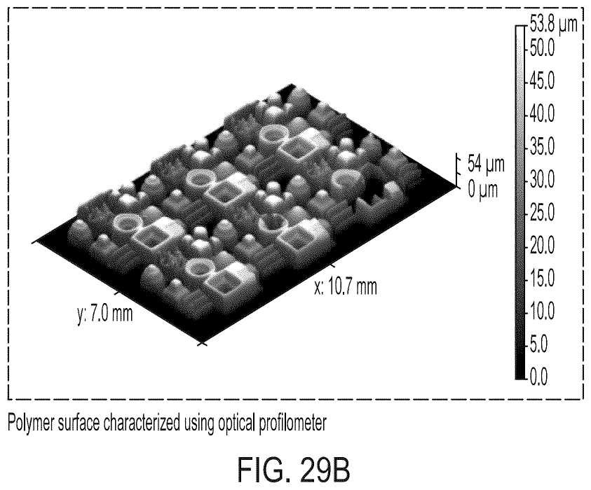

In one embodiment, a polymer structures with a curved profile shown in FIG. 22 is fabricated with a dynamically changing exposure pattern. The curved profile would be difficult to estimate using multiple exposures, even with grayscale. The pattern file is an animation which is continuously changing during a period of the fixed UV exposure time. FIG. 23 shows an image of a frame of a .GIF file of the animated pattern used to fabricate the structure of FIG. 22. The .GIF animation sequentially changes the pattern over time, as shown in FIG. 24. To attain a curved height for the polymer, the central region is provided with a longer UV exposure dose while the outer regions are provided with a shorter exposure dose. This is attained by gradually decreasing the diameter of the circle, as shown in FIG. 24.

In some embodiments, a frame rate (e.g., changes in the pattern) is variable over the entire animation. When preparing the dynamic pattern with variable frame rates, the cure thickness model given by Equation 1 is taken into consideration, with fixed exposure time, duration, and resin formulation.

In one embodiment, the following method is used to prepare the dynamically changing pattern file. First, a 3D topographic textured microstructures is designed using a 3D CAD program such as SolidWorks and save the geometry as an STL file. Next, the STL model is sliced along the height to generate 2D cross-sectional patterns image. Slicing along the z-axis occurs at discrete thickness intervals, wherein more slices result in a finer estimation of the surface profile of the geometry and lower slice counts result in coarser estimation of the surface. The slice algorithm can create a simple black and white pattern at each slice plane. When using coarser slicing, surface profile information between the slices is lost, therefore algorithms can be used to incorporate the missing slices by grayscale those regions. Then, the slice images are combined and converted into a movie or animation file.

### Multi-Material Heterogenous Fabrication

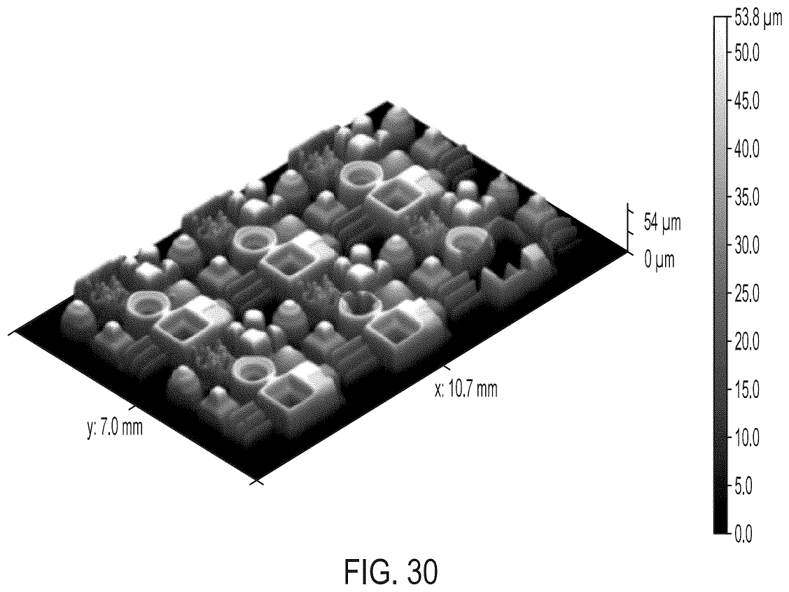

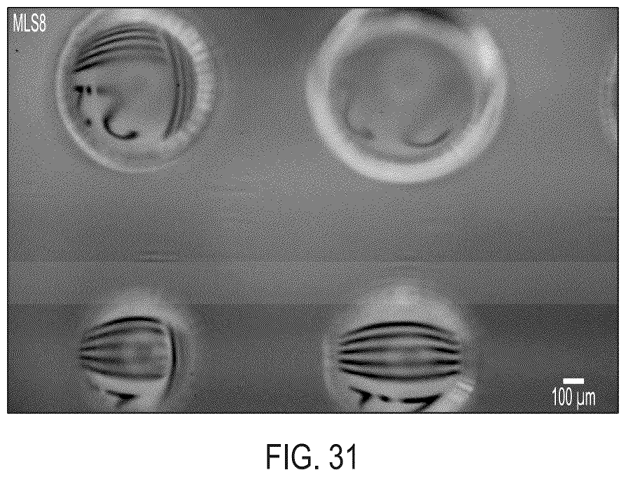

In some embodiments, polymeric devices and topographical surfaces comprising multiple materials are fabricated. In one embodiment, the patterned surface shown, respectively, from a front view and a top-down view in FIGS. 25A-25B, is fabricated with polymeric materials A, B, and C. First, a modular vat is filled with resin C, and exposed to light with the pattern shown in FIG. 26A. Then, an inter-exposure routine performed to switch to resin B. Resin C is drained using an inlet and outlet port and pump. A cleaning solvent (e.g., water, isopropanol) is injected using the inlet and outlet port and pump and a rotator may be used to stir the cleaning solvent. The cleaning solvent is drained using the inlet and outlet port and pump and a vacuum may be used to lower the pressure and evaporated solvent. Next, the modular vat is filled with resin B, and exposed to light with the pattern shown in FIG. 26B. The same inter-exposure routine is performed to drain resin B and replace it with resin A. Then, resin is exposed to light with the pattern shown in FIG. 26C. Resin A is drained, and the transparent substrate is removed, providing a polymerized heterogeneous device shown in FIG. 26D.

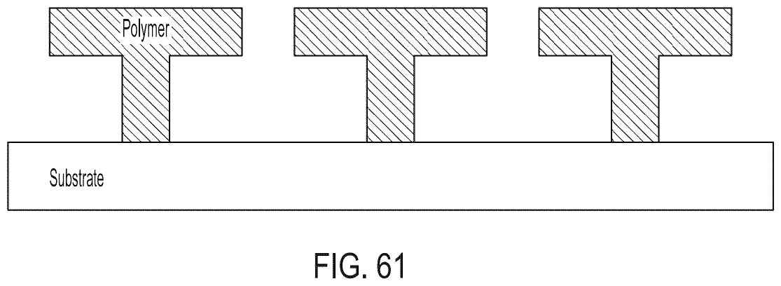

In some embodiments, textured microstructures with overhanging features are fabricated using multiple materials. FIG. 61 illustrates an example array of textured microstructures with overhanging features. Such overhanging textured surfaces are important for a variety of applications including meta materials, friction control, hydrophobic surfaces, antennas, and RF waveguides. It is not fundamentally possible to fabricate overhanging geometries like the one shown in FIG. 61 using the frontal photopolymerization approach described elsewhere herein, such as example approaches for micropatterning using frontal photopolymerization. To create such overhanging features, one would have to rely on 3D printing (e.g., stereolithography). However, using the multi-material fabrication approach described herein, heterogenous materials can be used to form overhanging geometries.

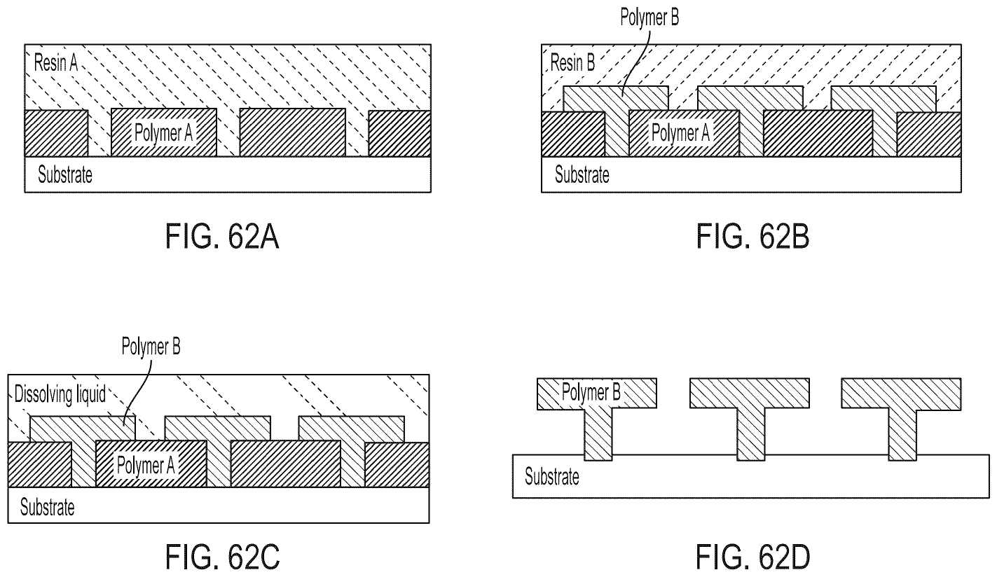

FIGS. 62A-62D illustrates an embodiment for photopolymerization that leverages a multi-material frontal photopolymerization approach to fabricate overhanging textured surfaces, such as that illustrated in FIG. 61. The overview of the steps area follows:

In FIG. 62A, a volume of a first liquid resin is disposed on a substrate and photopolymerization is used to polymerize portions of a first monomer to form one or more first microstructures of a first polymer on the substrate. First Resin A is polymerized using a patterned light, e.g., UV Pattern A (not shown) to create Polymer A. In some embodiments, using inter-exposure routines, Resin A is cleaned and rinsed away.

In FIG. 62B, a volume of a second liquid resin (e.g., Resin B) introduced into the system (e.g., disposed on the substrate or on/about Polymer A) and photopolymerization is used to polymerize portions of a second monomer to form one or more second microstructures of a second polymer on the substrate. Polymer B may be formed using exposure of Resin B to a patterned light, e.g., UV Pattern B. In some embodiments, Polymer A may be translucent enough to allow light, e.g., UV light, to penetrate through it to allow polymerization of Resin B at the interface of the Polymer A. After these exposures, the resulting surface is a heterogenous polymer (A+B). The properties of the Polymer A may be such that Polymer A photopolymerized structures on or about the substrate can be selectively dissolved or etched away using a dissolving solvent liquid. This liquid does not dissolve, or does not substantially dissolve, Polymer B.

In FIG. 62C, a dissolving liquid is disposed on the substrate and caused to dissolve the one or more first microstructures of the first polymer (e.g., Polymer A) on the substrate. Polymer A can be formed from a liquid resin material comprising, for example, one or more of: N, N-dimethylacrylamide, methacrylic acid, methacrylic anhydride, water-soluble filler polyvinylpyrrolidone, photoinitiator IRGACURE® 819, other suitable materials, and/or combinations thereof. The photopolymerized polymer can be dissolved using NaOH aqueous solution, or another suitable solvent as suitable based on the composition of Polymer A.

In FIG. 62D, the one or more second microstructures of the second polymer remain on the substate, forming a surface having overhanging textured microstructures of the second polymer formed thereon. Once Polymer A is fully or substantially dissolved away, the remaining Polymer B is an overhanging geometry.

In some embodiments, an alternative method for fabricating a polymeric device or a polymeric surface with arbitrary geometries and topographical textures can include disposing a volume of a liquid resin comprising photocurable monomers to a first surface of a transparent substrate, projecting a patterned light onto a second surface of the transparent substrate, the second surface being opposite the first surface, wherein the transparent substrate is dimensioned and configured such that the patterned light travels through the transparent substrate from the second side to the first side, varying the patterned light in order to focus a projection focal plane of the patterned light on an interface between the first surface of the transparent substrate and the liquid resin disposed thereon in order to initiate polymerization of at least a portion of the photocurable monomers at said interface, and modulating an effective exposure energy dose of the patterned light within one or more portions of the volume of the liquid resin, wherein the exposure energy dose is a product of light exposure time and exposure intensity for respective of the one or more portions of the liquid resin.

In some embodiments, a method for fabricating a multi-material polymeric device or a multi-material polymeric surface can include disposing a volume of a first photocurable monomer onto a surface of a substrate, projecting a patterned light into one or more portions of the volume of the first photocurable monomer, modulating an effective exposure energy dose of the patterned light within the one or more portions of the first photocurable monomer to cause the one or more portions of the volume of the first photocurable monomer to form one or more first photocured structures, wherein the exposure energy dose is a product of light exposure time and exposure intensity for respective of the one or more portions of the first photocurable monomer, removing a remaining portion of the first photocurable monomer from the substrate, disposing a volume of a second photocurable monomer onto the surface of the substrate and/or onto at least a portion of the one or more photocured structures, projecting the patterned light into one or more portions of the volume of the second photocurable monomer, and modulating the effective exposure energy dose of the patterned light within the one or more portions of the second photocurable monomer to cause the one or more portions of the volume of the second photocurable monomer to form one or more second photocured structures.

### Projection Stitching

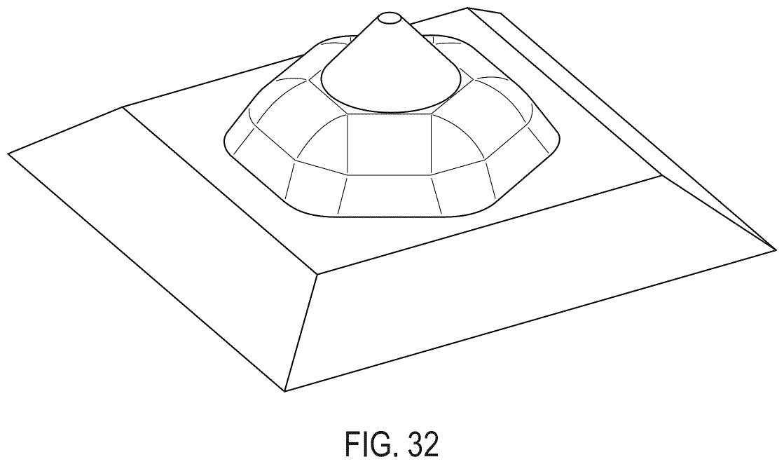

In some embodiments, a DLP projector is used to project the patterned light. The projection area or field of view (FOV) is determined by the projection optics of the projector. There is an inherent tradeoff between the FOV and the minimum patternable feature size, as shown in FIGS. 27A-27D. A larger FOV will result in poorer resolution but a larger patternable feature size, as shown in FIG. 27A, relative to a corresponding pattern illustrated in FIG. 27B. Whereas, a smaller FOV will allow higher resolution features but a smaller patternable feature size, as shown in FIG. 27C, relative to a corresponding pattern illustrated in FIG. 27D.

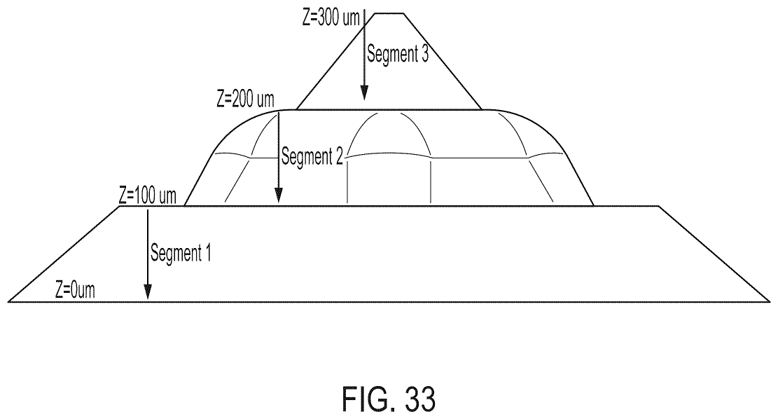

To achieve both a large area and high-resolution features, “projection stitching” can be used wherein small FOV areas are sequentially exposed. FIG. 28 shows a pattern divided into 9 sub-regions, wherein each sub-region comprises the maximum projected area from the DLP projector. The DLP projector is attached to a linear stage and moved to a new location to sequentially exposed each sub-region to the provided pattern of light.

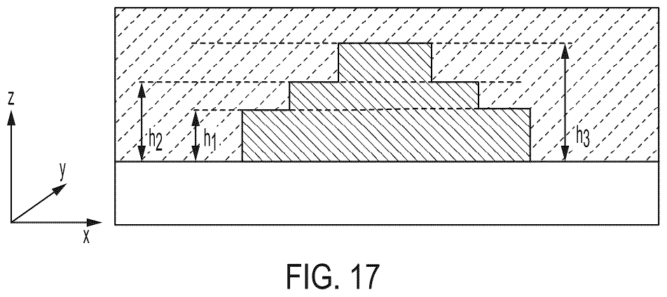

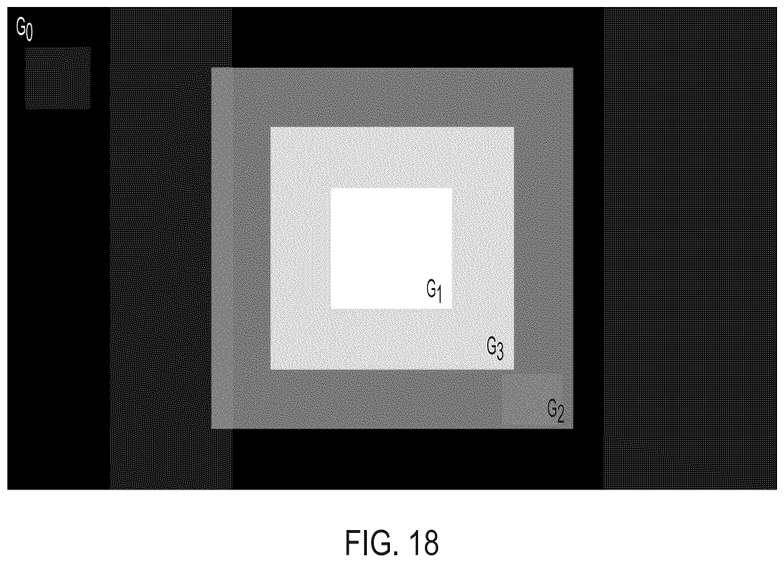

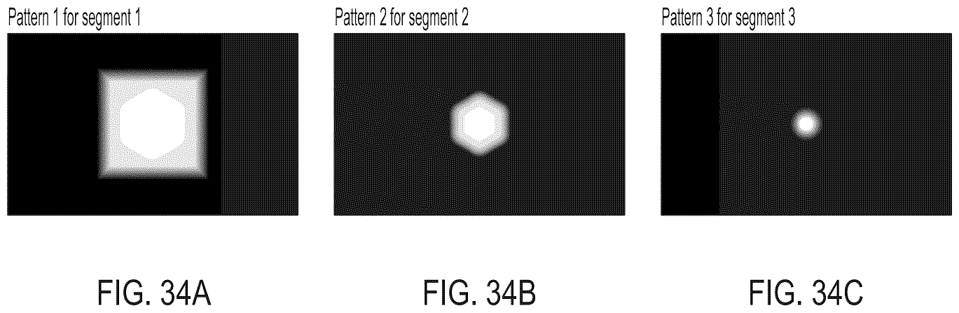

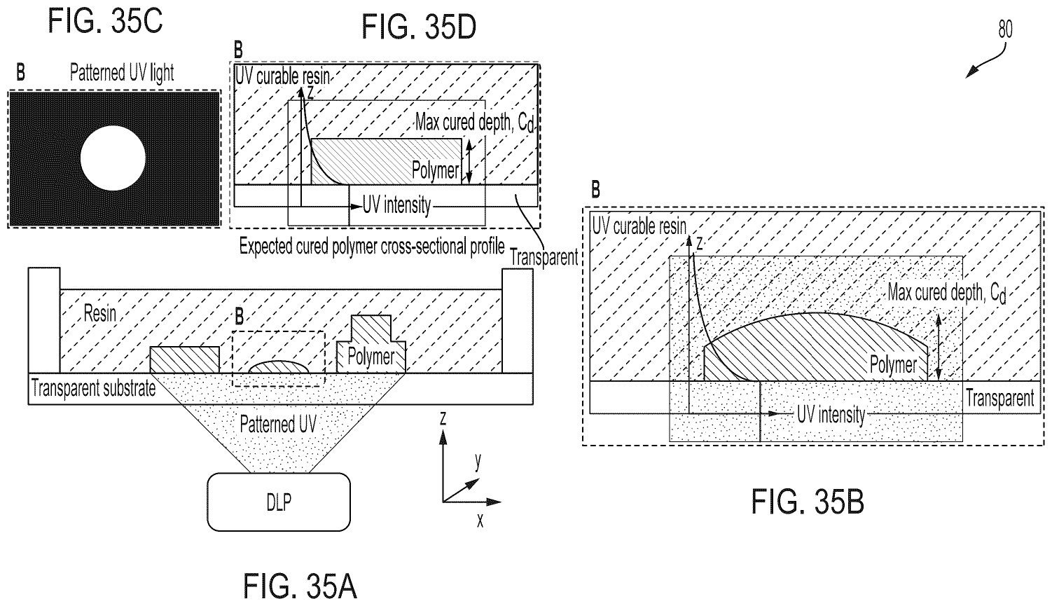

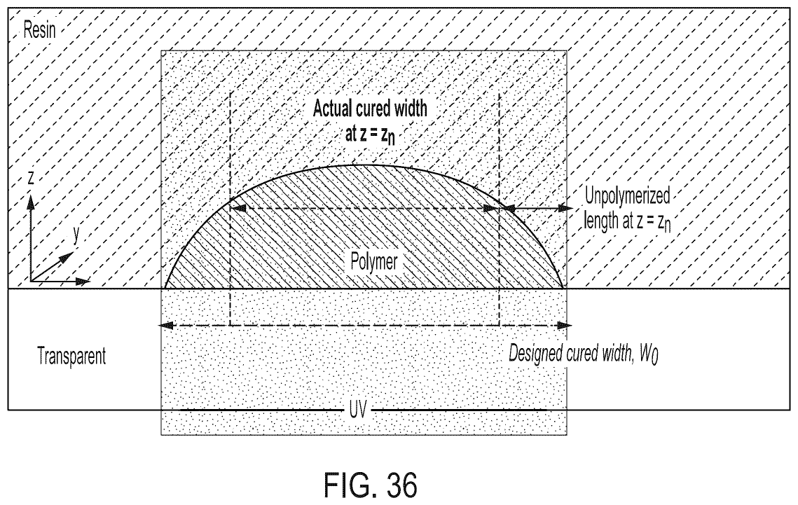

In one embodiment, a polymeric structure shown in FIGS. 29A-29B was fabricated using projection stitching wherein the resin was polymerized in multiple regions. Resin was exposed to the pattern shown in FIG. 13A, and after each exposure, the DLP projector was automatically moved to a new location and the same pattern was exposed again. As shown in FIG. 30, the polymeric structure can include a topographical textured micropattern formed on a substrate having, e.g., z-directional/height dimensions of less than or equal to about 55 μm, less than or equal to about 50 μm, less than or equal to about 45 μm, less than or equal to about 40 μm, less than or equal to about 35 μm, less than or equal to about 30 μm, less than or equal to about 25 μm, less than or equal to about 20 μm, less than or equal to about 15 μm, less than or equal to about 10 μm, less than or equal to about 5 μm, or any combination thereof, inclusive of all value and ranges therebetween. As shown in FIG. 31, the polymeric structure can include a multi-focal microlens array having a maximum dimension in the x-y plane of between about 100 μm and about 1,000 μm, or any value or range therewithin.

### Substrate Modifications

In some embodiments, light is patterned through the design of the substrate to control the photopolymerization.

In one embodiment, the substrate is a patterned photomask (e.g., such as photomasks typically used for lithography). Photomask preparation is well known in the art and a patterned photomask may be prepared by any such methods. Using the methods described herein, the resin undergoes photopolymerization on a surface of the photomask, wherein polymerization occurs at the transparent portions of the photomask. After the polymerization is completed, the photomask may be removed from the polymer (e.g., by peeling off). When using a photomask as the substrate, the light source may be a non-patterned collimated light or a spatial light modulator (e.g., a DLP projector emitting patterned or non-patterned light).

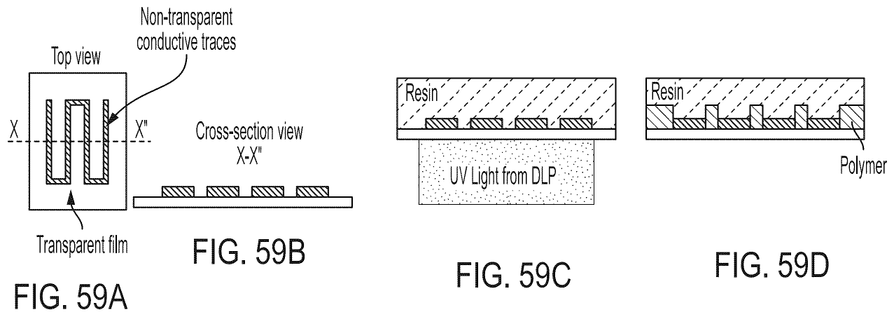

In another embodiment, the substrate is a device (e.g., an electronic device comprising conductive silver ink on top of a transparent flexible polymer sheet such as TPU or COC). In some embodiments, this device can be used as a substrate, on top of which one or more resins can be photopolymerized according to any of the methods described herein. FIGS. 59A-59D illustrate an example of a functional device as a substrate used for forming a topographical texture on a top surface thereof. FIG. 59A illustrates a top-view of a transparent film with one or more non-transparent conductive traces formed thereon. FIG. 59B illustrates a cross-sectional view of the transparent film illustrated in FIG. 59A. FIG. 59C illustrates a resin volume on a transparent substrate with a topographical texture formed thereon via UV light exposure from a DLP. FIG. 59D illustrates a resin volume on a transparent substrate with a topographical texture formed thereon between polymer structures via UV light exposure from a DLP.

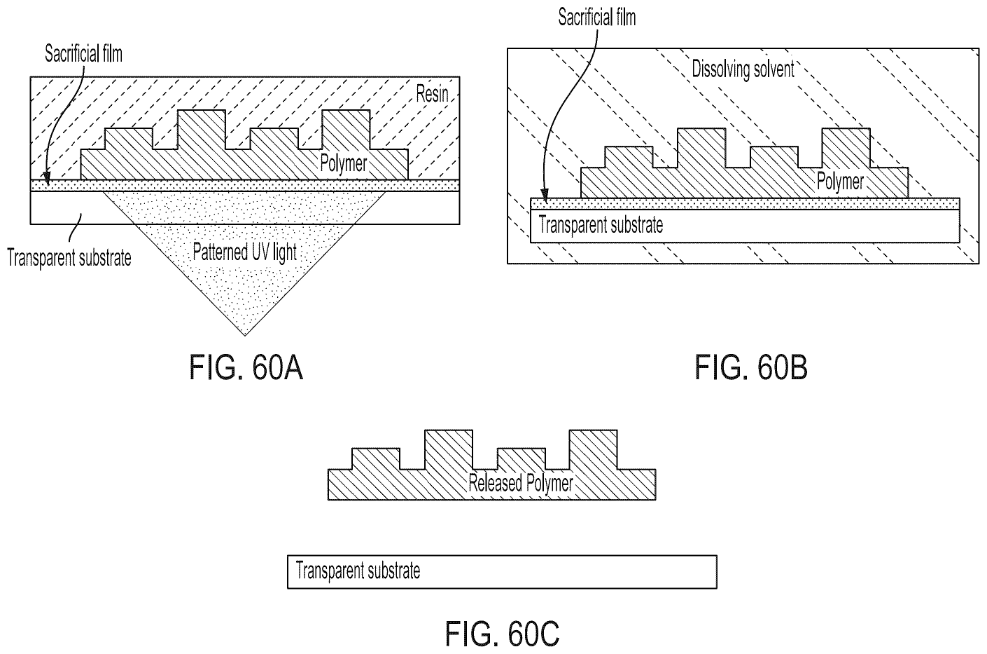

In some embodiments, a sacrificial film on the transparent substrate is used to help release the textured polymer. A thin layer of a transparent or semi-transparent sacrificial material may be applied to the transparent substrate (e.g., by spin coating). In one embodiment the sacrificial film is a positive photoresist. In some embodiments the sacrificial film comprises polyvinyl alcohol (PVA) and/or polyethylene glycol (PEG). In some embodiments the sacrificial film comprises 10 nm to 50 nm in thickness. FIGS. 60A-60C illustrate a process for photopolymerization using a sacrificial film on a substrate to help release the textured polymer. The polymerization of the resin will occur at the interface of the sacrificial material instead of the surface of the transparent substrate (FIG. 60A). Once the fabrication is completed, the device can be submerged into a dissolving solvent (FIG. 60B) which would selectively dissolve the sacrificial material and allow the textured polymer device to peel or release from the substrate (FIG. 60C). The composition of the dissolving solvent will depend on the solubility of the chosen sacrificial material and may include water, acetone, and/or isopropanol.

### Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be appreciated by a person skilled in the art, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Example Computing Entity

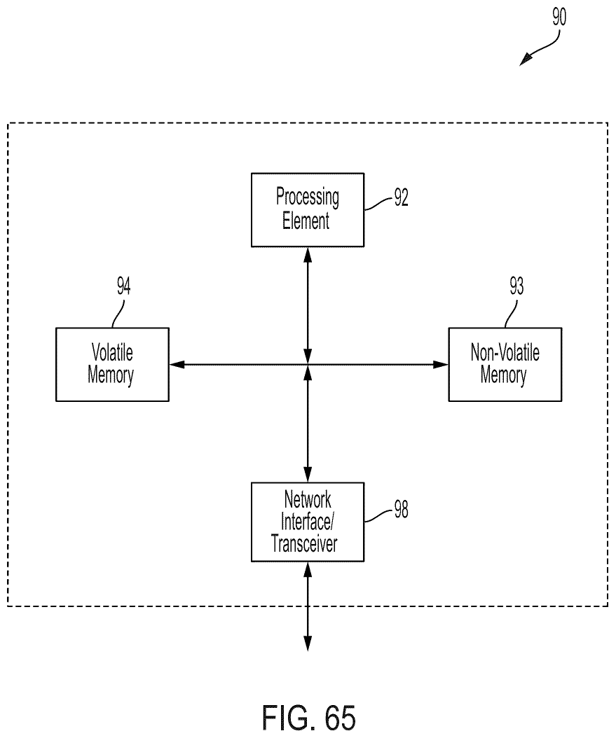

FIG. 65 provides a schematic of the computing device 90 according to one embodiment of the present disclosure. In general, the terms computing device, computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As shown in FIG. 65, in one embodiment, the computing device 90 may include or be in communication with one or more processing elements 92 (also referred to as processors, processing circuitry, and/or similar terms used herein interchangeably) that communicate with other elements within the computing device 90 via a bus, for example. As will be understood, the processing element 92 may be embodied in a number of different ways. For example, the processing element 92 may be embodied as one or more complex programmable logic devices (CPLDs), microprocessors, multi-core processors, coprocessing entities, application-specific instruction-set processors (ASIPs), microcontrollers, and/or controllers. Further, the processing element 92 may be embodied as one or more other processing devices or circuitry. The term circuitry may refer to an entirely hardware embodiment or a combination of hardware and computer program products. Thus, the processing element 92 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 92 may be configured for a particular use or configured to execute instructions stored in volatile or non-volatile media or otherwise accessible to the processing element 92. As such, whether configured by hardware or computer program products, or by a combination thereof, the processing element 92 may be capable of performing steps or operations according to embodiments of the present disclosure when configured accordingly.

In some embodiments, the computing device 90 may further include or be in communication with non-volatile media (also referred to as non-volatile storage, memory, memory storage, memory circuitry, and/or similar terms used herein interchangeably). In one embodiment, the non-volatile storage or memory may include the one or more non-volatile memories 93, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the computing device 90 may further include or be in communication with volatile media (also referred to as volatile storage, memory, memory storage, memory circuitry, and/or similar terms used herein interchangeably). In one embodiment, the volatile storage or memory may also include one or more volatile memories 94, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 92. Thus, the databases, database instances, database management systems, data, applications, programs, program modules, scripts, source code, object code, byte code, compiled code, interpreted code, machine code, executable instructions, and/or the like may be used to control certain aspects of the operation of the computing device 90 with the assistance of the processing element 92 and operating system.

In some embodiments, the computing device 90 may also include one or more network interfaces, such as a transceiver 98 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing device 90 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing device 90 may include or be in communication with one or more input elements, such as a keyboard input, a mouse input, a touch screen/display input, motion input, movement input, audio input, pointing device input, joystick input, keypad input, and/or the like. The computing device 90 may also include or be in communication with one or more output elements (not shown), such as audio output, video output, screen/display output, motion output, movement output, and/or the like.

### Example External Computing Entity

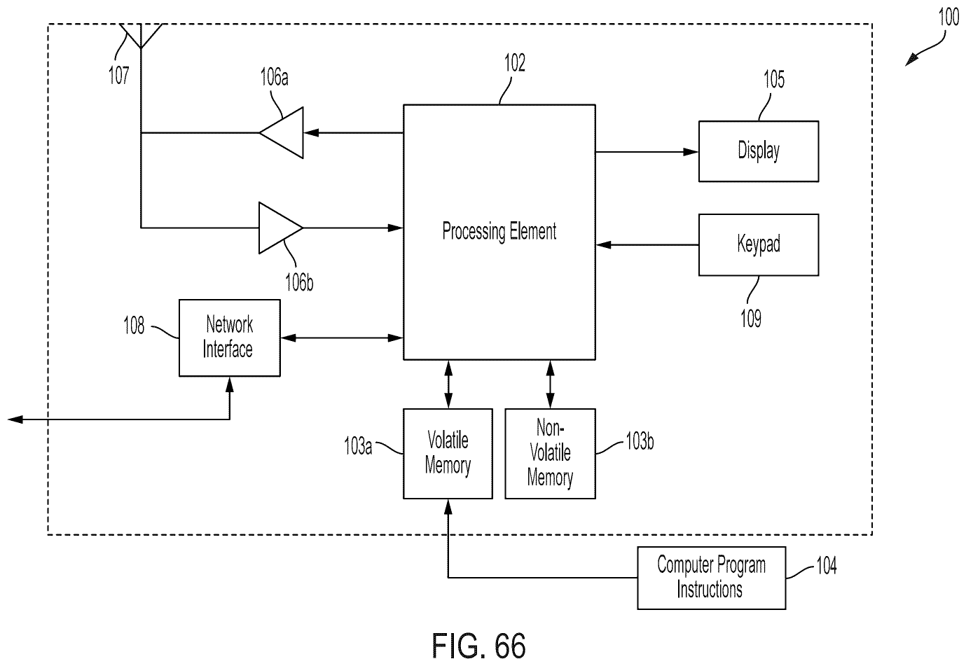

FIG. 66 provides an illustrative schematic representative of an external computing device 100 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The external computing device 100 can be operated by various parties. As shown in FIG. 66, the external computing device 100 can include an antenna 107, a transmitter 106a (e.g., radio), a receiver 106b (e.g., radio), and a processing element 102 (e.g., CPLDs, microprocessors, multi-core processors, coprocessing entities, ASIPs, microcontrollers, and/or controllers) that provides signals to and receives signals from the transmitter 106a and receiver 106b, correspondingly.

The signals provided to and received from the transmitter 106a and the receiver 106b, correspondingly, may include signaling information/data in accordance with air interface standards of applicable wireless systems. In this regard, the external computing device 100 may be capable of operating with one or more air interface standards, communication protocols, modulation types, and access types. More particularly, the external computing device 100 may operate in accordance with any of a number of wireless communication standards and protocols, such as those described above with regard to the computing device 90. In a particular embodiment, the external computing device 100 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing device 100 may operate in accordance with multiple wired communication standards and protocols, such as those described above with regard to the computing device 90 via a network interface 108.

Via these communication standards and protocols, the external computing device 100 can communicate with various other entities using concepts, such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing device 100 can also download changes, add-ons, and updates, for instance, to its firmware, software (e.g., including executable instructions, applications, program modules), and operating system.

According to one embodiment, the external computing device 100 may include location determining aspects, devices, modules, functionalities, and/or similar words used herein interchangeably. For example, the external computing device 100 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the external computing device 100 in connection with a variety of other systems, including cellular towers, Wi-Fi access points, and/or the like. Similarly, the external computing device 100 may include indoor positioning aspects, such as a location module adapted to acquire, for example, latitude, longitude, altitude, geocode, course, direction, heading, speed, time, date, and/or various other information/data. Some of the indoor systems may use various position or location technologies, including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing device 100 may also comprise a user interface (that can include a display 105 coupled to the processing element 102) and/or a user input interface (coupled to the processing element 102). For example, the user interface may be a user application, browser, user interface, and/or similar words used herein interchangeably executing on and/or accessible via the external computing device 100 to interact with and/or cause display of information/data from the computing device 90, as described herein. The user input interface can comprise any of a number of devices or interfaces allowing the external computing device 100 to receive data, such as a keypad 109 (hard or soft), a touch display, voice/speech or motion interfaces, or other input device. In embodiments including a keypad 109, the keypad 109 can include (or cause display of) the conventional numeric (0-9) and related keys (#, *), and other keys used for operating the external computing device 100 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing device 100 can also include volatile storage or memory 103a and/or non-volatile storage or memory 103b, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory (103a, 103b) can store databases, database instances, database management systems, data, applications, programs, program modules, scripts, source code, object code, byte code, compiled code, interpreted code, machine code, executable instructions, and/or the like to implement the functions of the external computing device 100. As indicated, this may include a user application that is resident on the entity or accessible through a browser or other user interface for communicating with the computing device 90 and/or various other computing entities.

In another embodiment, the external computing device 100 may include one or more components or functionalities that are the same or similar to those of the computing device 90, as described in greater detail above. As will be recognized, these architectures and descriptions are provided for exemplary or illustrative purposes only and are not meant to limit the scope of this disclosure to one, some, or all of the various embodiments described herein.

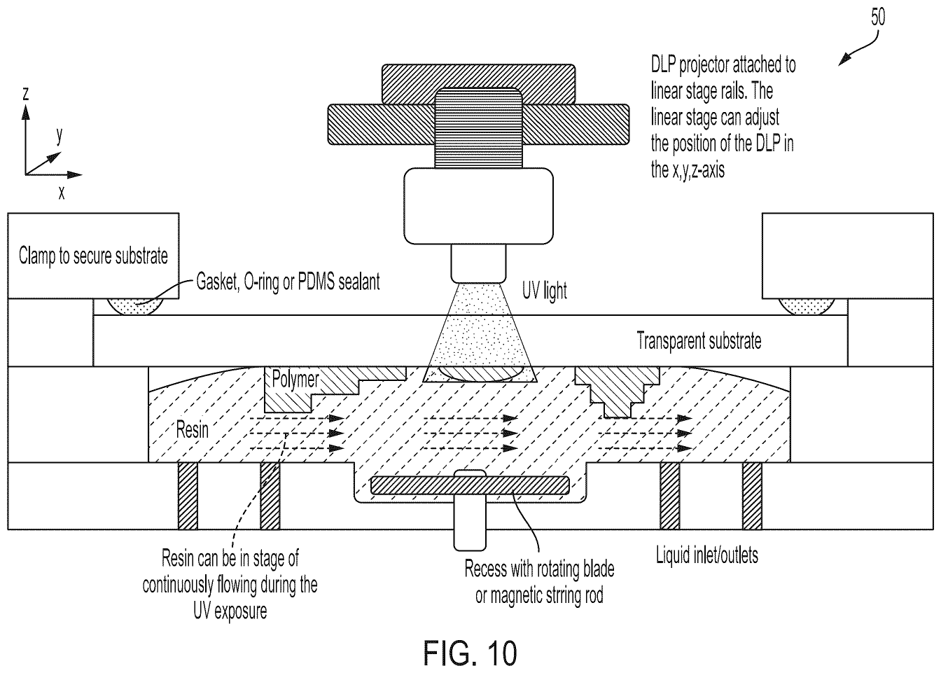

In some embodiments, the printing apparatus/device, such as shown, e.g., in FIGS. 7, 17A-17C, 18, 19, 20, 22A, 24A-24B, etc., can comprise and/or be in communication with the computing device 90, the computing device 90 being suitable to carry out movement of the various components of the printing apparatus/device, flow rates or deposition/dispersal volumes, or the like. In some embodiments, the printing apparatus/device or a component thereof, e.g., the computing device 90, can be configured to be in communication with the external computing device 100, which can be configured to provide instructions for printing, a design file for a printed article, printing nozzle and/or non-solvent vapor dispersion apparatus path instructions, or the like to the computing device 90, which is configured to carry out printing.

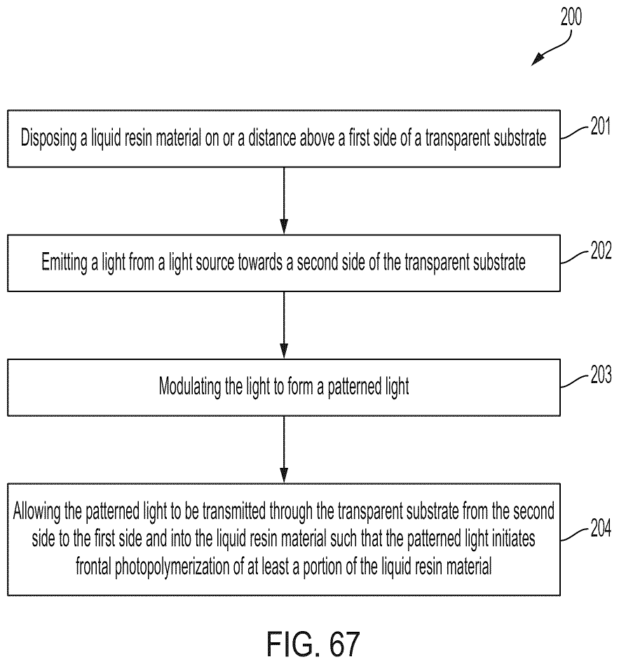

FIGS. 67-78 illustrate various stereolithographic methods, such as described elsewhere herein. The methods described herein can be carried out by means, such as the computing device 90 and/or the external computing device 100.

Referring now to FIG. 67, a method 200 is illustrated that comprises disposing a liquid resin material on or a distance above a first side of a transparent substrate, at 201. The method 200 can further comprise emitting a light from a light source towards a second side of the transparent substrate, at 202. The method 200 can further comprise modulating the light to form a patterned light, at 203. The method 200 can further comprise allowing the patterned light to be transmitted through the transparent substrate from the second side to the first side and into the liquid resin material such that the patterned light initiates frontal photopolymerization of at least a portion of the liquid resin material, at 204. Some or all elements/steps of the method 200 can be carried out by a device/apparatus, such as a 3D printing device. Some or all elements/steps of the method 200 can be carried out programmatically, such as by using a computing device (e.g., 90 and/or 100), which can be separate from or a part of a device/apparatus for 3D printing.

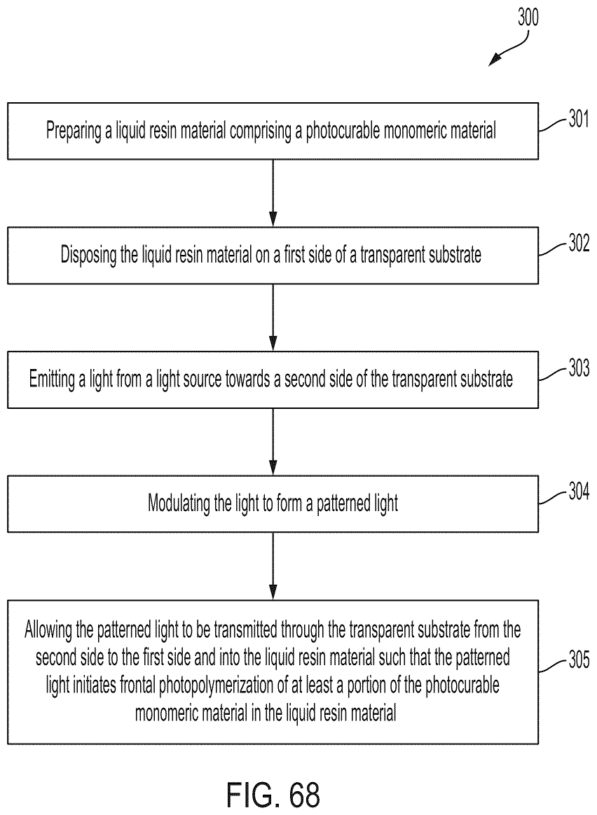

Referring now to FIG. 68, a method 300 is illustrated that comprises preparing a liquid resin material comprising a photocurable monomeric material, at 301. The method 300 can further comprise disposing the liquid resin material on a first side of a transparent substrate, at 302. The method 300 can further comprise emitting a light from a light source towards a second side of the transparent substrate, at 303. The method 300 can further comprise modulating the light to form a patterned light, at 304. The method 300 can further comprise allowing the patterned light to be transmitted through the transparent substrate from the second side to the first side and into the liquid resin material such that the patterned light initiates frontal photopolymerization of at least a portion of the photocurable monomeric material in the liquid resin material, at 305. Some or all elements/steps of the method 300 can be carried out by a device/apparatus, such as a 3D printing device. Some or all elements/steps of the method 300 can be carried out programmatically, such as by using a computing device (e.g., 90 and/or 100), which can be separate from or a part of a device/apparatus for 3D printing.

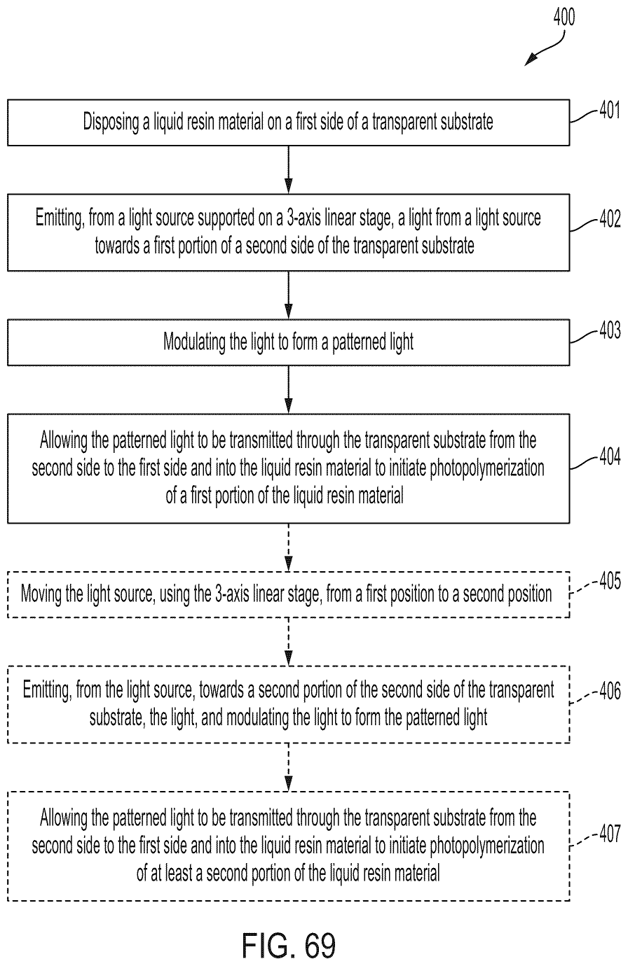

Referring now to FIG. 69, a method 400 is illustrated that comprises disposing a liquid resin material on a first side of a transparent substrate, at 401. The method 400 can further comprise emitting, from a light source supported on a 3-axis linear stage, a light from a light source towards a first portion of a second side of the transparent substrate, at 402. The method 400 can further comprise modulating the light to form a patterned light, at 403. The method 400 can further comprise allowing the patterned light to be transmitted through the transparent substrate from the second side to the first side and into the liquid resin material to initiate photopolymerization of a first portion of the liquid resin material, at 404. The method 400 can, optionally, further comprise moving the light source, using the 3-axis linear stage, from a first position to a second position, at 405. The method 400 can, optionally, further comprise emitting, from the light source, towards a second portion of the second side of the transparent substrate, the light, and modulating the light to form the patterned light, at 406. The method 400 can, optionally, further comprise allowing the patterned light to be transmitted through the transparent substrate from the second side to the first side and into the liquid resin material to initiate photopolymerization of at least a second portion of the liquid resin material, at 407. Some or all elements/steps of the method 400 can be carried out by a device/apparatus, such as a 3D printing device. Some or all elements/steps of the method 400 can be carried out programmatically, such as by using a computing device (e.g., 90 and/or 100), which can be separate from or a part of a device/apparatus for 3D printing.

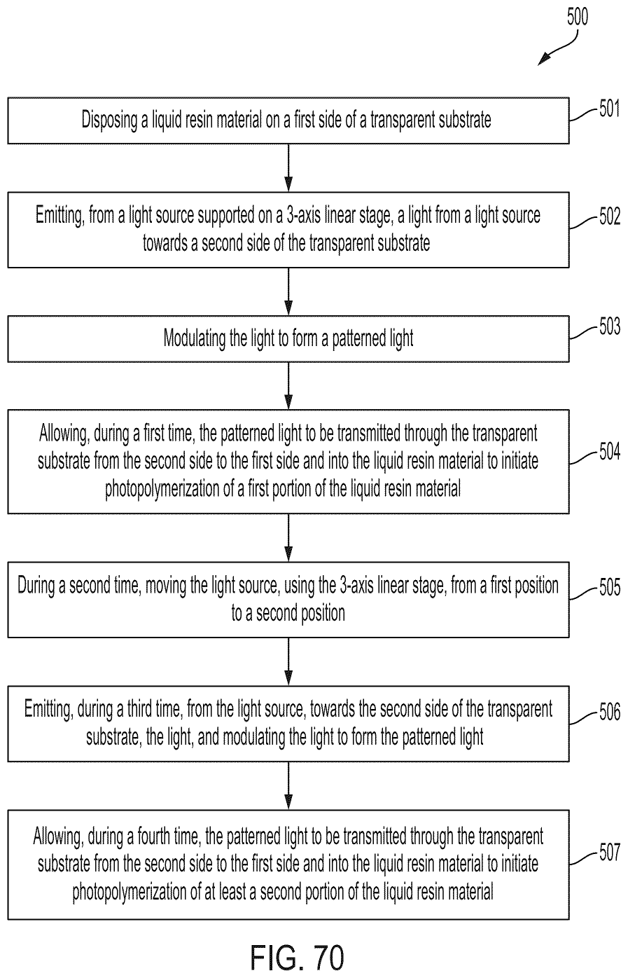

Referring now to FIG. 70, a method 500 is illustrated that comprises disposing a liquid resin material on a first side of a transparent substrate, at 501. The method 500 can further comprise emitting, from a light source supported on a 3-axis linear stage, a light from a light source towards a second side of the transparent substrate, at 502. The method 500 can further comprise modulating the light to form a patterned light, at 503. The method 500 can further comprise allowing, during a first time, the patterned light to be transmitted through the transparent substrate from the second side to the first side and into the liquid resin material to initiate photopolymerization of a first portion of the liquid resin material, at 504. The method 500 can further comprise during a second time, moving the light source, using the 3-axis linear stage, from a first position to a second position, at 505. The method 500 can further comprise emitting, during a third time, from the light source, towards the second side of the transparent substrate, the light, and modulating the light to form the patterned light, at 506. The method 500 can further comprise allowing, during a fourth time, the patterned light to be transmitted through the transparent substrate from the second side to the first side and into the liquid resin material to initiate photopolymerization of at least a second portion of the liquid resin material, at 507. Some or all elements/steps of the method 500 can be carried out by a device/apparatus, such as a 3D printing device. Some or all elements/steps of the method 500 can be carried out programmatically, such as by using a computing device (e.g., 90 and/or 100), which can be separate from or a part of a device/apparatus for 3D printing.

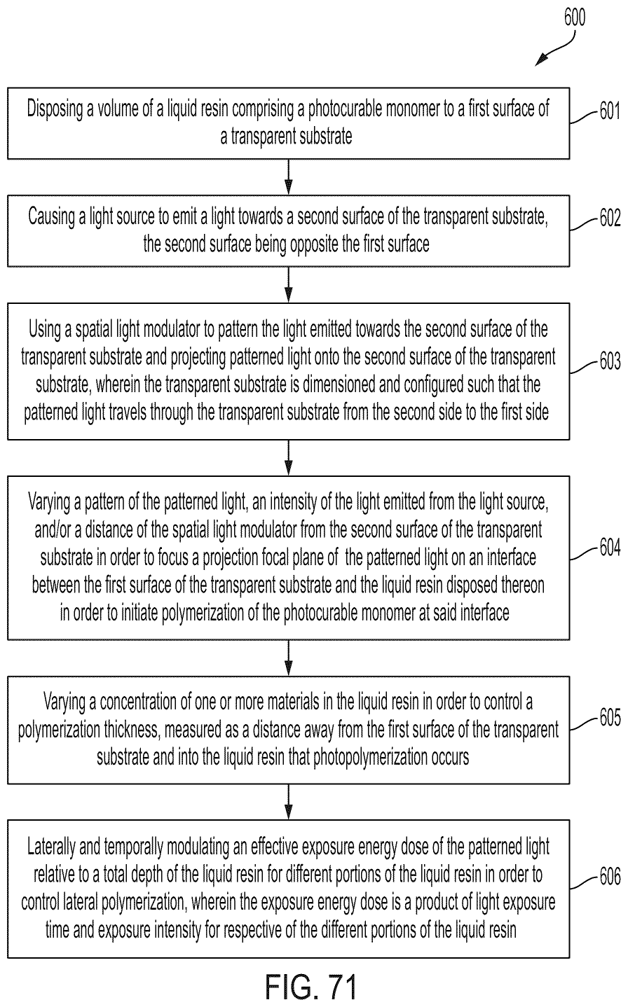

Referring now to FIG. 71, a method 600 is illustrated that comprises disposing a volume of a liquid resin comprising a photocurable monomer to a first surface of a transparent substrate, at 601. The method 600 can further comprise causing a light source to emit a light towards a second surface of the transparent substrate, the second surface being opposite the first surface, at 602. The method 600 can further comprise using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side, at 603. The method 600 can further comprise varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface, at 604. The method 600 can further comprise varying a concentration of one or more materials in the liquid resin in order to control a polymerization thickness, measured as a distance away from the first surface of the transparent substrate and into the liquid resin that photopolymerization occurs, at 605. The method 600 can further comprise laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin, at 606. Some or all elements/steps of the method 600 can be carried out by a device/apparatus, such as a 3D printing device. Some or all elements/steps of the method 600 can be carried out programmatically, such as by using a computing device (e.g., 90 and/or 100), which can be separate from or a part of a device/apparatus for 3D printing.

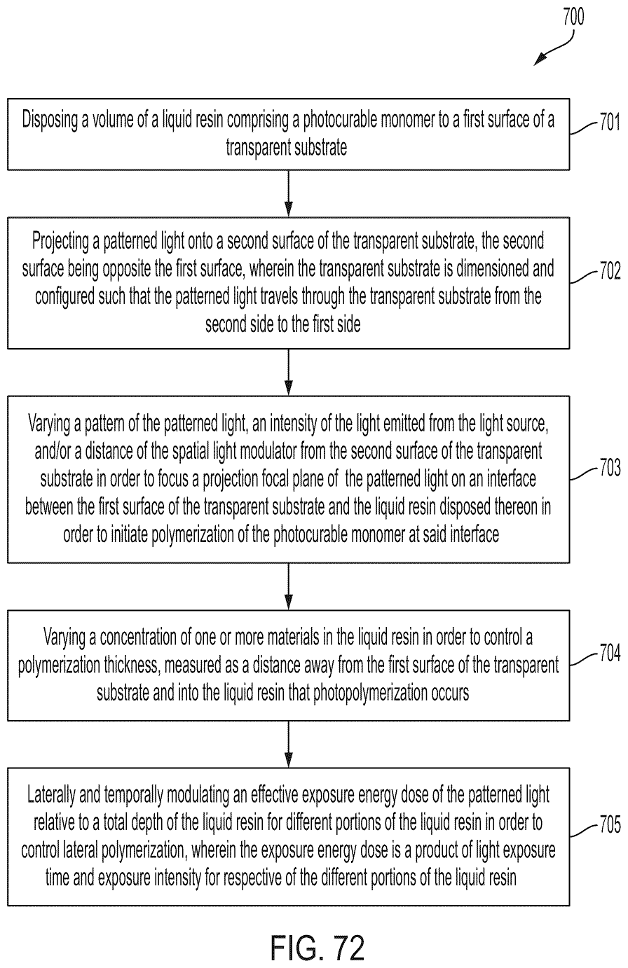

Referring now to FIG. 72, a method 700 is illustrated that comprises disposing a volume of a liquid resin comprising a photocurable monomer to a first surface of a transparent substrate, at 701. The method 700 can further comprise projecting a patterned light onto a second surface of the transparent substrate, the second surface being opposite the first surface, wherein the transparent substrate is dimensioned and configured such that the patterned light travels through the transparent substrate from the second side to the first side, at 702. The method 700 can further comprise varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface, at 703. The method 700 can further comprise varying a concentration of one or more materials in the liquid resin in order to control a polymerization thickness, measured as a distance away from the first surface of the transparent substrate and into the liquid resin that photopolymerization occurs, at 704. The method 700 can further comprise laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin, at 705. Some or all elements/steps of the method 700 can be carried out by a device/apparatus, such as a 3D printing device. Some or all elements/steps of the method 700 can be carried out programmatically, such as by using a computing device (e.g., 90 and/or 100), which can be separate from or a part of a device/apparatus for 3D printing.

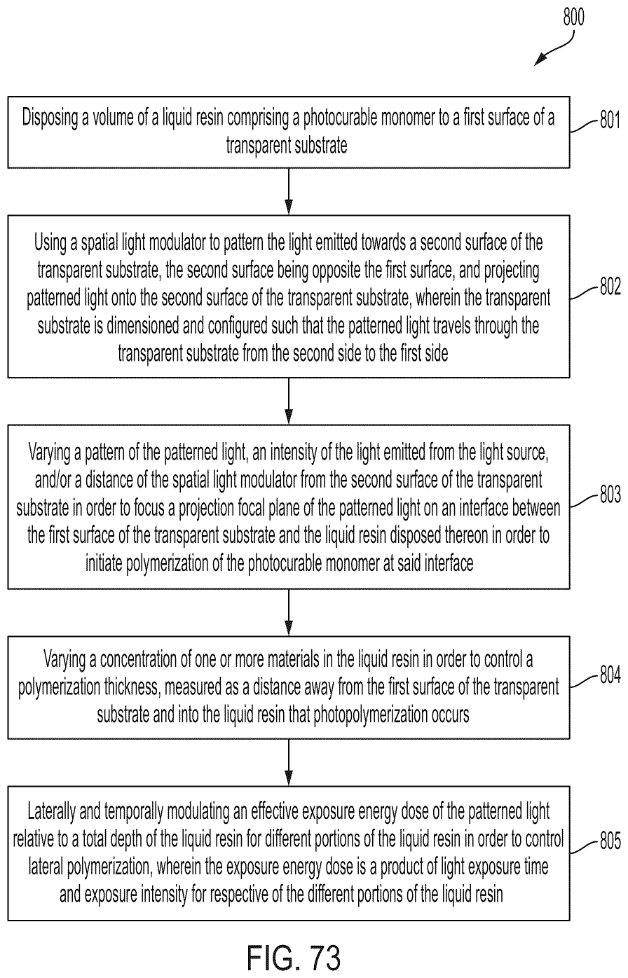

Referring now to FIG. 73, a method 800 is illustrated that comprises disposing a volume of a liquid resin comprising a photocurable monomer to a first surface of a transparent substrate, at 801. The method 800 can further comprise using a spatial light modulator to pattern the light emitted towards a second surface of the transparent substrate, the second surface being opposite the first surface, and projecting patterned light onto the second surface of the transparent substrate, wherein the transparent substrate is dimensioned and configured such that the patterned light travels through the transparent substrate from the second side to the first side, at 802. The method 800 can further comprise varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface, at 803. The method 800 can further comprise varying a concentration of one or more materials in the liquid resin in order to control a polymerization thickness, measured as a distance away from the first surface of the transparent substrate and into the liquid resin that photopolymerization occurs, at 804. The method 800 can further comprise laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin, at 805. Some or all elements/steps of the method 800 can be carried out by a device/apparatus, such as a 3D printing device. Some or all elements/steps of the method 800 can be carried out programmatically, such as by using a computing device (e.g., 90 and/or 100), which can be separate from or a part of a device/apparatus for 3D printing.

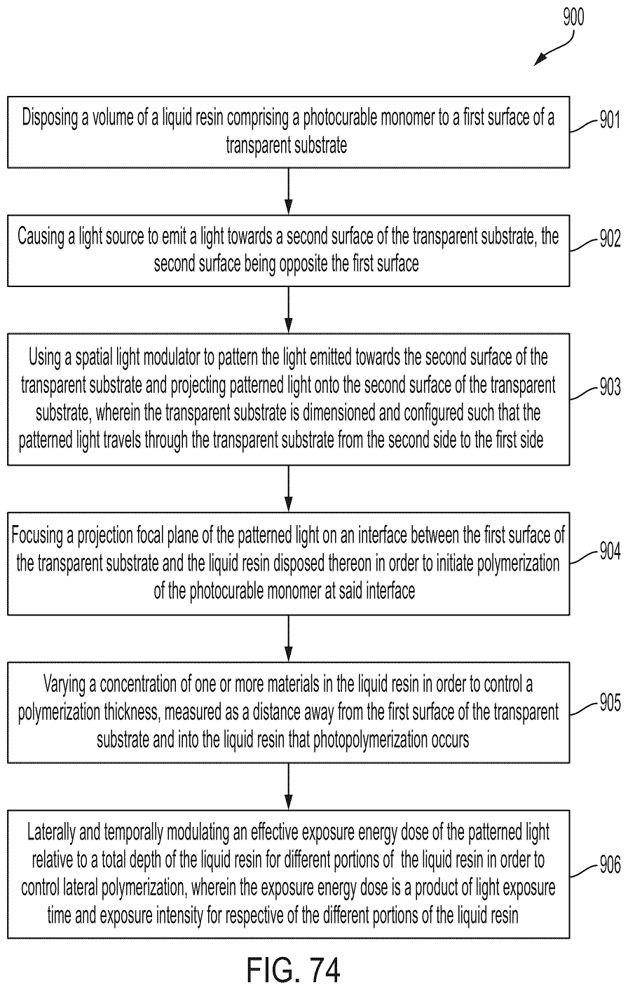

Referring now to FIG. 74, a method 900 is illustrated that comprises disposing a volume of a liquid resin comprising a photocurable monomer to a first surface of a transparent substrate, at 901. The method 900 can further comprise causing a light source to emit a light towards a second surface of the transparent substrate, the second surface being opposite the first surface, at 902. The method 900 can further comprise using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side, at 903. The method 900 can further comprise focusing a projection focal plane of the patterned light on an interface between the first surface of the transparent substrate and the liquid resin disposed thereon in order to initiate polymerization of the photocurable monomer at said interface, at 904. The method 900 can further comprise varying a concentration of one or more materials in the liquid resin in order to control a polymerization thickness, measured as a distance away from the first surface of the transparent substrate and into the liquid resin that photopolymerization occurs, at 905. The method 900 can further comprise laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin, at 906. Some or all elements/steps of the method 900 can be carried out by a device/apparatus, such as a 3D printing device. Some or all elements/steps of the method 900 can be carried out programmatically, such as by using a computing device (e.g., 90 and/or 100), which can be separate from or a part of a device/apparatus for 3D printing.

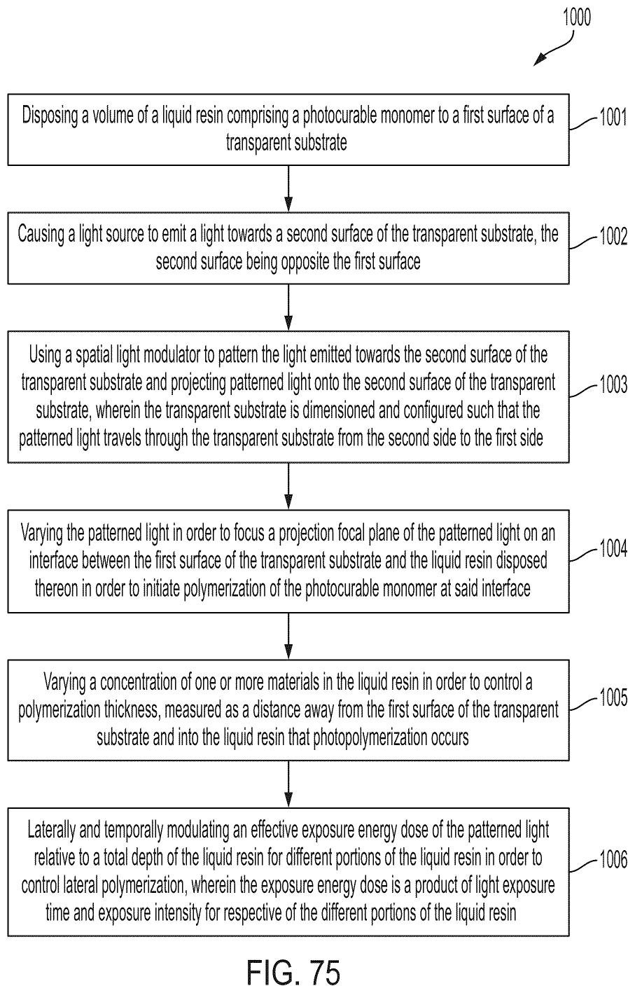

Referring now to FIG. 75, a method 1000 is illustrated that comprises disposing a volume of a liquid resin comprising a photocurable monomer to a first surface of a transparent substrate, at 1001. The method 1000 can further comprise causing a light source to emit a light towards a second surface of the transparent substrate, the second surface being opposite the first surface, at 1002. The method 1000 can further comprise using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side, at 1003. The method 1000 can further comprise varying the patterned light in order to focus a projection focal plane of the patterned light on an interface between the first surface of the transparent substrate and the liquid resin disposed thereon in order to initiate polymerization of the photocurable monomer at said interface, at 1004. The method 1000 can further comprise varying a concentration of one or more materials in the liquid resin in order to control a polymerization thickness, measured as a distance away from the first surface of the transparent substrate and into the liquid resin that photopolymerization occurs, at 1005. The method 1000 can further comprise laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin, at 1006. Some or all elements/steps of the method 1000 can be carried out by a device/apparatus, such as a 3D printing device. Some or all elements/steps of the method 1000 can be carried out programmatically, such as by using a computing device (e.g., 90 and/or 100), which can be separate from or a part of a device/apparatus for 3D printing.

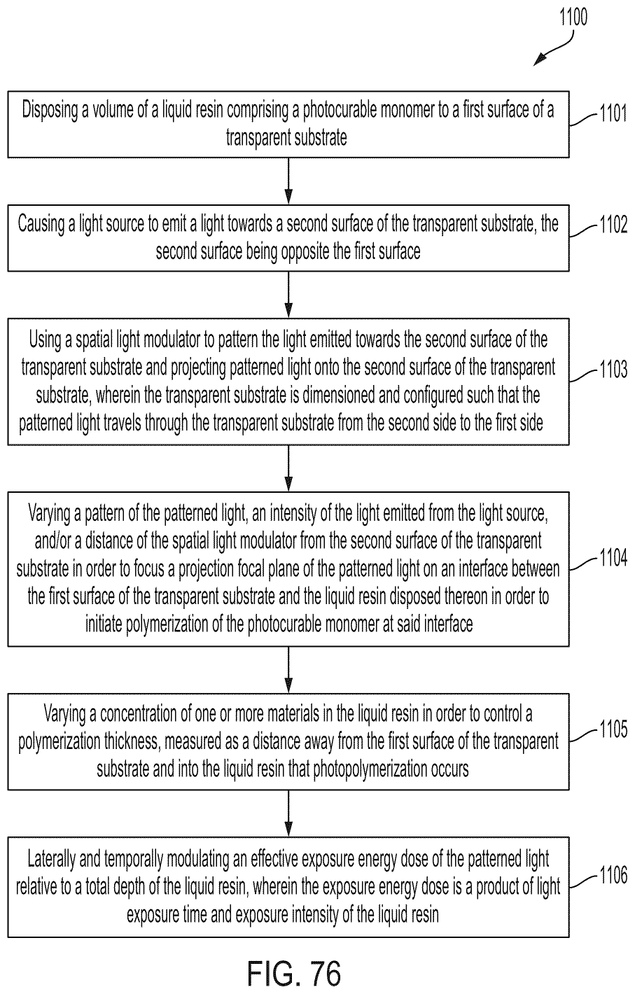

Referring now to FIG. 76, a method 1100 is illustrated that comprises disposing a volume of a liquid resin comprising a photocurable monomer to a first surface of a transparent substrate, at 1101. The method 1100 can further comprise causing a light source to emit a light towards a second surface of the transparent substrate, the second surface being opposite the first surface, at 1102. The method 1100 can further comprise using a spatial light modulator to pattern the light emitted towards the second surface of the transparent substrate and projecting patterned light onto the second surface of the transparent substrate, wherein the transparent substrate is dimensioned and configured such that the patterned light travels through the transparent substrate from the second side to the first side, at 1103. The method 1100 can further comprise varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface, at 1104. The method 1100 can further comprise varying a concentration of one or more materials in the liquid resin in order to control a polymerization thickness, measured as a distance away from the first surface of the transparent substrate and into the liquid resin that photopolymerization occurs, at 1105. The method 1100 can further comprise laterally and temporally modulating an effective exposure energy dose of the patterned light relative to a total depth of the liquid resin, wherein the exposure energy dose is a product of light exposure time and exposure intensity of the liquid resin, at 1106. Some or all elements/steps of the method 1100 can be carried out by a device/apparatus, such as a 3D printing device. Some or all elements/steps of the method 1100 can be carried out programmatically, such as by using a computing device (e.g., 90 and/or 100), which can be separate from or a part of a device/apparatus for 3D printing.

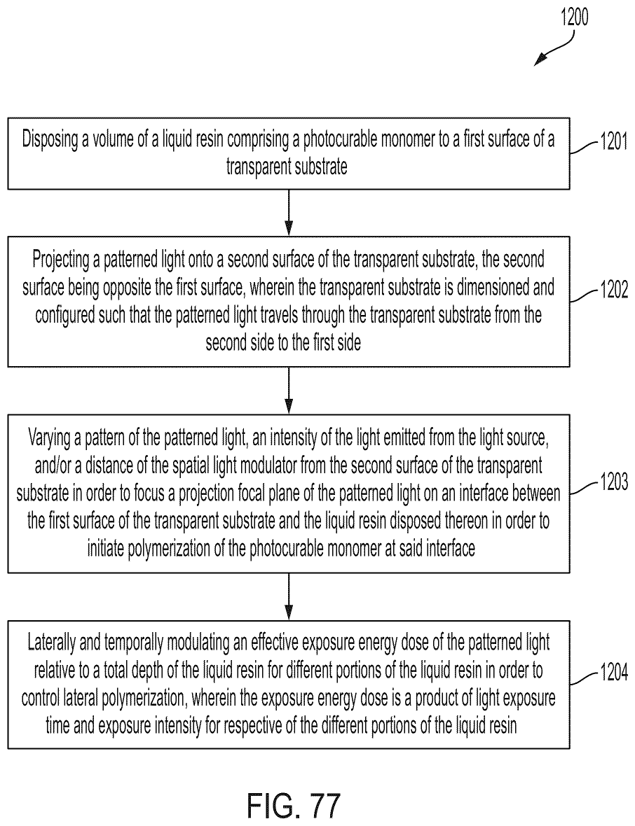

Referring now to FIG. 77, a method 1200 is illustrated that comprises disposing a volume of a liquid resin comprising a photocurable monomer to a first surface of a transparent substrate, at 1201. The method 1200 can further comprise projecting a patterned light onto a second surface of the transparent substrate, the second surface being opposite the first surface, wherein the transparent substrate is dimensioned and configured such that the patterned light travels through the transparent substrate from the second side to the first side, at 1202. The method 1200 can further comprise varying a pattern of the patterned light, an intensity of the light emitted from the light source, and/or a distance of the spatial light modulator from the second surface of the transparent substrate in order to focus a projection focal plane of the patterned light on an interface between the first surface of the transparent substrate and the liquid resin disposed thereon in order to initiate polymerization of the photocurable monomer at said interface, at 1203. The method 1200 can further comprise laterally and temporally modulating an effective exposure energy dose of the patterned light relative to a total depth of the liquid resin for different portions of the liquid resin in order to control lateral polymerization, wherein the exposure energy dose is a product of light exposure time and exposure intensity for respective of the different portions of the liquid resin, at 1204. Some or all elements/steps of the method 1200 can be carried out by a device/apparatus, such as a 3D printing device. Some or all elements/steps of the method 1200 can be carried out programmatically, such as by using a computing device (e.g., 90 and/or 100), which can be separate from or a part of a device/apparatus for 3D printing.

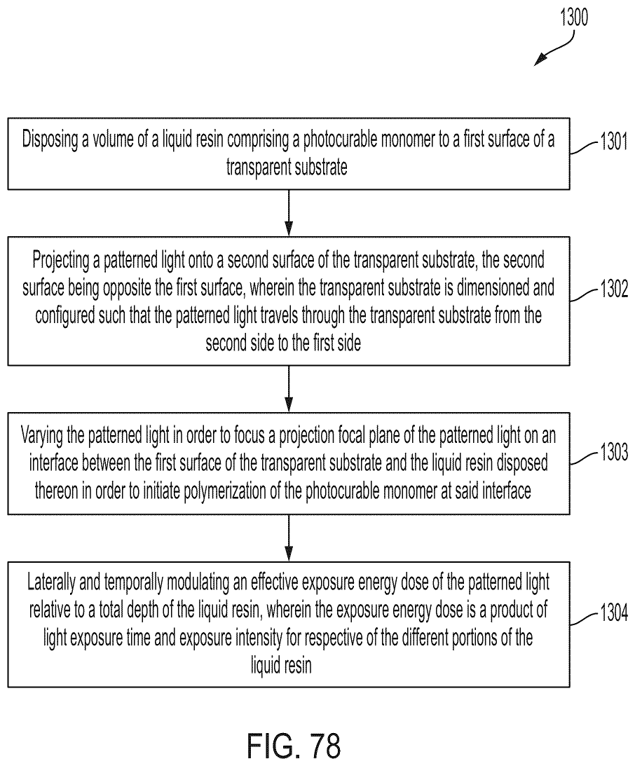

Referring now to FIG. 78, a method 1300 is illustrated that comprises disposing a volume of a liquid resin comprising a photocurable monomer to a first surface of a transparent substrate, at 1301. The method 1300 can further comprise projecting a patterned light onto a second surface of the transparent substrate, the second surface being opposite the first surface, wherein the transparent substrate is dimensioned and configured such that the patterned light travels through the transparent substrate from the second side to the first side, at 1302. The method 1300 can further comprise varying the patterned light in order to focus a projection focal plane of the patterned light on an interface between the first surface of the transparent substrate and the liquid resin disposed thereon in order to initiate polymerization of the photocurable monomer at said interface, at 1303. The method 1300 can further comprise laterally and temporally modulating an effective exposure energy dose of the patterned light relative to a total depth of the liquid resin, wherein the exposure energy dose is a product of light exposure time and exposure intensity for respective of the different portions of the liquid resin, at 1304. Some or all elements/steps of the method 1300 can be carried out by a device/apparatus, such as a 3D printing device. Some or all elements/steps of the method 1300 can be carried out programmatically, such as by using a computing device (e.g., 90 and/or 100), which can be separate from or a part of a device/apparatus for 3D printing.

### EXAMPLES

What follows are several examples of fabrication approaches for fabricating 3D microstructures and/or patterned/textured surfaces. These examples are non-limiting and are provided by way of example only.

### Example 1: Fabrication of 3D Microstructures

In one embodiment, a grayscale pattern is used to fabricate a 3D microstructure with various 3D features including ramps, staircases, checkerboards. FIG. 13A shows the grayscale pattern inputted into a DLP and FIG. 13B shows the projected UV light at the focal plane.

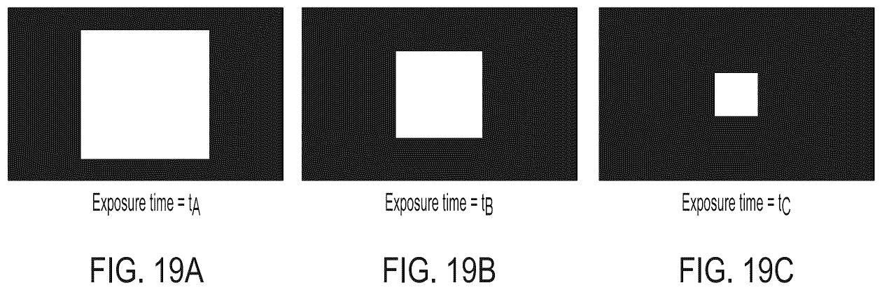

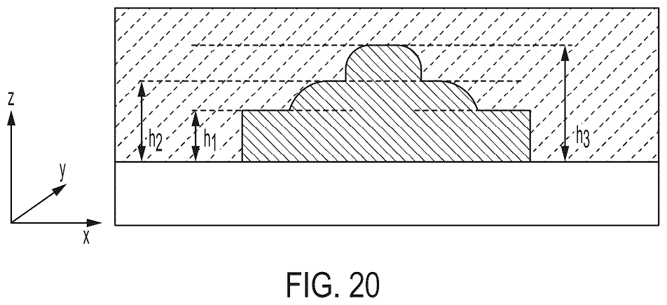

In one embodiment, the inputted grayscale pattern is shown in FIG. 14A. The polymer's lateral dimension (e.g., along the x-axis and y-axis) and height (e.g., z-axis) are controlled by varying the local UV intensity, wherein the local UV intensity is determined from the grayscale of the pattern. FIGS. 14B-14G show cross-sections of features A-F of the cured polymer fabricated by inputting the pattern shown in FIG. 14A.

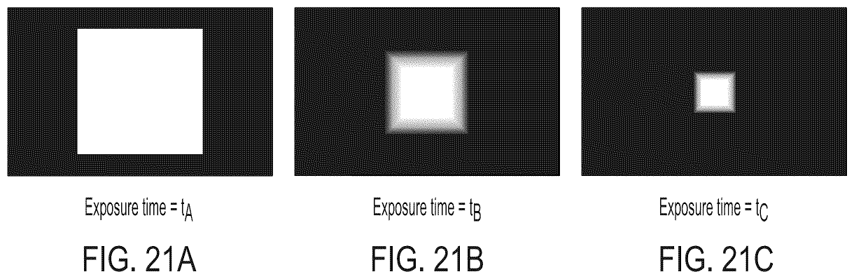

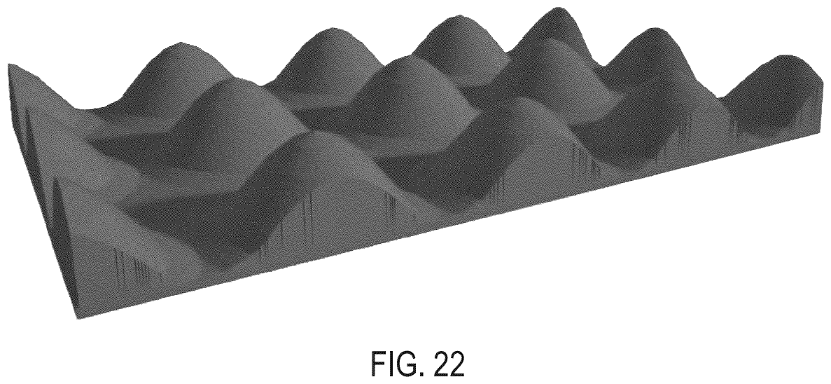

In another embodiment, a polymer device with varying topographical features is fabricated by inputted grayscale pattern is shown in FIG. 15. The topography of the polymer is shown in FIG. 16.

### Example 2: Multiple Exposure Stacking

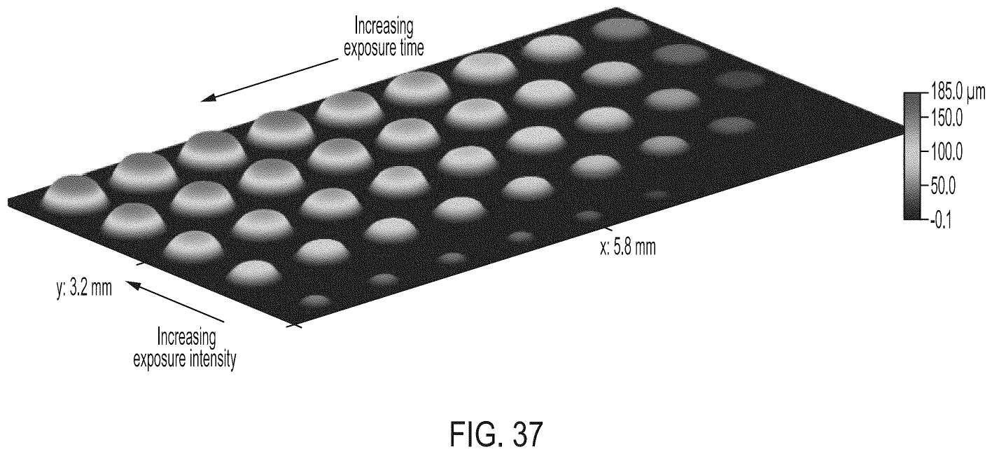

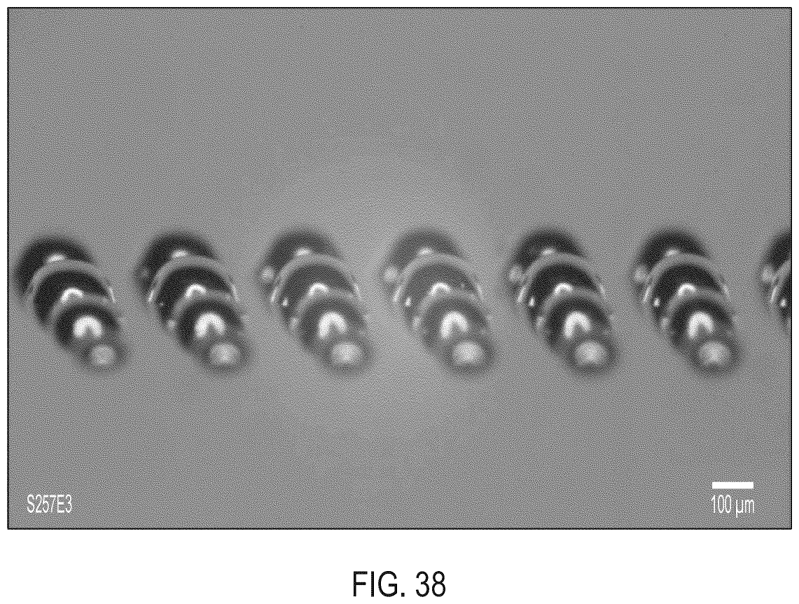

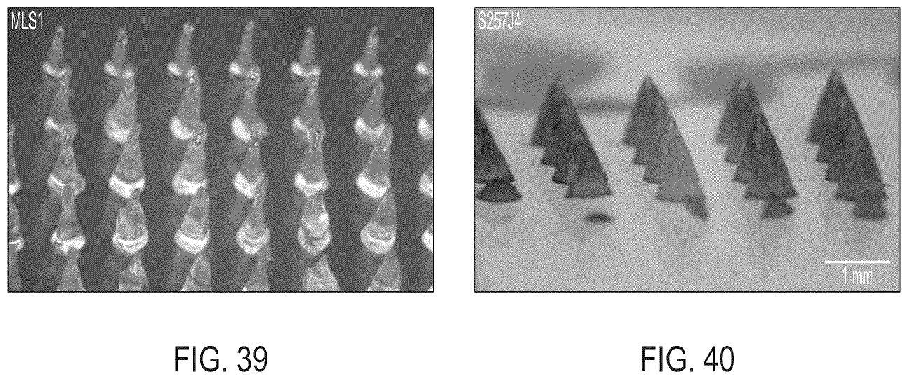

In one embodiment, multiple exposure stacking was used to attain a polymeric device with composite geometry shown in FIG. 32. A 3D CAD model was designed and converted into an .STL file. The model was divided into three segments, as shown in FIG. 33. Segment 1 contains a slice at z=100 um to form a region between z=100 um to z=0 um. Segment 2 contains a slice at z=200 um to form a region between z=200 um to z=100 um. Segment 3 contains a slice at z=300 um to form a region between z=300 um to z=200 um. For each segment, a grayscale pattern was created by determining the starting and ending slice location and number of slicing intervals and spacing between each interval. For segment 2, 10 slices linearly spaced between z=200 um to z=100 um were used. A grayscale color (e.g., between 0-255 where 0=black and 255=white) was assigned to each slice at the determined location. In some embodiments, grayscale values are linearly or exponentially proportional to the z-axis location (e.g., as z-axis location decreases, the gray value decreases). The grayscale slices were then stacked, wherein the slice area with the highest z-axis location was in the foreground, while the subsequent slices with lower z-axis location will be in the background. FIG. 34A shows the grayscale pattern generated to expose segment 1. FIG. 34B shows the grayscale pattern generated to expose segment 2. FIG. 34C shows the grayscale pattern generated to expose segment 3.

### Example 3: Fabricating Smooth and Curved Surfaces for Optical Lenses

In the fabrication of optical lenses, it can often be helpful or necessary to form a solid with a curved profile (e.g., spherical or parabolic), wherein the curvature shape will affect the focal length of the lens. Several methods to fabricate microlenses can include photoresist reflow, multi-layer photolithography, or laser catapulting, but these methods are often slow, costly and do not provide full control of the lenslet geometry. Frontal photopolymerization methods can rely on using grayscale patterns to attain curved features, or complex oxygen inhibition models for process planning and mask pattern generations and they use multiple exposures to attain the curved surfaces. In some embodiments, grayscaling of the lenslet pattern may be needed, depending on the application, and many methods and models cannot provide dense high fill factor microlens arrays. As disclosed herein, smooth and curved polymers can be fabricated without using grayscale patterning.

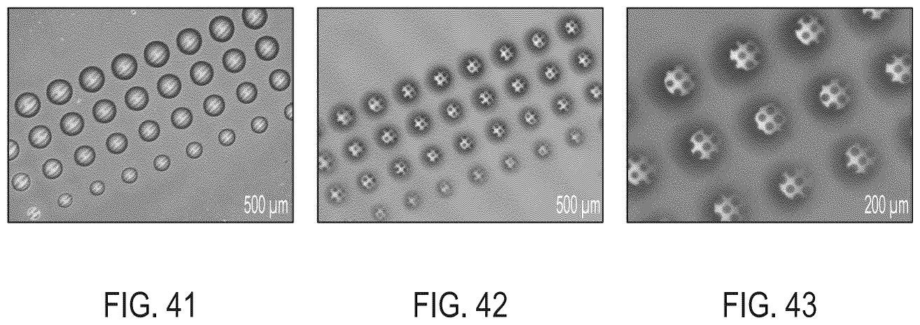

In some embodiments, a fabrication system 80 can be configured to use single shot UV exposure to attain smooth curved geometries, as shown in FIGS. 35A-35D. FIG. 35A illustrates the fabrication system 80 in which a DLP projector emits/projects patterned UV to cure a polymer with a curved surface. FIG. 35B shows a cross-sectional profile of a cured polymer with the relationship between maximum cured depth (Cu) and UV light intensity. FIG. 35C illustrates the patterned UV light emitted from the DLP projector. FIG. 35D is a graph that illustrates the relationship between Cu and UV light intensity. The degree of polymerization was influenced laterally (e.g., along the x-axis and y-axis) along the depth of the resin (e.g., z-axis) by leveraging the secondary effects of the polymerization kinetics. Equation 1 models polymerization along the vertical direction (e.g., z-axis), but does not account for dynamic, non-linear higher order effects (e.g., oxygen inhibition reaction) of the polymerization kinetics. In Equation 1, higher order effects are subsumed into a single parameter, the critical exposure dose parameter, E_{c}, which determines the minimum exposure energy required to initiate polymerization (e.g., start gelation, start solidification of resin, etc.). To control the polymerization laterally (x- and y-axes) along the depth of resin (z-axis), the underlying physics of the polymerization kinetics was leveraged.

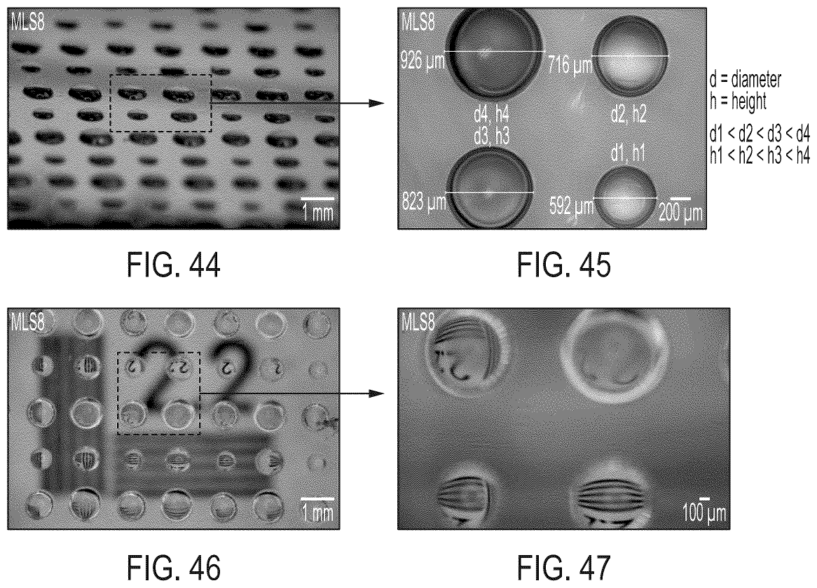

A smooth curved profile shown in FIG. 36 was fabricated without using a grayscale pattern, wherein the lateral polymerization width (e.g., along the x-axis and y-axis) of the resin gradually decreased along the depth of the resin (e.g., z-axis). This was realized by inhibiting the lateral polymer growth rate in comparison to the growth rate of the polymer in the vertical direction (z-axis). The lateral boundaries of the region of resin exposed to UV light have a slower polymerization rate compared to the center region because the reaction at the boundaries is retarded by inhibitors in the resin, which are continuously diffusing from unexposed regions. For the resin to be converted into a polymer, the dissolved inhibitors must be first consumed, and the growth rate of the polymer must exceed the inhibition rate. The polymerization on the boundaries can be influenced to favor inhibition by increasing inhibitor concentration in the resin, increasing diffusion of the inhibitor, decreasing photoinitiator concentration, decreasing UV absorption of the photoinitiator, decreasing the photoinitiator conversion efficiency to a radical, decreasing the exposure intensity, decreasing the exposure time, and/or decreasing the total energy dose.

In some embodiments, resins are formulated such that the lateral edges of UV exposure are strongly dominated by inhibition. A resin may comprise a photoinitiator selected with poor absorbance at the wavelength of UV light being used and/or poor radical conversion efficiency. A resin may comprise an absorbers or dye at a chosen concentration to modulate the attenuation of UV light along the depth of the resin. A resin may comprise an inhibitor, modulated to control inhibition of polymerization. The inhibitor may comprise dissolved oxygen, wherein the oxygen concentration is increased by bubbling oxygen gas into the resin. The oxygen concentration may be decreased by bubbling nitrogen gas in the resin.

In some embodiments, an exposure pattern, exposure sequence, and/or exposure conditions are optimized to maximize the unexposed area of the resin near the edges of the region that is exposed to the UV light. A larger unexposed area of resin allows for more unconsumed inhibitors to diffuse to the edges of the exposed area to inhibitor the lateral polymer growth. In some embodiments, the spacing between microstructures that are concurrently being exposed during single exposure mode is increased to allow for a larger area of unexposed resin. In some embodiments, the exposure is split into multiple discrete non-overlapping exposures.

In some embodiments, inter-exposure routines are utilized to restore the resin to the equilibrium state that existed prior to UV exposure by replenishing consumed inhibitors. In some embodiments, the inter-exposure routine comprises waiting for a specified duration (e.g., about 5 s, about 20 s, about 60 s, etc.) before continuing the subsequent exposure. In some embodiments, the inter-exposure routine comprises stirring, mixing, shaking, and/or vibrating the resin to cause the resin to flow. In some embodiments, the inter-exposure routine comprises draining the original resin and replacing it with fresh resin.

In some embodiments, the resin is kept in a state of continuous flow during the UV exposure, wherein the resin is moving with respect to the transparent substrate and the UV exposure pattern which remains stationary. In some embodiments, the exposure dose is decreased near the edges of the pattern by modulating the exposure intensity using a grayscale pattern as shown in FIG. 14G.

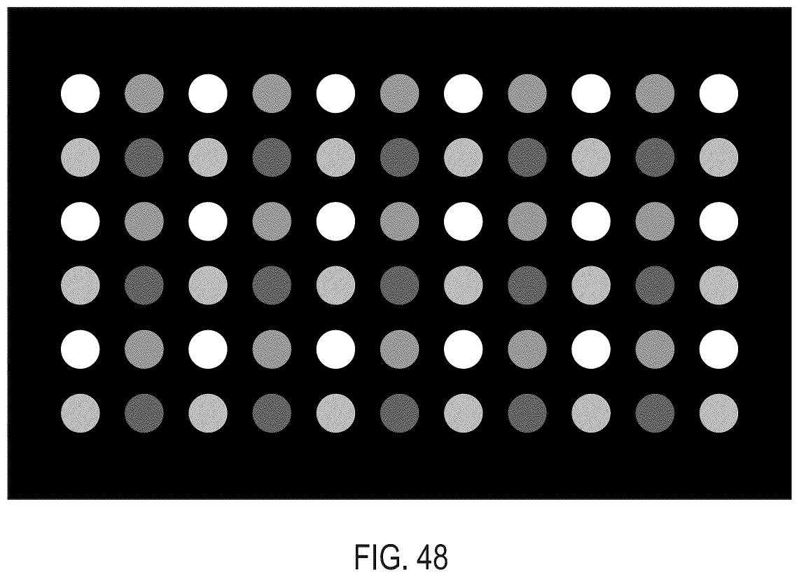

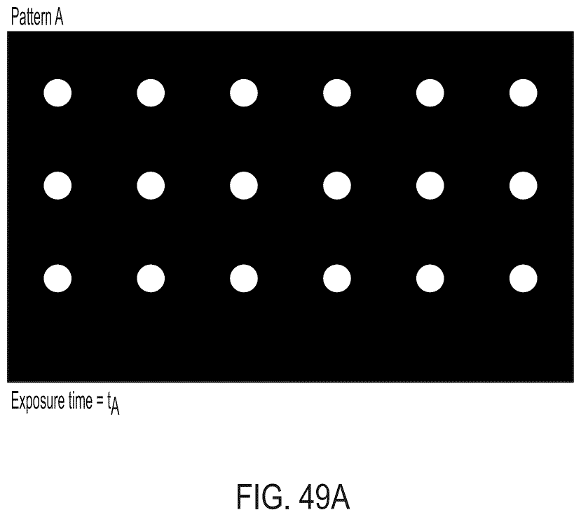

In embodiments, microstructures were fabricated using a single shot exposure method with controlled diameter, height and curvature profile as shown in FIGS. 37-38. Single exposure of a non-grayscale, “white only” pattern of a circle as shown in FIG. 35A was used for the fabrication of FIG. 37 with designed diameter of 500 um. The fabricated microstructures shown in FIG. 38 were designed with a diameter of 250 um. The microstructures of FIGS. 37-38 were fabricated using projection stitching wherein each microlens was formed by sequential exposures of the same pattern at different locations of the substrate. Each exposure had a different exposure time and UV exposure intensity (e.g., different exposure dose energy), wherein the exposure time varied from about 3 seconds to about 120 seconds and exposure intensity varied from about 3 mW/cm² to about 40 mW/cm².

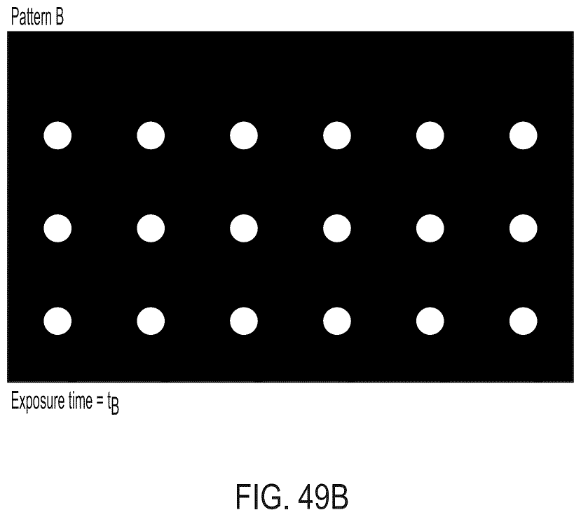

In another embodiment, conical microstructures were fabricated, as shown in FIG. 39 and FIG. 40 by controlling lateral and vertical polymerization. These conical microstructures may be of interest for applications that benefit from the use of microneedles or require microneedles.

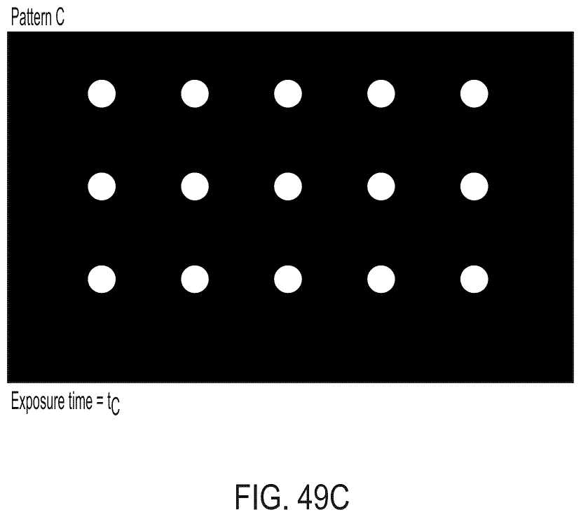

In some embodiments, curved polymers are fabricated and function as microlenses, as shown in FIGS. 41-43. Depending on the exposure time and exposure intensity, each lenslet has a different base diameter, height, and curvature, thus a different effective focal length. The estimated average focal length over all the lenslets was characterized as about 300 μm to about 500 μm. A microlens can have a non-circular cross-sectional profile (e.g., square) and curved smooth surface geometries can still be achieved.

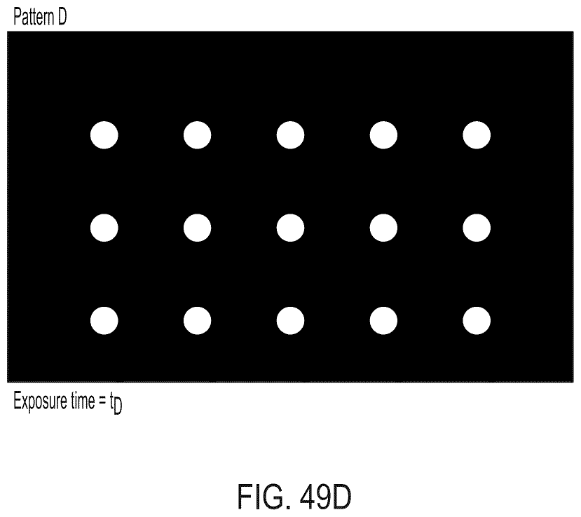

In some embodiments, arrays of multi-focal microlenses arranged in a mosaic pattern are fabricated on a glass substrate as shown in FIGS. 44-47. In the arrays, each unit cell has 4 lenses. Each lenslet or small lens in the unit cell has a different geometry (e.g., diameter, height, and/or curvature), thus a different focal length. In some embodiments, a thin flexible film such as cyclic olefin copolymer (COC) is used as the transparent substrate.

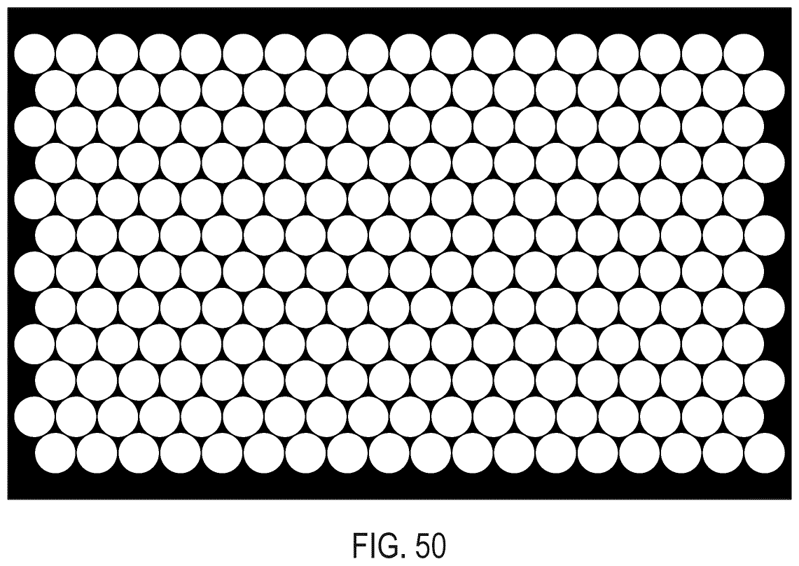

In some embodiments, the array of multi-focal microlenses is fabricated using a single exposure for a fixed duration with a grayscale pattern, as shown in FIG. 48. The pattern contains an array of unit cells, wherein each unit cell has 4 circles with different grayscale values to modulate exposure intensity. During the fixed exposure time, each circle in the unit cell receives a different exposure dose corresponding to the grayscale value. The different exposure dose results in a different shape of the fabricated lens, as shown in FIG. 37. The shape of the lens is not controlled by a non-uniform grayscale circle pattern, but a uniform grayscale value is used to modulate the intensity of light within the same exposure. Wide spacing between each lens allowed for the edges of the UV exposure to be dominated by the inhibition reaction.

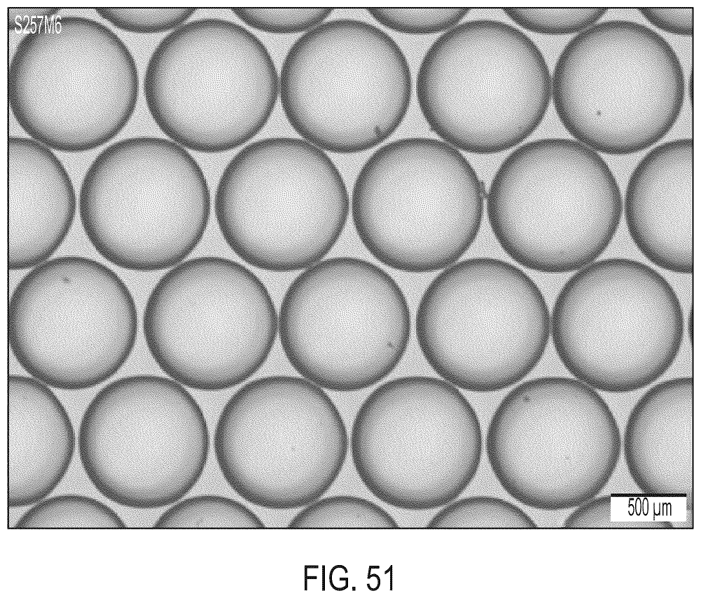

In another embodiments, the array of multi-focal microlenses is fabricated with multiple non-overlapped exposures of patterns without grayscale, as shown in FIGS. 49A-49D. Each exposure has a fixed duration that is different from the other exposures, resulting in lenses with different shapes. The same exposure time can be used to give all lenslets in the unit cell the same shape. Between each exposure, inter-exposure routines can be performed, as disclosed herein.

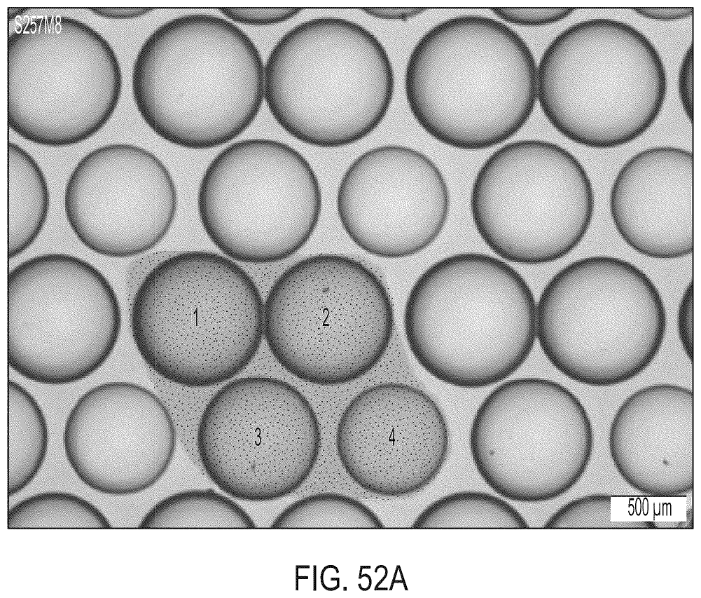

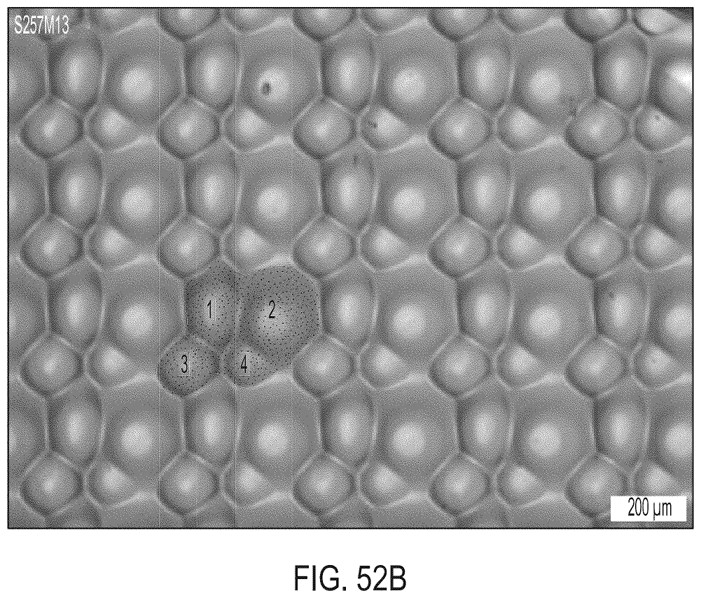

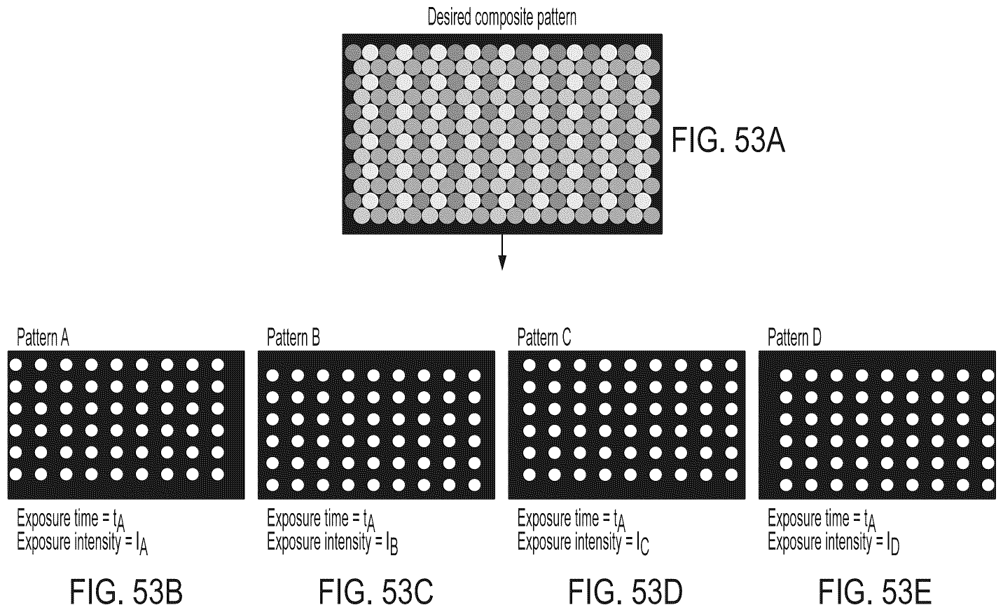

In some embodiments, arrays of microlenses are fabricated with a high packing density (e.g., fill factor) and uniformity. The hexagonally packed pattern in FIG. 50 can be used to fabricate a dense array of microstructure. A single shot exposure of the pattern will result in poor curvature and poor uniformity over the entire area because the inhibition reaction is weaker compared to polymer chain growth reaction during the exposure of a dense pattern. Arrays of microlenses with high packing density were fabricated using multiple exposures and inter-exposure routines as shown in FIGS. 51, 52A and 52B. An array with a single focal length was fabricated in FIG. 51, while FIGS. 52A-52B show an array with multiple focal lengths.

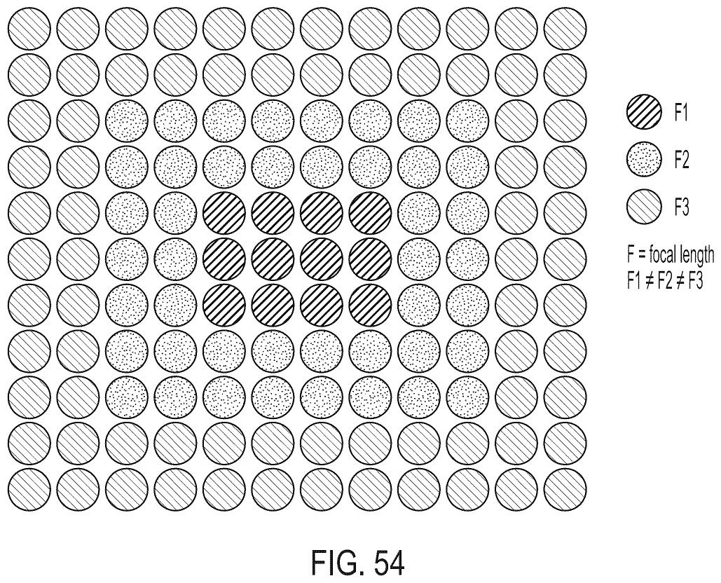

The desired composite pattern shown in FIG. 53A was split into 4 different patterns without grayscale, as shown in FIGS. 53B-53E. During the fabrication, each pattern shown in FIGS. 53B-53E was exposed sequentially. For the fabrication of single focal length lenses, the exposure intensity and exposure time are the same for each discrete exposure. For the fabrication of multi-focal length lenses, the exposure intensity and exposure time are different for each discrete exposure. After each exposure, an inter-exposure routine comprising waiting 10-30 sec and mixing the resin was performed.

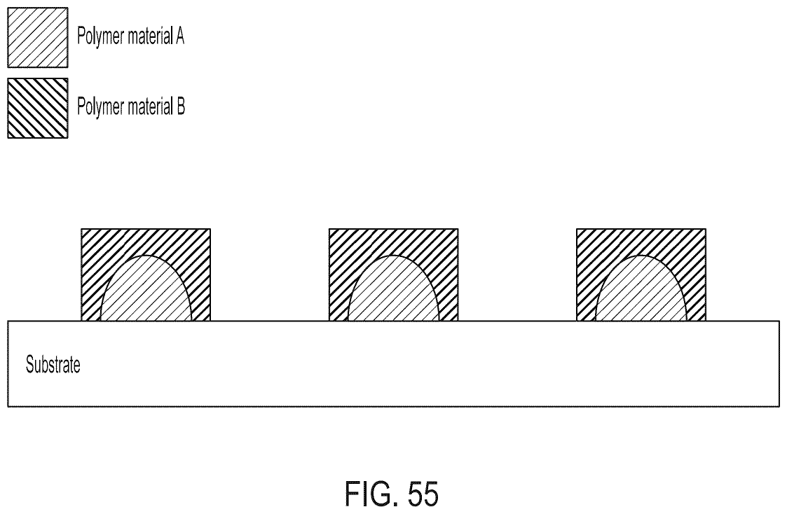

In some embodiments, a fabricated array of microstructures comprises a unit cell of 2×2, a pattern similar to a Bayer filter. In some embodiments, other arrangements of microstructures are fabricated using discrete sequential multiple exposures. In some embodiments, the exposure time and/or intensity for each discrete exposure is modulated to control the shaped of the polymer. In one embodiment, an array of multi-focal lenses is fabricated as shown in FIG. 54.

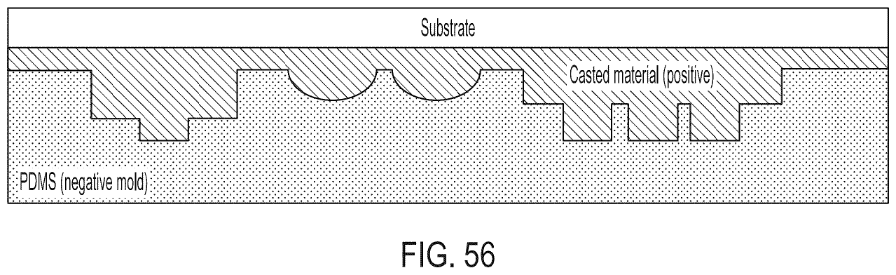

In some embodiments, an array of optical lenses is produced with a graded index of refraction by multi-material heterogenous fabrication, as shown in FIG. 55. In the array, polymer material A and polymer material B have different refractive indexes. The resin of polymer material A is formulated such that it is dominated by the oxygen inhibition reaction at the edge of the exposure. The resin of polymer material A is exposed to patterned light to form curved microlenses as disclosed herein. Next, an inter-exposure routine is utilized to drain resin A and replace with resin B. The resin of polymer material B is formulated with different materials than resin A to achieve a different refractive index and polymerize with a uniform flat thickness.

### Example 4: Replication of Textured Surfaces

Aspects of the disclosure relate to methods of fabricating textured surfaces and microstructure. Herein, the textured surfaces and microstructures are referred to as master positive features or a positive master. The fabrication process of a positive master requires a transparent substrate (e.g., glass). For end applications wherein the transparent substrate is not compatible, the fabricated surface may be duplicated onto another desired substrate (e.g., silicon wafer). The surface of the desired substrate can be functionalized to improve adhesion of the casted material on the substrate (e.g., use of silanes).

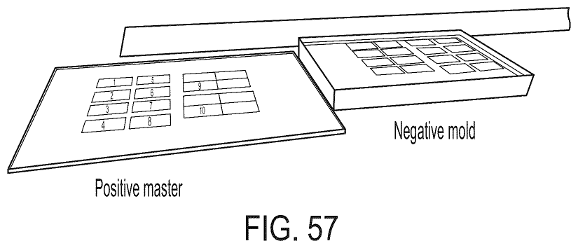

In some embodiments, master positive features are replicated into different material using methods such as molding and casting, as shown in FIG. 56. In some embodiments, a master positive feature is fabricated using the methods described herein. In some embodiments, the master positive is processed to reduce surface roughness (e.g., thermal annealing near the glass transition temperature of the polymer or deposition of low surface energy anti-stiction coating such as octafluorocyclobutane). In some embodiments, the master positive is coated with a thin metallic film (e.g., comprising aluminum, copper, titanium, gold, silver, and/or the like). The thin metallic film coating may protect the polymer surface, provide functionality for end applications (e.g., electrical conductivity), induce compressive stress by preventing the polymer from debonding the substrate, and/or reduce surface roughness. The thin metallic film coating may be deposited by methods such as sputtering, thermal evaporation, electroplating, or spray coating.

In some embodiments, the master positive is coated with an anti-stiction release agent (e.g., trichloro(1H, 1H,2H,2H-perfluorooctyl) silane or octafluorocyclobutane) by various methods (e.g., dip coating or vacuum evaporation).

In embodiments, a negative mold is created by casting an elastomer material such as polydimethylsiloxane (PDMS) on top of the master positive, wherein the PDMS silicone will solidify and create a negative copy of the master positive. In some embodiments, the surface of the negative mold is coated with anti-stiction release agent coatings (e.g., trichloro(1H, 1H,2H,2H-perfluorooctyl) silane or octafluorocyclobutane).

Then, a positive duplicate of the original positive master is created by casting a new material (e.g., PDMS, SU8 photoresist, a photopolymerizable resin, a thermally curable resin, low temperature castable metals and alloys) into the negative mold. PDMS or thermally curable monomers can be cured in furnace. Photopolymerizable resins or SU8 are exposed to UV light after casting into the mold.

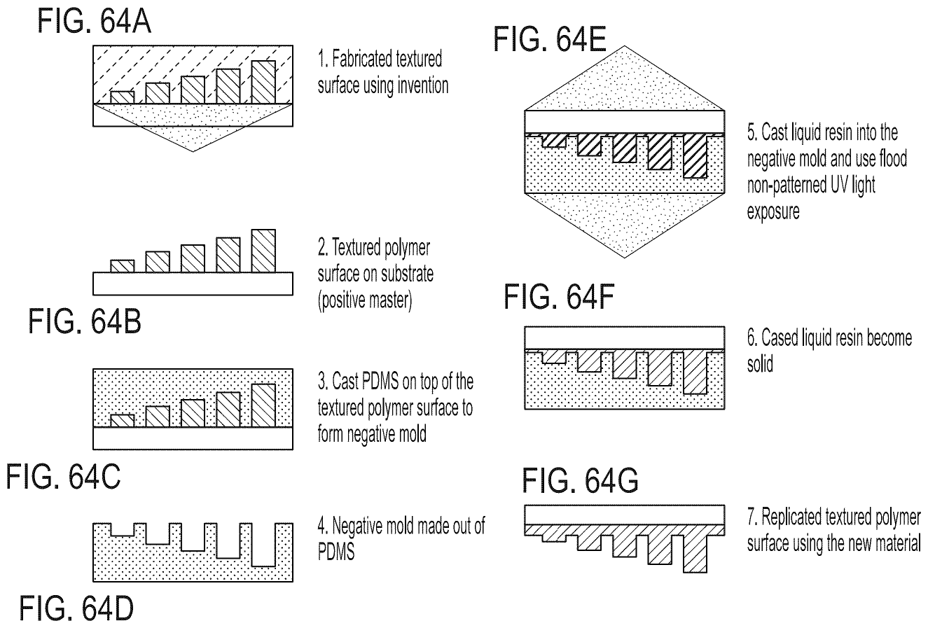

FIGS. 64A-64G illustrate an example approach for replication of a textured polymer surface. FIG. 64A illustrates how a textured surface is fabricated through UV light emission through a transparent substrate and into a resin supported thereon. FIG. 64B illustrates that once the unpolymerized resin is removed from the substrate, a positive master of the textured surface is formed. FIG. 64C illustrates that PDMS can be cast on top of the positive master of the textured polymer substrate. FIG. 64D illustrates that, once the cast PDMS hardens/solidifies, the PDMS forms a negative mold that inversely corresponds to the positive master. FIG. 64E illustrates that liquid resin can be cast into an inner volume of the negative mold and exposed with non-patterned UV light. FIG. 64F illustrates that, once the liquid resin is cast into the inner volume of the negative mold, it hardens. FIG. 64G illustrates that, once the cast liquid resin hardens, it forms an exact or substantially exact replication of the textured polymer surface as represented by the positive master using, but now replicated in the new resin material. According to some embodiments, any of the portions of the approach can be an optional step, and therefore can only optionally be carried out. The positive master can be fabricated using any of the photopolymerization approaches described elsewhere herein. In some embodiments, additional processing of the positive master may be carried out to reduce surface roughness or otherwise prepare the positive master for replication. For example, the positive master can be thermally annealed near the glass transition temperature of the polymer, which can help localized flow and smoothen out the surface roughness. Additionally or alternatively, a low surface energy anti-stiction coating such as octafluorocyclobutane [C₄F₈] or the like can be disposed/deposited onto at least portions of the positive master. Such a coating may help reduce the surface roughness in a negative mold formed from the positive master so that the positive master and negative mold(s) can be properly separated after formation of the negative mold(s) on/about the positive master. Without wishing to be bound by any particular theory, such a coating may fill in irregularities on surface(s) of the positive master such that a surface tension/interfacial attraction between abutting surfaces of the positive master and negative mold(s) is (are) reduced. The coating's surface tension interaction with the casted negative mold material may create smoother a surface on the positive master.

In some embodiments, the positive master can be coated with a film, e.g., a thin metallic film. The film may help protect the polymer surface of the positive master. The film may be used for functionality for various end applications (e.g., by a thin metallic film providing for electrical conductivity for electrical charge transport). The film may help induce compressive stresses exerted on the positive master and prevent the polymer of the positive master from debonding from the substrate during forming of the negative mold(s) and/or separation of the negative mold(s) from the positive master. The film may help reduce surface roughness in the polymer features. Coatings and/or films may fill in at least some of the irregularities in a top surface and/or side surface(s) of the positive master and help smoothen out said surfaces.

A film can be deposited using various methods such as sputtering, thermal evaporation, ALD, electroplating, spray coating, and/or the like. In instances in which the film is a metallic film or comprises a metallic material, the film can comprise one or more of: aluminum, copper, titanium, gold, silver, other suitable metals, and/or combinations thereof.

In some embodiments, the surface of the positive master is coated with an anti-stiction release agent coating. The anti-stiction release agent coating can comprise one or more of: trichloro(1H, 1H,2H,2H-perfluorooctyl) silane, octafluorocyclobutane [C₄F₈], other suitable release agent materials, and/or combinations thereof. The anti-stiction release agent coating can be formed or disposed on the positive master by any suitable method, such as dip coating, vacuum evaporation, other suitable approaches, and/or combinations thereof.

In some embodiments, the negative mold can be created by casting a mold material, such as polydimethylsiloxane (PDMS), silicone, other suitable mold materials, and/or combinations thereof, on top of the positive master. The mold material, prior to partial or complete solidification, conforms to the dimensions and form factor of the positive master. Once the mold material partially or fully solidifies on the positive master, a negative mold is formed that has an inverse or substantially inverse dimensions and form factor as the positive master, such that the negative space within an inner volume of the negative mold has identical or substantially identical dimensions and form factor as the positive master on which the negative mold is formed.

In some embodiments, an inner surface within the inner volume the negative mold is coated with an anti-stiction release agent coating(s), such as described above. In some embodiments, the positive duplicate of the positive master can be formed by casting a new material into the inner volume of the negative mold. The positive duplicate can be formed from any suitable material, such as PDMS, SU8 photoresist, a photopolymerizable resin, a thermally curable resin, low temperature castable metals and alloys (e.g., gallium), other suitable materials, and/or combinations thereof.

How the casted material achieves the final form will vary depending on the type of material used. For example, PDMS or thermally curable monomers, once disposed within the inner volume of the negative mold, can be cured in a furnace to form the positive duplicate. In other examples, photopolymerizable resins and/or SU8 may need to be exposure to UV light after being disposed in the inner volume of the negative mold in order to form the positive duplicate.

The new material may be, thereafter, cast onto a new substrate. In some embodiments, an example process for fabrication of a positive master may require a transparent substrate (e.g., glass), while an end application for the positive duplicate may not require a transparent substrate and/or may require another substrate altogether. For example, an end application for the positive duplicate may require a new substrate (e.g., a silicon wafer) that is not compatible with the process for fabrication of the positive master—in which case the fabricated surfaces/positive replicate must be formed on, disposed on, transferred to, or otherwise fabricated on the desired alternative substrate.

For example, as illustrated in FIG. 56, a casted material can be sandwiched between the negative mold (e.g., PDMS) and the desired substrate (e.g., a silicon wafer). In some embodiments, the surface of the desired substrate can be functionalized (e.g., using silanes) to improve adhesion of the casted surface/material (e.g., positive duplicate) to the desired substrate.

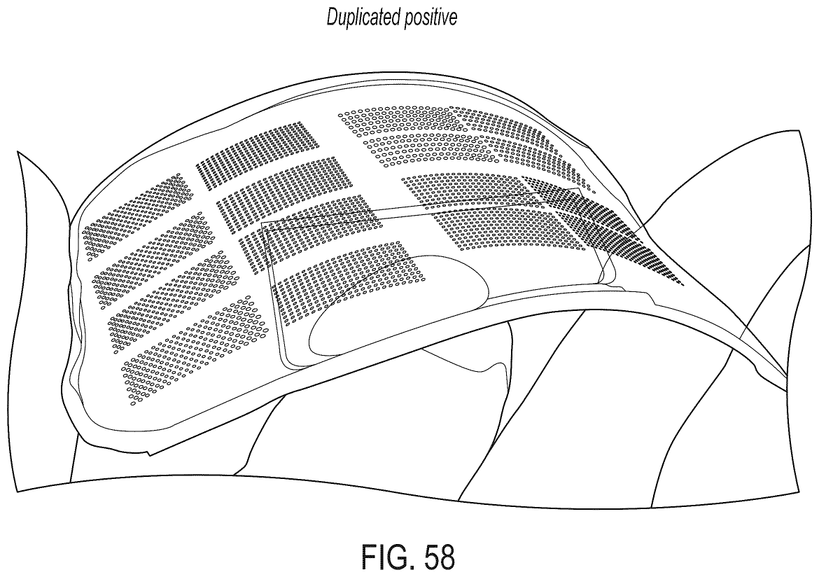

The described replication/duplication approach illustrated in FIG. 64 can be used, e.g., to replicate the microlens arrays described elsewhere herein, such as those illustrated in FIG. 57 and FIG. 58. In some embodiments, the positive master can be fabricated using a base resin, while the positive duplicate can be formed from a different (e.g., higher quality material, material having particular desired properties, etc.). For example, the positive master can be fabricated using a HDDA base resin while a positive duplicate for fabrication of a replicated microlens may be made out of, e.g., PDMS and/other another suitable material.

In one embodiment, a microlens array was replicated by fabricating a master positive feature with 1,6-hexanediol diacrylate (HDDA) resin and negative mold with PDMS as shown in FIG. 57. A duplicated positive of the microlens array was fabricated from the negative mold with PMDS, which is flexible and stretchable (see, e.g., FIG. 58).

### CONCLUSIONS

Efforts have been made to ensure accuracy with respect to numbers used (e.g., amounts, temperature, etc.) but some experimental errors and deviations should be accounted for.

One skilled in the art will recognize many methods and materials similar or equivalent to those described herein, which could be used in the practicing the subject matter described herein. The present disclosure is in no way limited to just the methods and materials described.

Throughout this specification and the claims, the words “comprise,” “comprises,” and “comprising” are used in a non-exclusive sense, except where the context requires otherwise. It is understood that examples described herein include “consisting of” and/or “consisting essentially of” examples.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other examples set forth herein will come to mind to one skilled in the art to which this subject matter pertains having the benefit of the teachings presented in the foregoing descriptions and the associated drawings. Therefore, it is to be understood that the subject matter is not to be limited to the specific examples disclosed and that modifications and other examples are intended to be included within the scope of the appended claims. Although specific terms are employed herein, they are used in a generic and descriptive sense only and not for purposes of limitation.

It should be appreciated that all combinations of the foregoing concepts and additional concepts discussed in greater detail below (provided such concepts are not mutually inconsistent) are contemplated as being part of the inventive subject matter disclosed herein. In particular, the combinations of claimed subject matter appearing at the end of this disclosure are contemplated as being part of the inventive subject matter disclosed herein. It should be appreciated that terminology explicitly employed herein that also may appear in any disclosure incorporated by reference should be accorded a meaning consistent with the particular concepts disclosed herein.

In some embodiments, one or more of the operations, steps, elements, or processes described herein may be modified or further amplified as described below. Moreover, in some embodiments, additional optional operations may also be included. It should be appreciated that each of the modifications, optional additions, and/or amplifications described herein may be included with the operations previously described herein, either alone or in combination, with any others from among the features described herein.

The provided method description, illustrations, and process flow diagrams are provided merely as illustrative examples and are not intended to require or imply that the steps of the various embodiments must each or all be performed and/or should be performed in the order presented or described. As will be appreciated by one of skill in the art, the order of steps in some or all of the embodiments described may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular. Further, any reference to dispensing, disposing, depositing, dispersing, conveying, injecting, inserting, communicating, and other such terms of art are not to be construed as limiting the element to any particular means or method or apparatus or system, and is taken to mean conveying the material within the receiving vessel, solution, conduit, or the like by way of any suitable method.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation. Specific equipment and materials described in the examples are for illustration only and not for purposes of limitation. For instance, any and all articles, portions of articles, structures, bulk materials, and/or the like, having any form factor, scale, dimensions, aesthetic attributes, material properties, internal structures, and/or mechanical properties, which are formed according to any of the disclosed methods, approaches, processes, or variations thereof, using any devices, equipment, apparatuses, systems, or variations thereof, using any of the build materials/resins described herein or variations thereof, are all contemplated and covered by the present disclosure. None of the examples provided are intended to, nor should they, limit in any way the scope of the present disclosure.

The various portions of the present disclosure, such as the Background, Summary, Brief Description of the Drawings, and Abstract sections, are provided to comply with requirements of the MPEP and are not to be considered an admission of prior art or a suggestion that any portion or part of the disclosure constitutes common general knowledge in any country in the world. The present disclosure is provided as a discussion of the inventor's own work and improvements based on the inventor's own work. See, e.g., Riverwood Int'l Corp. v. R.A. Jones & Co., 324 F.3d 1346, 1354 (Fed. Cir. 2003).

In some embodiments, one or more of the operations, steps, or processes described herein may be modified or further amplified as described below. Moreover, in some embodiments, additional optional operations may also be included. It should be appreciated that each of the modifications, optional additions, and/or amplifications described herein may be included with the operations previously described herein, either alone or in combination, with any others from among the features described herein.

Although specific advantages have been enumerated above, various embodiments may include some, none, or all of the enumerated advantages.

Other technical advantages may become readily apparent to one of ordinary skill in the art after review of the following figures and description.

It should be understood that, although exemplary embodiments are illustrated in the figures and described below, the principles of the present disclosure may be implemented using any number of techniques, whether currently known or not. The present disclosure should in no way be limited to the examples, experimental results, exemplary embodiments, preferred configurations, illustrated equipment, disclosed processes, or particular implementations and techniques illustrated in the drawings and described below.

The provided method description, illustrations, and process flow diagrams are provided merely as illustrative examples and are not intended to require or imply that the steps of the various embodiments must each or all be performed and/or should be performed in the order presented or described. As will be appreciated by one of skill in the art, the order of steps in some or all of the embodiments described may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular. Further, any reference to dispensing, disposing, depositing, dispersing, conveying, injecting, conveying, inserting, communicating, and other such terms of art are not to be construed as limiting the element to any particular means or method or apparatus or system, and is taken to mean conveying the material within the receiving vessel, solution, conduit, or the like by way of any suitable method.

Unless otherwise indicated, all numbers expressing quantities of equipment, number of steps, material quantities, material masses, material volumes, operating conditions, and so forth used in the specification and claims are to be understood as being modified in all instances by the term “about”. Accordingly, unless indicated to the contrary, the numerical parameters set forth in the present specification and attached claims are approximations that can vary depending upon the desired properties sought to be obtained by the present application. Generally, the term “about,” as used herein when referring to a measurable value such as an amount of weight, time, volume, ratio, temperature, etc., is meant to encompass ±50% of the stated value. For example, a value of “1,000,” which would be construed from above as meaning “about 1,000,” indicates a range of values from 500 to 1,500, inclusive of all values and ranges therebetween. As another example, a value of “about 1,000” should be taken to indicate any single value or sub-range of values from 500 to 1,500, inclusive of the values 500 and/or 1,500. As such, if a value of “about 1,000” is disclosed or claimed, this disclosure or claim element includes, for example, the value of 500, the value of 500.0000000000001, the value of 500.1, the value of 501, . . . the value of 1,000, . . . the value of 1,499.9999999, the value of 1,500, and all other values, ranges, or sub-ranges, therebetween, including values interstitial to adjacent integers or whole numbers, to any decimal place.

Generally, the term “substantially,” as used herein when referring to a measurable value, is meant to encompass ±50% of the stated value. Generally, the term “substantially,” as used herein with regard to a discrete position or orientation of a piece of equipment, component, or subcomponent, is meant to encompass the discrete position ±50% of the discrete position. Generally, the term “substantially,” as used herein with regard to a location of a piece of equipment, component, or subcomponent along a total range of travel of that equipment, component, or subcomponent, is meant to encompass ±50% of the location of the equipment, component, or subcomponent with regard to the total range of travel of that piece of equipment, component, or subcomponent, including translational travel, rotational travel, and extending travel in any direction, orientation, or configuration. As such, the use of the phrase “substantially disposed within a container” would be construed from above as meaning that greater than or equal to 50% of the subject element is disposed within the container. Likewise, the use of the phrase “substantially positioned within a bath” would be construed from above as meaning that greater than or equal to 50% of the subject element is positioned within the bath.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Conventional terms in the fields of additive manufacturing, materials science, and chemistry have been used herein. The terms are known in the art and are provided only as a non-limiting example for convenience purposes. Accordingly, the interpretation of the corresponding terms in the claims, unless stated otherwise, is not limited to any particular definition. Thus, the terms used in the claims should be given their broadest reasonable interpretation.

Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation. Specific equipment and materials described in the examples are for illustration only and not for purposes of limitation. For instance, any and all articles, portions of articles, structures, bulk materials, and/or the like, having any form factor, scale, dimensions, aesthetic attributes, material properties, internal structures, and/or mechanical properties, which are formed according to any of the disclosed methods, approaches, processes, or variations thereof, using any devices, equipment, apparatuses, systems, or variations thereof, using any of the build material, printing mixture, ink, yield-stress support material, or other material compositions described herein or variations thereof, are all contemplated and covered by the present disclosure. None of the examples provided are intended to, nor should they, limit in any way the scope of the present disclosure.

In this Detailed Description, various features may have been grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the embodiments should be determined with reference to the appended claims, along with the full scope of equivalents to which such claims are entitled.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that some or all of the parameters, dimensions, materials, equipment, processes, methods, and configurations described herein are meant to be preferred examples and that the actual parameters, dimensions, materials, and/or configurations will depend upon the specific application or applications for which the inventive teachings are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein “at. %” refers to atomic percent, “vol. %” refers to volume percent, and “wt. %” refers to weight percent. However, in certain embodiments when “at. %” is utilized, the values described may also describe “vol. %” and/or “wt. %,” when “vol. %” is utilized, the values described may also describe “at. %” and/or “wt. %,” and when “wt. %” is utilized, the values described may also describe “at. %” and/or “vol. %.” For example, if “20 at. %” is described in one embodiment, in other embodiments the same description may refer to “20 wt. %” or “20 vol. %.” As a result, all “at. %” values should be understood to also refer to “wt. %” in some instances and “vol. %” in other instances, all “vol. %” values should be understood to also refer to “wt. %” values in some instances and “at. %” in other instances, and all “wt. %” values should be understood to refer to “at. %” in some instances and “vol. %” in other instances.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A method for fabricating a polymeric device or a polymeric surface with arbitrary geometries and topographical textures, the method comprising:
disposing a volume of a liquid resin onto a first surface of a transparent substrate, the liquid resin comprising a photocurable monomer;
projecting a patterned light onto a second surface of the transparent substrate, the second surface being opposite the first surface, wherein the transparent substrate is dimensioned and configured such that at least a portion of the patterned light travels through the transparent substrate from the second side to the first side;
varying one or both of a light exposure time or a light intensity of the patterned light to focus a projection focal plane of the patterned light on an interface between the first surface of the transparent substrate and the liquid resin disposed thereon to initiate polymerization of the photocurable monomer at said interface; and
varying, for respective of the different portions of the liquid resin, at least one of the light exposure time or the light intensity of the patterned light to modulate an effective exposure energy dose of the patterned light relative to a total depth of the liquid resin on the first surface of the transparent substrate, wherein the effective exposure energy dose is a product of at least the light exposure time and the light intensity.

2. The method of claim 1, wherein the liquid resin comprises one or more of: a photoinitiator, a photoabsorber, an inhibitor, a dye, or nanoparticles.

3. The method of claim 1, further comprising:
controlling vertical polymerization by varying at least one of a resin formulation or the effective exposure energy dose.

4. The method of claim 1, wherein a characteristic absorption length of the liquid resin is inversely correlated with an absorption constant of the liquid resin.

5. The method of claim 1, further comprising:
controlling a minimum exposure energy dose to control polymerization of the liquid resin.

6. The method of claim 1, wherein the liquid resin comprises one or more of: one or more photocurable monomers, one or more photoinitiators, one or more absorbers, one or more dyes, one or more functional fillers, or one or more inhibitors.

7. The method of claim 1, wherein the transparent substrate comprises one or more of: a glass, a microscope slide, a cyclic olefin copolymer film, or a polyethylene terephthalate film.

8. The method of claim 1, further comprising:
functionalizing the first surface of the transparent substrate by coating the first surface of the transparent substrate with a functional material to facilitate adhesion or removal of the polymeric device or polymeric surface from the first surface of the transparent substrate.

9. The method of claim 1, further comprising:
functionalizing the second surface of the transparent substrate by coating the second surface of the transparent substrate with one or more of: an anti-reflective coating, a light filter coating, a light polarization coating, a stencil, a mask, a wavelength filtering coating, or a patterning coating.

10. The method of claim 1, wherein the spatial light modulator comprises one or more of: a digital light projector (DLP) configured to project said patterned light, a liquid crystal display device, or a liquid crystal on silicon device.

11. The method of claim 1, further comprising:
tilting, vertically translating, or laterally translating the transparent substrate to modulate the effective exposure energy dose of the patterned light relative to the total depth of the liquid resin or vary a position or an angle of the projection focal plane with respect to one of the first or second surface of the transparent substrate.

12. The method of claim 1, further comprising:
causing the volume of the liquid resin to be mixed, stirred, vibrated, oscillated, agitated mechanically, or kept in a state of continuous flow.

13. A method for fabricating a multi-material polymeric device or a multi-material polymeric surface, the method comprising:
disposing a volume of a first photocurable monomer onto a surface of a substrate;
projecting a patterned light into one or more portions of the volume of the first photocurable monomer;
modulating an effective exposure energy dose of the patterned light within the one or more portions of the first photocurable monomer to cause the one or more portions of the volume of the first photocurable monomer to form one or more first photocured structures, wherein the exposure energy dose is a product of at least a light exposure time and a light intensity of respective portions of the patterned light that reach respective of the one or more portions of the first photocurable monomer;
disposing a volume of a second photocurable monomer onto the surface of the substrate and/or onto at least a portion of the one or more photocured structures;
projecting the patterned light into one or more portions of the volume of the second photocurable monomer; and
modulating the effective exposure energy dose of the patterned light within the one or more portions of the second photocurable monomer to cause the one or more portions of the volume of the second photocurable monomer to form one or more second photocured structures.

14. The method of claim 13, further comprising:
in an instance in which only a portion of the volume of the first photocurable monomer forms the one or more first photocured structures, removing a remaining portion of the first photocurable monomer, the remaining portion of the first photocurable monomer comprising an uncured portion of the volume of the first photocurable monomer.

15. The method of claim 14, further comprising:
in an instance in which only a portion of the volume of the second photocurable monomer forms the one or more second photocured structures, removing a remaining portion of the second photocurable monomer, the remaining portion of the second photocurable monomer comprising an uncured portion of the volume of the second photocurable monomer.

16. The method of claim 13, wherein the first photocurable monomer is different from the second photocurable monomer.

17. The method of claim 16, wherein one or both of the first photocurable monomer or the second photocurable monomer comprises one or more of: a photoinitiator, a photoabsorber, an inhibitor, a dye, or nanoparticles.

18. A continuous or semi-continuous method for fabricating a polymeric device or a polymeric surface, the method comprising:
moving a flexible substrate along a path between a dispensing roll and a receiving roll;
disposing one or more volumes of a photocurable monomer onto one or more portions of the flexible substrates;
projecting a patterned light into the one or more volumes of the photocurable monomer at one or more points along said path between the dispensing roll and the receiving roll; and
modulating an effective exposure energy dose of the patterned light within the one or more volumes of the photocurable monomer to cause the one or more volumes of the photocurable monomer to form one or more photocured structures, wherein the exposure energy dose is a product of at least a light exposure time and a light intensity for the patterned light received at respective volumes of the one or more volumes of the photocurable monomer.

19. The method of claim 18, further comprising:
projecting the patterned light in multiple sequential exposures, wherein an inter-exposure routine is performed between the sequential exposures of projected patterned light,
wherein the inter-exposure routine comprises mixing or stirring the liquid resin, removing the liquid resin, disposing a solvent, removing a solvent, replacing the liquid resin with a liquid resin with a same or different composition, and/or moving the spatial light modulator.

20. The method of claim 18, wherein one or both of the first photocurable monomer or the second photocurable monomer comprises one or more of: a photoinitiator, a photoabsorber, an inhibitor, a dye, or nanoparticles.
